(19) United States
(12) Patent Application Publication
(10) Pub. No.: US 2024/0124618 A1
(43) Pub. Date: Apr. 18, 2024

(54) Asymmetric Constrained Geometry Catalysts

(71) Applicant: EXXONMOBIL CHEMICAL PATENTS INC., Baytown, TX (US)

(72) Inventors: Nikola S. Lambic, Houston, TX (US); Gregory J. Smith-Karahalis, Houston, TX (US)

(21) Appl. No.: 18/261,024

(22) PCT Filed: Jan. 4, 2022
(86) PCT No.: PCT/US2022/011083

§ 371 Date: Jul. 11, 2023

Related U.S. Application Data
(60) Provisional application No. 63/136,459, filed on Jan. 12, 2021.

(51) Int. Cl. C08F 4/76; C08F 210/06

(52) U.S. Cl. CPC C08F 4/76; C08F 210/06; C07B 2200/07

(57) ABSTRACT

The embodiments described herein pertain to constrained geometry catalyst (CGC)-type titanium catalyst compounds with an amido moiety that features asymmetric substituents that give rise to diastereomerism in new catalysts. Catalyst compounds embodying the present technological advancement are excellent catalysts for variety of transformations including homopolymers of propylene (P), ethylene (E), ethylene-propylene (EP)-copolymers and ethylene-octene (EO) copolymers.

### CROSS REFERENCE TO RELATED APPLICATIONS

This application claims the benefit of and priority to U.S. Provisional Application No. 63/136,459 filed Jan. 12, 2021, the disclosure of which is incorporated herein by reference.

### FIELD

The present disclosure generally relates to asymmetric constrained geometry catalysts, catalyst systems including such, and uses thereof.

### BACKGROUND

Olefin polymerization catalysts are of great use in industry. Hence, there is interest in finding new catalyst systems that increase the commercial usefulness of the catalyst and allow the production of polymers having improved properties.

Catalysts for olefin polymerization are often based on cyclopentadienyl transition metal compounds as catalyst precursors, which are activated either with an alumoxane or with an activator containing a non-coordinating anion. A typical catalyst system includes a metallocene catalyst and an activator, and an optional support. Many metallocene catalyst systems can be used in homogeneous polymerizations (such as solution or supercritical) and supported catalyst systems are used in many polymerization processes, often in slurry or gas phase polymerization processes.

For further background information on CGC complexes, see. McKnight, A. L.; Waymouth, R. M., (1998) “Group 4 ansa-Cyclopentadienyl-Amido Catalysts for Olefin Polymerization,” Chem. Rev., v. 98, pp. 2587-2598. The general state of the art CGC complexes are described in early patent publications: WO2019/827103, WO1999/042467, WO1997/015583 and WO/2004/013149. More recent work is described in patent publications: WO2017/192226, wherein a tetrahydroindacenyl ligand is substituted in 5,6,7 position, and KR2019/0086989, where asymmetric silyl bridge is used.

An academic work investigating the mechanism of propylene polymerization with CGC type catalysts is described by Resconi et al. (2002) “Indenyl-amido titanium and zirconium dimethyl complexes: improved synthesis and use in propylene polymerization,” Journal of Organometallic Chemistry, v. 664(1-2) pp. 5-26 and by McKnight, A. et al. (1997) “Selectivity in Propylene Polymerization with Group 4 Cp-Amido Catalysts,” Organometallics, v. 16(13), pp. 2879-2885. In addition, mechanistic studies on selectivity have been rationalized using DFT methodology by the group of Motta, A. et al. (2007) “Stereochemical Control Mechanisms in Propylene Polymerization Mediated by C₁-Symmetric CGC Titanium Catalyst Centers,” JACS, v. 129(23), pp. 7327-7338.

Other references of interest include: U.S. Pat. Nos. 5,382,630; 5,382,631; 8,575,284; 6,069,213; Kim, J. D. et al. (2000) “Copolymerization of Ethylene and α-Olefins with Combined Metallocene Catalysts. III. Production of Polyolefins with Controlled Microstructures,”J. Polym. Sci. Part A: Polym. Chem., v. 38(9), pp. 1427-1432; Iedema, P. D. et al., “Predicting the Molecular Weight Distribution of Polyethylene for Mixed Systems with a Constrained-Geometry Metallocene Catalyst in a Semibatch Reactor,” Ind. Eng. Chem. Res., v. 43(1), pp. 36-50; U.S. Pat. Nos. 6,656,866; 8,815,357; US 2014/0031504; U.S. Pat. No. 7,385,015; WO2007/080365; WO2012/006272; WO2000/12565; WO2002/060957; WO2004/046214; U.S. Pat. Nos. 6,846,770; 6,664,348; WO2005/075525; US 2002/0007023; WO2003/025027; US 2005/0288461; US 2014/0031504; U.S. Pat. Nos. 8,088,867; 5,516,848; 4,701,432; 5,077,255; 7,141,632; 6,207,606; 8,598,061, and PCT/US2020/043758.

There is still a need in the art for new and improved catalyst systems for the polymerization of olefins, in order to achieve increased activity or specific polymer properties, such as high melting point, high molecular weights, to increase conversion or comonomer incorporation, or to alter comonomer distribution without deteriorating the resulting polymer's properties.

### SUMMARY

A composition, comprising: a catalyst compound having Formula (I),wherein, M is a group IV transition metal, X is a bridging atom, Y is nitrogen, Z is carbon that is optionally stereogenic, each R¹ and R² are independently hydrogen, substituted or unsubstituted hydrocarbyl, aryl, or heteroaryl, wherein R¹ and R² can be joined to form a saturated or unsaturated C₃-C₆₀ cyclic or polycyclic ring or combination of thereof, R³ is a substituted or unsubstituted C₁-C₂₀ hydrocarbyl, R⁴ is hydrogen, an alkyl group, or aryl group, each of R⁵ and R⁶ is independently hydrogen, an unsubstituted hydrocarbyl, a substituted C₁-C₄₀ hydrocarbyl, a heteroatom, a heteroatom-containing group, or R⁵ and R⁶ form a cyclic or polycyclic ring structure, or a combination thereof, R⁷ is hydrogen, a substituted C₁-C₂₀ hydrocarbyl, or an unsubstituted C₁-C₂₀ hydrocarbyl, each of R⁸, R⁹, R¹⁰, R¹¹, and R¹² is independently hydrogen, an unsubstituted hydrocarbyl, a substituted C₁-C₄₀ hydrocarbyl, a heteroatom, a heteroatom-containing group, or two or more of R⁸, R⁹, R¹⁰, R¹¹, and R¹² are joined together to form a C₄-C₆₂ cyclic or polycyclic ring structure, or a combination thereof; and each R¹³ and R¹⁴ is independently substituted or unsubstituted hydrocarbyl, aryl, or heteroaryl, or cycloalkyl, wherein R¹³ and R¹⁴ can be joined to form a saturated or unsaturated C₃-C₆₀ cyclic or polycyclic ring, or combination of thereof.

The composition, wherein each R¹ and R² are independently, methyl, ethyl, propyl, isopropyl, butyl, isobutyl, tertbutyl, pentyl, isopentyl, hexyl, cyclopentyl, cyclohexyl, 1-adamantyl, 2-adamantyl, or norbornyl, or combination of thereof.

The composition, wherein the catalyst compound has a syn or anti configuration, and R¹ and R² are different from each other.

The composition, wherein diastereomeric chirality is imposed on the catalyst compound by the Z being stereogenic, R¹ and R² are different from each other, and the R³-R¹² is a substituted 4-aryl polycyclic ring.

The composition, wherein R¹ and R² are joined to form a saturated or unsaturated asymmetric C₃-C₆₀ cyclic or polycyclic ring or combination of thereof.

The composition, wherein X is silicon.

The composition, wherein the catalyst compound has syn and anti-configurations, M is titanium, X is silicon, and R¹ is fused with R² to form an asymmetric cyclohexyl ring with Me group in 2-position, R¹³, R¹⁴, R³ are each independently Me, each of R⁴, R⁵, R⁶, R⁷, R⁸, R⁹, R¹¹ and R¹² are independently H, R¹⁰ is tBu, and Z is CH and racemic.

The composition, wherein the catalyst compound has syn and anti-configurations, M is titanium, X is silicon wherein each of R¹, R³, R¹³, and R¹⁴ is independently Me, R² is 1-adamantyl, each of R⁴-R⁹, R¹¹, and R¹² is independently hydrogen, and R¹⁰ is tertButyl.

The composition, wherein the catalyst compound has syn and anti-configurations, M is titanium, X is silicon wherein each of R¹, R³, R¹³, and R¹⁴ is independently Me, R² is cyclohexyl, each of R⁴-R⁹, R¹¹, and R¹² is independently hydrogen, and R¹⁰ is tertButyl such that stereochemistry at the Z atom is R.

The composition, wherein the catalyst compound has syn and anti-configurations, the M is titanium, X is silicon wherein each of R¹, R³, R¹³, and R¹⁴ is independently Me, R² is cyclohexyl, each of R⁴-R⁹, R¹¹, and R¹² is independently hydrogen, and R¹⁰ is tertButyl such that stereochemistry at the Z atom is S.

The composition, wherein the catalyst compound has syn and anti-configurations, the M is titanium, X is silicon wherein each of R¹, R³, R¹³, and R¹⁴ is independently Me, R² is 1-adamantyl, each of R⁴, R⁷, R⁸, R¹⁰, and R¹² are independently hydrogen, R⁵ and R⁶ are fused to make a cyclopentyl ring, and R¹¹ and R⁹ are each independently tBu.

The composition, wherein the catalyst compound is included in a catalyst system with an activator and a support material.

A method, comprising: introducing one or more monomers and a catalyst system of claim 12 into a reactor at a reactor pressure of from 1 bar to 70 bar and a reactor temperature of from 20° C. to 150° C.; and obtaining a polymer.

The method, wherein the introducing includes introducing propylene and an alpha-olefin, and the polymer is a co-polymer of propylene and the alpha-olefin.

The method, wherein the alpha-olefin is a C₂ or C₄ to C₄₀ olefin monomer, preferably ethylene, and the co-polymer has a Mw of 50,000-600,000 g/mol and preferably an ethylene content from 0.5-50 wt %.

The method, wherein the polymer is polypropylene that has a M_{w} of 50,000-1,500,000 g/mol or polyethylene that has a Mw of 50,000-3,000,000 g/mol.

The method, wherein the catalyst compound is enriched to either syn or anti form in at least 6:4, more preferably 7:3, more preferably 8:2, more preferably 9:1 and higher.

The method, wherein the catalyst compound is enriched in anti form and the polymer is a propylene elastomer with a melt temperature ranging between 50-80° C.

The method, wherein the polymer is an ethylene-octene (EO) copolymer that has a Mw of 50,000-1,500,000 g/mol, an 1-octene content from 0.5 to 60 wt % and Tₘ less than 125° C.

### BRIEF DESCRIPTION OF THE DRAWINGS

FIG. 1 is an exemplary graphical representation of stereochemistry around metal center with unsymmetrical CGC-type complexes.

FIG. 2 illustrates exemplary asymmetric amine type building blocks useable for synthesis of new ligands.

FIG. 3 illustrates diastereomeric catalyst pairs alongside comparative catalyst (Comp. CGC) used in the polymerization analysis described herein.

FIG. 4 is an X-ray crystal structure of diastereomeric pair of Catalyst E (dichloride).

FIG. 5 is an ¹H NMR spectrum (C₆D₆) demonstrating two diastereomers of Catalyst E.

FIG. 6 is an X-ray crystal structure of diastereomeric pure Catalyst C (anti form).

FIG. 7 is an ¹H NMR spectrum (C₆D₆) demonstrating two diastereomers of Catalyst C.

FIG. 8 illustrates DSC results (1^{st} melt) of polypropylenes prepared with comparative CGC and syn and anti enriched catalysts C and D.

FIG. 9 is a bar graph illustrating polypropylene molecular weight capability.

FIG. 10 is a bar graph illustrating polypropylene catalyst activities with different activators at 70° C.

FIG. 11 is a bar graph illustrating polypropylene catalyst activities with [B(C₆F₅)₄][DMAH] activator at 100° C.

### DETAILED DESCRIPTION

The embodiments described herein pertain to constrained geometry catalyst (CGC)-type titanium catalyst compounds with an amido moiety that features asymmetric substituents that give rise to diastereomerism in new catalysts. Catalyst compounds embodying the present technological advancement are excellent catalysts for variety of transformations including homopolymers of propylene (P), ethylene (E), ethylene-propylene (EP)-copolymers and ethylene-octene (EO) copolymers. Notable improvements (2-3 fold in PP molecular weight capability) relative to state of the art CGC titanium species reported in the literature is observed. The molecular weight of polypropylenes produced with catalyst compounds embodying the present technological advancement can exceed 1,400 kDa at polymerization temperature of 70° C. Catalyst compounds embodying the present technological advancement in many cases offer improved activities and higher temperature capabilities relative to a control CGC catalyst. Finally, given the diastereomeric nature of the catalyst compounds embodying the present technological advancement, it is possible to prepare pure propylene elastomer-like polymers with very low crystallinity (Tₘ=50-80° C.) by using “anti” diastereomers (e.g., enrich the catalyst compound to be at least 7:3, preferably 8:2, or more preferably 9:1, or even higher, in favor of the anti) of catalyst compounds embodying the present technological advancement. However, it is also within the scope of the present technological advancement to enrich the syn form in the same ratios as noted for the anti form. “Pure” means that the elastomer material is made out of propylene only. Usually, to get elastomeric properties one needs to add a comonomer (ethylene, or other olefins) to drive the crystallinity down and increase the elastomeric properties.

Constrained geometry (half-metallocene) complexes of group IV transition metals are useful catalysts for polymerization of alpha olefins. These species are particularly useful for the efficient production of poly ethylene-co-octene and ethylene-propylene copolymers in solution process. More recently, these catalyst compounds found application in production of amorphous polypropylene. However, due to the inherently higher rates of chain transfer reactions in propylene polymerization, achieving high molecular weight remains challenging without compensating for loses in catalyst productivity. The present technological advancement provides a solution for this problem by employing asymmetrically substituted, and optionally chiral constrained geometry catalysts, based on 4-Aryl-indenyl or 4-Aryl-tetrahydro-s-indacenylligands.

### Catalyst Compounds

The general structure of a catalyst compound embodying the present technological advancement is shown below in Formula (I).

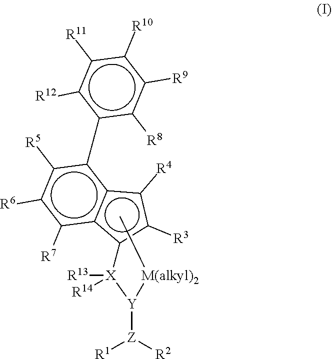

R³-R¹⁴ are hydrogen, substituted or unsubstituted hydrocarbyl, aryl, or heteroaryl, that could optionally be joined to form a saturated or unsaturated C₃-C₆₀ cyclic or polycyclic ring or combination of thereof. X is a bridging atom, preferably silicon but could be carbon or germanium, Y is nitrogen, Z is carbon that is optionally stereogenic, R¹ and R² are hydrogen, substituted or unsubstituted hydrocarbyl, aryl, or heteroaryl, that could optionally be joined to form a saturated or unsaturated asymmetric C₃-C₆₀ cyclic or polycyclic ring or combination of thereof. The combination of 4-aryl substitution, coupled with asymmetric carbon (Z) imposes diastereomeric chirality on the final complex, hence the inventive examples can be isolated in pure syn or anti conformations or can be used as syn/anti mixtures (however, R¹ and R² need to be different from each other to give the syn/anti forms). M is a group IV transition metal, and is preferably titanium.

In some embodiments, each of R¹ and R² is independently an alkyl or cycloalkyl. Examples of combinations of R¹ and R² are (Me, Cyclohexyl) and (Me, Adamantyl). In general, the preferred difference in size between R¹ and R² should be as large as possible. This is why Me for R¹ (small) and cycloalkyl or adamantyl for R² (large) may be preferred. Other options for R¹ and R² are ethyl, propyl, isopropyl, butyl, isobutyl, terbutyl, pentyl, isopentyl, hexyl, cyclopentyl, cyclohexyl, substituted cyclohexyl, 1-adamantyl, 2-adamant norbornyl, or substituted norbornyl groups. Diastereomeric chirality is imposed on the catalyst compound when the Z is stereogenic, and R¹ and R² are different from each other, and R³-R¹² are a substituted 4-aryl polycyclic ring.

In some embodiments, R³ is a substituted C₁-C₂₀ hydrocarbyl, or an unsubstituted hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example, a substituted C₁-C₆ hydrocarbyl, or an unsubstituted C₁-C₆ hydrocarbyl.

In some embodiments, R⁴ is preferably hydrogen, but it could be an alkyl or aryl group. However, alkyl or aryl groups may result in reduced activity.

In some embodiments, each of R⁵ and R⁶ is independently hydrogen, an unsubstituted C₁-C₄₀ hydrocarbyl, a substituted C₁-C₄₀ hydrocarbyl, a heteroatom, a heteroatom-containing group, or R⁵ and R⁶ form a cyclic or polycyclic ring structure, or a combination thereof.

In some embodiments, each of R⁵ and R⁶ is independently hydrogen, a halogen, an unsubstituted C₁-C₄₀ hydrocarbyl, a substituted C₁-C₄₀ hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R⁵ and R⁶ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or R⁵ and R⁶ form a substituted or unsubstituted C₄-C₂₀ saturated or unsaturated cyclic or polycyclic ring structure, or a combination thereof.

In some embodiments, R⁷ is hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example hydrogen, a substituted C hydrocarbyl, or an unsubstituted C₁-C₆ hydrocarbyl.

In some embodiments, each of R⁸, R⁹, R¹⁰, R¹¹, and R¹² is independently hydrogen, an unsubstituted C₁-C₄₀ hydrocarbyl, a substituted C₁-C₄₀ hydrocarbyl, a heteroatom, a heteroatom-containing group, or two or more of R⁹, R¹⁰, R¹¹, R¹², and R¹³ are joined together to form a C₄-C₆₂ cyclic or polycyclic ring structure, or a combination thereof.

In some embodiments, each of R⁸, R⁹, R¹⁰, R¹¹, and R¹² is independently hydrogen, a halogen, an unsubstituted C₁-C₄₀ hydrocarbyl, a substituted C₁-C₄₀ hydrocarbyl, an unsubstituted C₄-C₆₂ aryl (such as an unsubstituted C₄-C₂₀ aryl, such as a phenyl), a substituted C₄-C₆₂ aryl (such as a substituted C₄-C₂₀ aryl), an unsubstituted C₄-C₆₂ heteroaryl (such as an unsubstituted C₄-C₂₀ heteroaryl), a substituted C₄-C₆₂ heteroaryl (such as a substituted C₄-C₂₀ heteroaryl), —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R⁸, R⁹, R¹⁰, R¹¹, and R¹² is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more of R⁸, R⁹, R¹⁰, R¹¹, and R¹² can be joined to form a substituted or unsubstituted C₄-C₂₀ saturated or unsaturated cyclic or polycyclic ring structure, or a combination thereof.

In some embodiments, at least one of R⁸, R⁹, R¹⁰, R¹¹, and R¹² is a phenyl.

In some embodiments, each of R¹³ and R¹⁴ is independently a substituted or unsubstituted hydrocarbyl, aryl, alkyl, heteroaryl, or cycloalkyl.

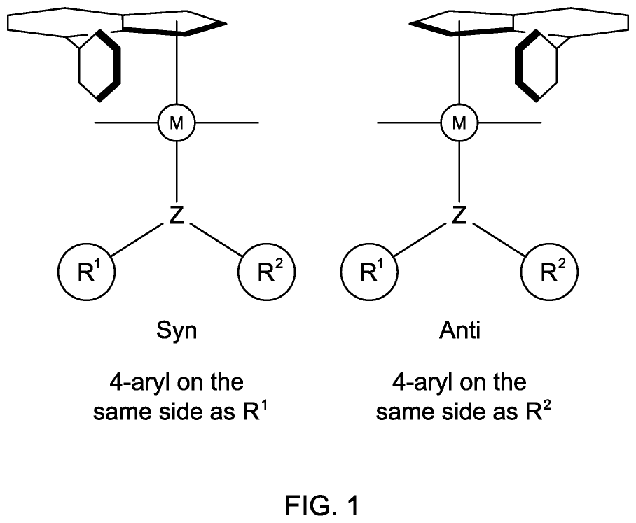

FIG. 1 is an exemplary graphical representation of stereochemistry around metal center with unsymmetrical CGC-type complexes. The indenyl ligand can bind on each face, which results in formation of diastereomers. Syn/anti are two widely accepted prefixes used to distinguish diastereomers, and they indicate whether the substituent in the 4-position (typically aryl) of indenyl ligand is positioned on the same side (syn diastereomer) or opposite side (anti diastereomer) of a geometric plane containing a bulkier substituent of the amide moiety. As shown in FIG. 1, the complexes are diastereomers—in the context of catalysis, one can use the diastereomeric mixture or carry out fractional crystallization to obtain a diastereomerically enriched samples. This step is routinely done for many state of the art C₂ symmetric metallocenes for polypropylene. Alternatively, one can isolate an optically active mixtures of diastereomers, depending on the absolute configuration at the Z atom (R or S). The catalyst family based on the above mentioned structures allows for significant improvements in polymer molecular weights and catalyst activities relative to current state of the art.

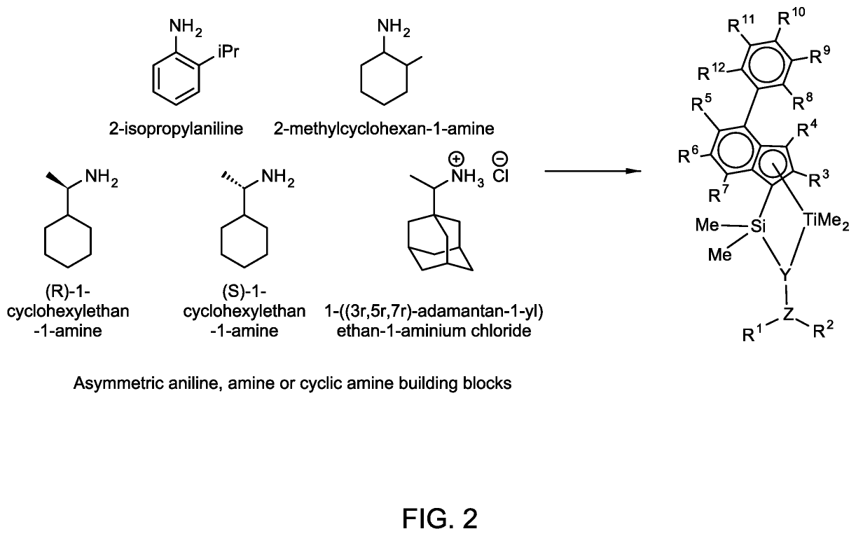

In general, most synthetic modifications of CGC type catalyst compounds focuses on substitutions of Cp or indenyl rings and many variants are known to date. In addition, substitution of the silane moiety has recently been reported by LG-Chem in patent publication KR2019/0086989. While there are many iterations of CGC complexes with different amine substitution, there is very little evidence of asymmetric CGC complexes substituted around the heteroatom. In order to prepare the catalysts complexes embodying the present technological advancement, asymmetric amine building blocks from FIG. 2 can be used. FIG. 2 illustrates exemplary asymmetric amine type building blocks useable for synthesis of new ligands. The Z atom represents a carbon that is directly bound to an NH₂ functional group.

Many of the amines can also be obtained in an enantiopure form, and could be used as such to introduce chirality in the catalyst. Examples of catalysts containing a chiral center that is not at the metal employ 1-cyclohexylethan-1-amine, which could be obtained in both R and S configuration (R and S referring to the CIP system of nomenclature). Ligand synthesis was accomplished according to well established procedures. Complex synthesis could be accomplished by any of the 3 routes in scheme 1 (below) with yields around 20%.

The three schemes below show general synthetic schemes demonstrating how the catalyst compounds can be prepared. The schemes are exemplary, non-limiting embodiments of a method to prepare the catalyst compounds described herein.

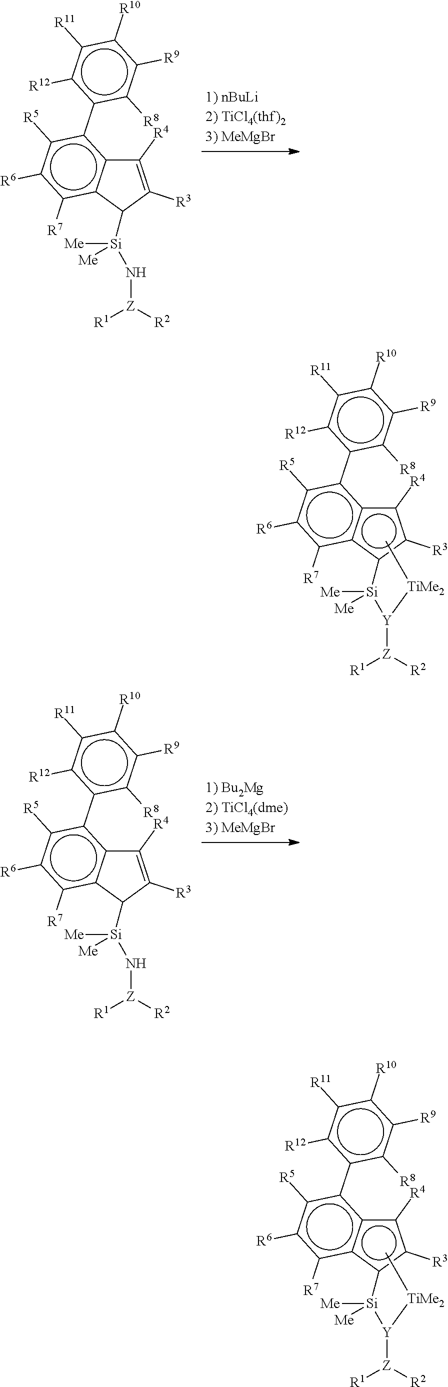

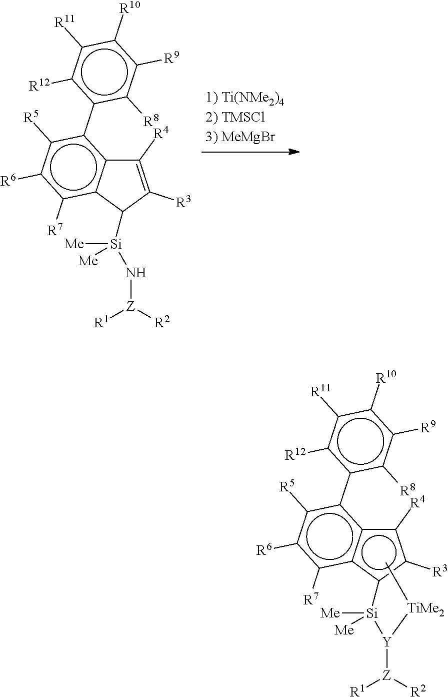

### Preparation of Ligands and Organometallic Catalysts

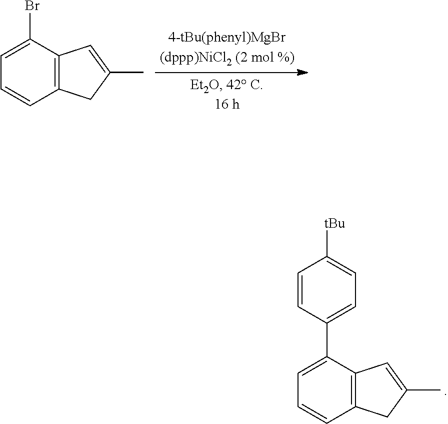

4-(4-(tert-butyl)phenyl)-2-methyl-1H-indene. To a stirred solution of 2-methyl-4-bromo-indene and Ni catalyst was slowly added the ether solution of aryl Grignard. The reaction mixture slowly changed color to dark red and became homogenous. The mixture was heated to 40° C. for 6 hours. Upon cooling, the resulting brown solution was slowly quenched with water and was diluted with HCl (ca 10% solution). Once the bubbling stopped, the mixture was further diluted with water. The organic layer was separated, and the aqueous layer was extracted with diethyl ether (2×20 mL). The combined organic layers were washed with water (2×30 mL) and saturated sodium bicarbonate (2×30 mL), dried over MgSO₄, filtered and concentrated. TLC analysis and 1H NMR show a single pure product which was used in the next step. Trace amounts of t-Bu-Benzene is observed due to residual Grignard quench. The compound was immediately lithiated in the next step (100% Yield). ¹H NMR (CDCl₃): δ 7.45 (m, 2H) 7.38 (m, 2H) 7.28 (m, 2H) 7.15 (m, 1H) 6.40 (m, 1H) 3.11 (s, 2H), 1.82 (s, 3H) 1.28 (s, 9H).

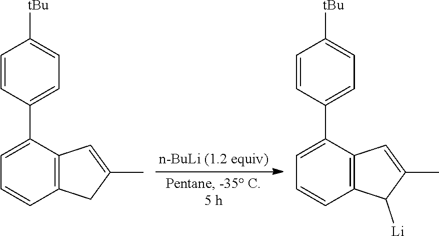

(7-(4-(tert-butyl)phenyl)-2-methyl-1H-inden-1-yl)lithium nBuLi (13.1 mL of 2.5M) was slowly added to a cooled pentane solution (−35° C.) of indene (7.15 g) in pentane. The mixture very quickly became cloudy with white precipitate. It was allowed to stir for 5 hours. After 5 hours, the solution was filtered and the solid was isolated and dried in vacuo (80% yield). ¹H NMR (C₆D₆/THF-d8) δ 8.02 (m, 2H) 7.68 (m, 2H) 7.46 (m, 2H) 7.10 (m, 2H) 6.52 (s, 1H) 6.30 (s, 1H) 3.11 (s, 2H), 1.82 (s, 3H) 1.28 (s, 9H).

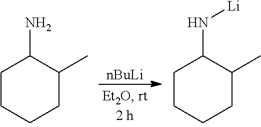

Lithium (2-methylcyclohexyl)amide. To a stirred mixture of 2-Me-cyclohexylamine (4.0 mL) in pentane (100 mL) was slowly added nBuLi (12.1 mL, 2.5 M solution). The mixture was stirred for 2 hours at room temperature and filtered. The obtained white solid was washed with pentane and dried in vacuo to give the final product in 77% yield. ¹H NMR (THF-d8): δ 2.37 (m, 1H) 1.77 (m, 1H) 1.63 (m, 3H) 1.24 (m, 3H) 0.97 (m, 6H) 1.29 (bs, 1H).

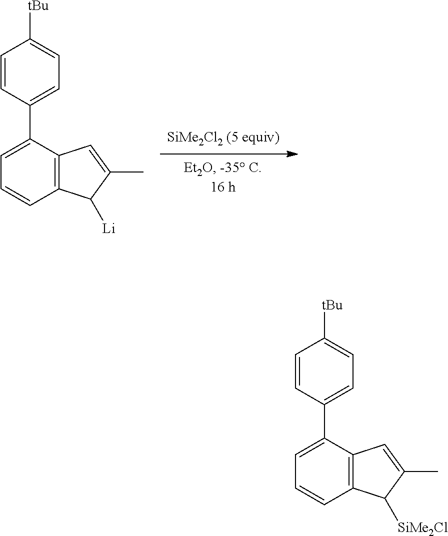

(7-(4-(tert-butyl)phenyl)-2-methyl-1H-inden-1-yl)chlorodimethylsilane. A cold ether solution of lithium indacene (3.15 g) was added slowly to a stirred ether solution of excess dichlorodimethylsilane (7.57 g). The reaction mixture was allowed to warm up to room temperature and was further stirred for 1 day. After 1 day, the reaction mixture is pale yellow with white precipitate. The solution was concentrated in vacuo to give a sticky yellow mixture. The mixture was then extracted with pentane (2×30 mL) and filtered over celite. Solvent removal in vacuo afforded the final product as a spectroscopically pure viscous yellow oil in essentially quantitative yield (100% yield). ¹H NMR (C₆D₆): δ 7.61 (m, 2H) 7.47 (m, 4H) 7.23 (m, 1H) 6.93 (s, 1H) 3.42 (s, 1H) 2.13 (s, 3H) 1.37 (s, 9H) 0.29 (s, 3H) 0.04 (s, 3H).

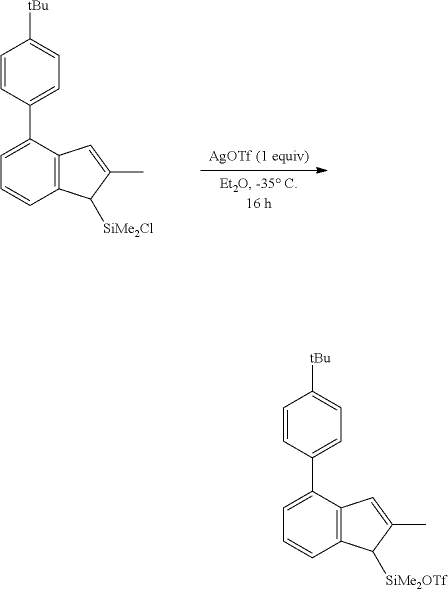

(4-(4-(tert-butyl)phenyl)-2-methyl-1H-inden-1-yl)dimethylsilyl trifluoromethanesulfonate. AgOTf (3.01 g) was added directly (as a solid) to an ether solution of indene (4.16 g). The flask was wrapped in aluminum foil, and the mixture was placed on a stir plate overnight. After 16 hours, the solution is cloudy pink with precipitate. Solvent was removed in vacuo, and the residue was extracted with pentane (2×30 mL) and filtered. Solvent removal afforded the product in good yield and purity as a very viscous brown oil in 94% yield. ¹H NMR (C₆D₆): δ 7.47 (m, 2H) 7.40 (m, 2H) 7.15 (m, 3H) 6.77 (s, 1H) 3.20 (s, 1H) 1.92 (s, 3H) 1.29 (s, 9H) 0.19 (s, 3H) −0.19 (s, 3H).

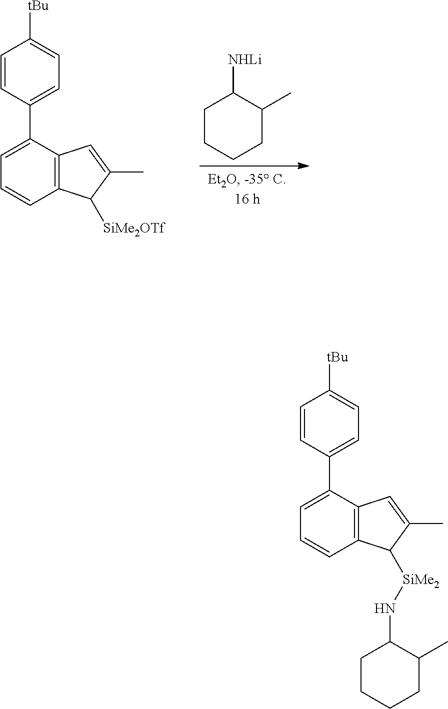

1-(4-(4-(tert-butyl)phenyl)-2-methyl-1H-inden-1-yl)-1,1-dimethyl-N-(2-methylcyclohexyl)silanamine. 2-Me-cyclohexyl lithium amide (0.276 g) was slowly added (as a ca 5 mL of cold diethylether/THF slurry), to a chilled ether solution of indenyl triflate (1.061 g). The mixture was allowed to warm up to room temperature and was stirred overnight. After 16 hours, the mixture is colorless. Solvent was removed in vacuo to give a white sticky solid. The solid was extracted with pentane (2×20 mL), filtered over celite and concentrated in vacuo. The compound was isolated as a white oil in quantitative yield as an essentially 50:50 cis/trans mixture. ¹H NMR (C₆D₆): δ 7.64 (m, 2H) 7.41 (m, 4H) 7.23 (s, 1H) 6.94 (s, 1H) 3.26 (s, 1H) 2.10-2.07 (two s, 3H each isomer) 1.59 (m, 3H) 1.29 (s, 9H) 1.10 (m, 3H) 0.88 (m, 7H) 0.16-0.02 (four s, 6H, each isomer).

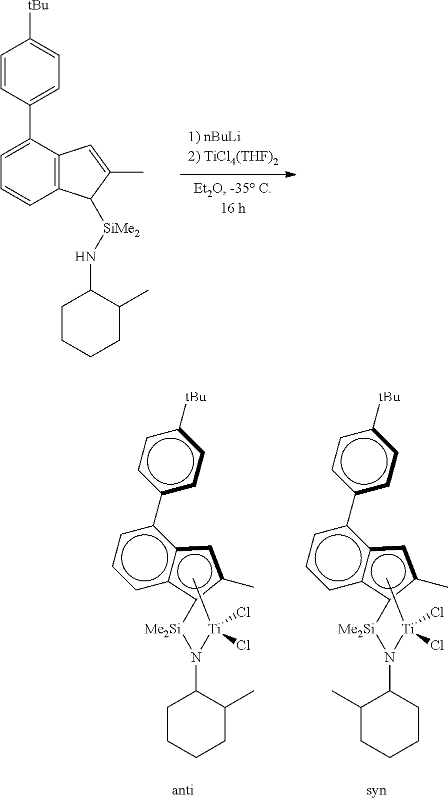

1-(4-(4-(tert-butyl)phenyl)-2-methyl-1H-inden-1-yl)-1,1-dimethyl-N-(2-methylcyclohexyl)silanamide titanium dichloride. nBuLi (2.02 mL) was slowly added to a cold solution (ca 20 mL) of ligand (1.005 g) in diethylether. Almost instantly, the colorless reaction mixture became orange. The mixture was allowed to stir for 3 hours at room temperature. After 3 hours, the solution was orange with precipitate. It was cooled to −35° C. in the freezer. While stirring, solid TiCl₄(THF)₂ was slowly added to the reaction mixture. Upon addition, the final red mixture was allowed to warm up to room temperature and was further stirred for 16 hours. After 16 hours, solvent was removed in vacuo, and the residue was extracted with pentane (2×30 mL) and filtered. The mixture was then concentrated and placed in a freezer to crystallize. After 3 days, the resulting crystals were washed with minimal pentane and dried in vacuo to give a brown/red solid in 20% yield. ¹H NMR (C₆D₆): δ 7.70 (m, 2H) 7.35 (m, 2H) 7.10 (m, 1H) 7.01 (m, 3H) 4.77 (m, 1H) 2.17-2.08 (two s, 3H total, ½ for each isomer) 1.66-1.42 (m, 6H) 1.26-1.25 (two s, 9H total) 1.04 (s, 4H) 0.95 (d, 3H) 0.66-0.42 (four s, 6H total, 2 pairs for each isomer).

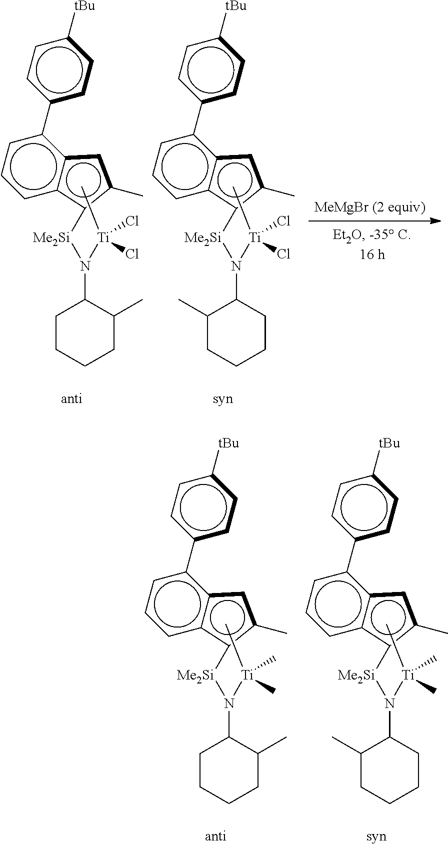

Catalyst B: 1-(4-(4-(tert-butyl)phenyl)-2-methyl-1H-inden-1-yl)-1,1-dimethyl-N-(2-methylcyclohexyl)silanamide titanium dimethyl. MeMgBr (130 μL of 3M in diethylether, 2.05 equiv.) was slowly added to a solution of titanium complex (0.104 g in 5 mL of diethylether). The mixture was allowed to warm up to room temperature and was stirred overnight. After 18 hours, the mixture was concentrated in vacuo, and the residue was extracted with pentane (2×5 mL) and filtered. Solvent removal afforded pure dimethyl complex as a mixture of syn/anti isomers in approximately 1:1 ratio in 94% yield. ¹H NMR (C₆D₆): δ 7.74 (m, 2H) 7.53 (m, 1H) 7.42 (m, 2H) 7.26 (m, 2H) 6.98 (m, 1H) 4.44 (m, 1H) 2.03-1.98 (two s, 3H total, ½ for each isomer) 1.63-1.55 (m, 5H) 1.26-1.25 (two s, 9H total) 1.09 (bm, 5H) 1.00 (two d, 3H total) 0.99-0.83 (two s, 3H total) 0.64-0.61 (two s, 3H total) 0.50-0.46 (two s, 3H total) 0.07-0.04 (two s, 3H total).

### Preparation of Catalyst C

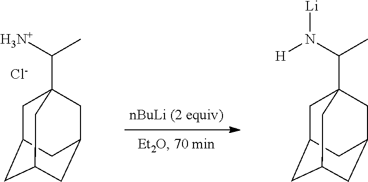

Lithium (1-(1-adamantanyl)ethyl)amide. To a stirring suspension of 1-(1-adamantyl)ethylamine hydrochloride (2.043 g, 9.47 mmol) in diethyl ether (100 mL), n-butyllithium (7.8 mL, 2.48M in hexane, 19.34 mmol, 2.04 equiv.) was added. The reaction was stirred at room temperature for 70 minutes. The reaction was concentrated under a stream of nitrogen and then under high vacuum. The residue was stirred in diethyl ether (10 mL). The resulting suspension was filtered over a plastic, fritted funnel. The filtered solid was washed with pentane (10 mL). The solid was collected and concentrated under high vacuum to afford the product as a white solid (1.68 g, 95% purity by mass), containing residual lithium chloride. Product purity was determined by ¹H NMR with cyclohexane internal standard.

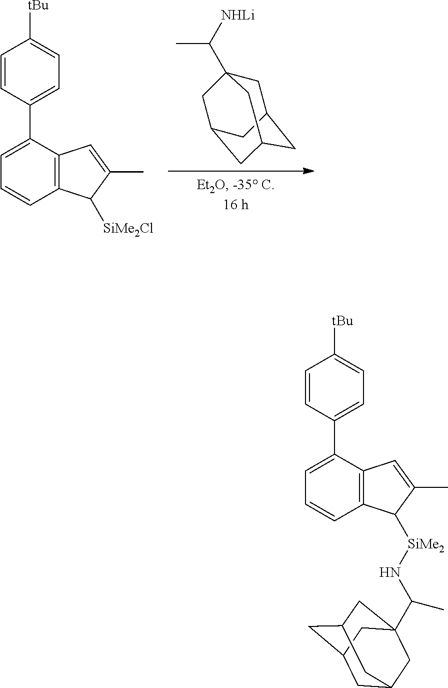

N-(1-((3r,5r,7r)-adamantan-1-yl)ethyl)-1-(4-(4-(tert-butyl)phenyl)-2-methyl-1H-inden-1-yl)-1,1-dimethylsilanamine. A 50 mL diethyl ether suspension of silyl chloride (1.054 g) and adamantyl amide (0.579 g) was stirred at room temperature overnight. After 16 hours the reaction mixture is pale yellow with precipitate. Solvent was removed in vacuo, and the residue was extracted with hexane (2×10 mL) and filtered over celite. Solvent removal afforded white foam in good yield (99%) and purity as a mixture of isomers. ¹H NMR (C₆D₆) δ 7.65 (m, 2H), 7.42 (m, 4H), 7.24 (m, 1H), 6.95 (m, 1H), 3.29 (m, 1H), 2.18 (m, 1H) 2.11 (two s, 3H total), 1.92 (s, 4H), 1.63 (m, 8H), 1.59 (m 3H), 1.29 (two s, 9H total), 0.90-0.80 (two d, 3H total, CH—CH₃) 0.18-0.03 (four s, 6H total, SiMe₂ moiety).

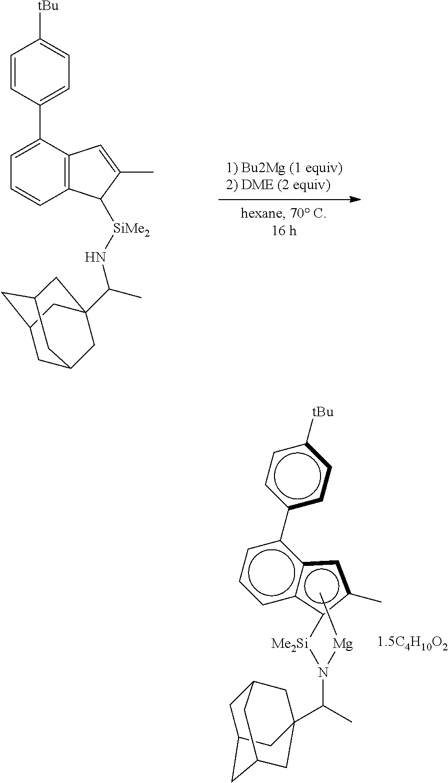

N-(1-((3r,5r,7r)-adamantan-1-yl)ethyl)-1-(4-(4-(tert-butyl)phenyl)-2-methyl-1H-inden-1-yl)-1,1-dimethylsilanamide magnesium (II). To a hexane mixture of ligand was added 1.05 equiv. of dibutyl magnesium. Initially, no color change is observed. The reaction mixture was heated to 70° C. overnight. After 18 hours, the bright yellow mixture was cooled down to room temperature. DME (1.0 equiv.) was added. The mixture was stirred for 5 minutes which gave a thick oil that settled at the bottom of the flask. Solvent was decanted off, and the flask was placed under vacuum. This resulted in formation of bright yellow solid. The extracts from the flask were further dried in vacuo. ¹H NMR indicates good purity of the desired magnesocene in ca 71% yield. Syn/anti isomers are both observed. The DME content appears to be about 1.5 equivalents (not included in NMR integration). ¹H NMR (THF-d8) δ 7.78 (m, 1H), 7.66 (m, 2H), 7.40 (m 2H), 6.74 (m, 2H), 6.48 (m, 1H), 2.69 (m, 1H), 2.60 (two s, 3H total 2-Me indene), 2.57 (bs, 3H), 1.99 (bs, 2H), 1.77 (bs, 2H) , 1.69 (bs, 4H), 1.52 (bs, 4H), 1.40 (two s, 9H total, tBu), 1.14-1.05 (two d, 3H total, CH—CH₃), 0.40-0.33 (four s, 6H total, SiMe₂).

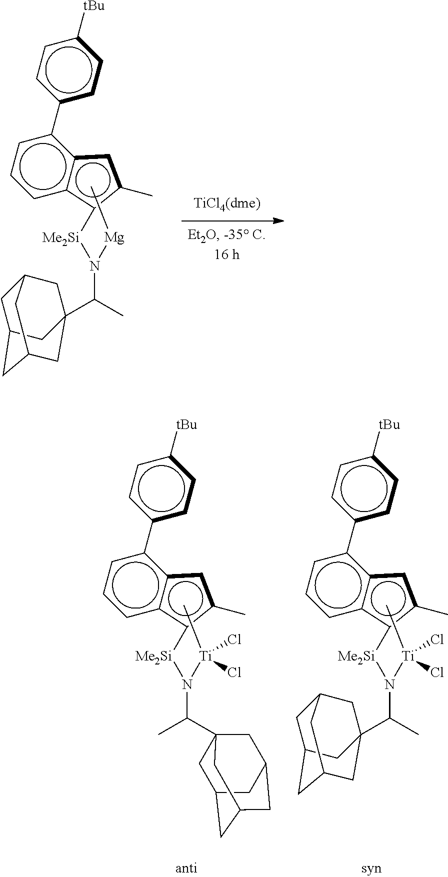

N-(1-((3r,5r,7r)-adamantan-1-yl)ethyl)-1-(4-(4-(tert-butyl)phenyl)-2-methyl-1H-inden-1-yl)-1,1-dimethylsilanamide titanium dichloride. Magnesocene ligand (1.12 g) was dissolved in diethylether (20 mL) and cooled in the freezer to −35° C. To this solution was added dropwise TiCl₄(dme) at −35° C. as a neat solid. The mixture instantly darkened as it warmed up to room temperature. It was then heated to 42° C. overnight. After 16 hours, solvent was removed in vacuo to give a dark red residue. The residue was extracted with methylene chloride (2×10 mL) and filtered over celite. Solvent was removed in vacuo to give brown/red foam. The foam was suspended in hexane (ca 10 mL) and filtered again over celite. The hexane layer was concentrated to ca 4 mL and placed in a freezer for several hours. The resulting bright red material was filtered and dried in vacuo. This batch yielded an approximately 6:4 mixture of syn/anti isomers. The supernatant liquid was stored in a freezer and afforded a second crop of material that with approximate syn:anti ratio of 4:6. The total yield obtained was 48% of combined batches. ¹H NMR (CD₂C₁₂, isomer 1) δ 7.82 (m, 1H), 7.58 (m, 4H), 7.36 (s, 1H) 7.33 (s, 1H), 7.25 (s, 1H), 4.94 (m, 1H), 2.35 (s, 3H), 2.01 (m, 5H), 1.68 (m, 10H) 1.42 (s, 9H), 1.19 (s, 3H, SiMe₂), 1.07 (d, 3H), 0.78 (s, 3H, SiMe 2). ¹H NMR (CD₂Cl₂, isomer 2) δ 7.66 (m, 1H), 7.58 (m, 4H), 7.35 (d, 1H), 7.32 (d, 1H), 4.94 (m, 1H), 2.43 (s, 3H), 2.01 (m, 5H), 1.68 (m, 10H) 1.42 (s, 9H), 1.04 (s, 3H, SiMe₂), 0.96 (d, 3H), 0.91 (s, 3H, SiMe₂).

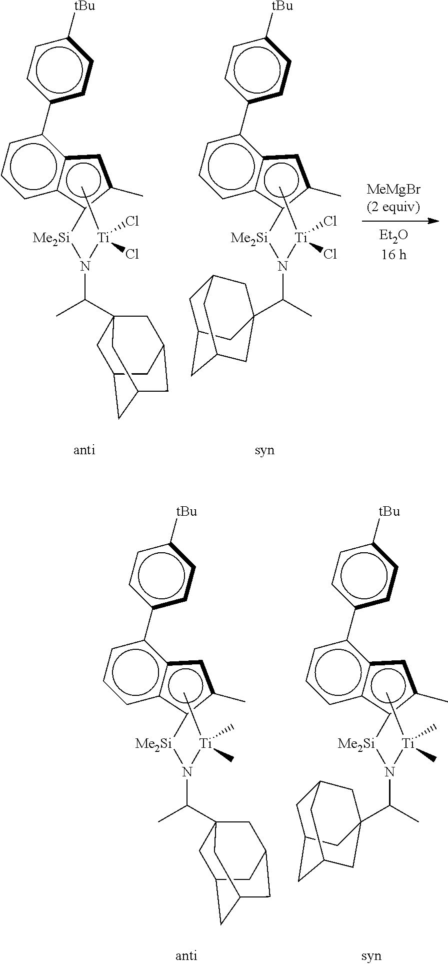

Catalyst C: N-(1-((3r,5r,7r)-adamantan-1-yl)ethyl)-1-(4-(4-(tert-butyl)phenyl)-2-methyl-1H-inden-1-yl)-1,1-dimethylsilanamide titanium dimethyl. 0.142 mL of MeMgBr (2.25 equiv.) was added to a stirred solution of titanium dichloride (0.125 g of 6:4 anti:syn ratio) in diethyl ether at room temperature. The reaction mixture was stirred overnight. After 16 hours solvent was removed in vacuo, and the residue was extracted with hexane (2×5 mL) and filtered over celite. Solvent removal afforded dimethyl complex in good purity and yield (88%). The isomer ratio carried over from starting dichloride mixture. ¹H NMR (CD₂Cl₂, anti isomer) δ 7.72 (m, 2H), 7.56 (m, 1H), 7.45 (m, 2H) 7.32 (s, 1H), 7.22 (m, 1H), 6.95 (m, 1H) 5.18 (m, 1H), 1.97 (s, 3H), 1.64 (m, 15H) 1.28 (s, 9H), 1.13 (m, 3H, CH—CH₃), 0.84 (s, 3H, Ti-Me) 0.83 (s, 3H, SiMe₂) 0.48 (s, 3H SiMe₂), 0.10 (s, 3H, Ti-Me). ¹H NMR (CD₂Cl₂, syn isomer) δ 7.72 (m, 2H), 7.51 (m, 1H), 7.45 (m, 2H) 7.29 (s, 1H), 7.26 (m, 1H), 7.04 (m, 1H) 5.10 (m, 1H), 1.98 (s, 3H), 1.64 (m, 15H) 1.28 (s, 9H), 1.09 (d, 3H, CH—CH₃), 0.90 (s, 3H, Ti-Me) 0.67 (s, 3H, SiMe₂) 0.61 (s, 3H SiMe₂), 0.01 (s, 3H, Ti-Me). The mixture of isomers can be used in polymerization studies as is, or one can attempt to enrich the mixture by fractional crystallization. This can be done by dissolving the syn:anti mixture in minimal hexane and placing it in the freezer. Anti-enriched crystals in 7:3 ratio (ca 0.020 g, were obtained after filtration. The supernatant solution was found to contain syn enriched fraction.

### Preparation of Catalysts D and E

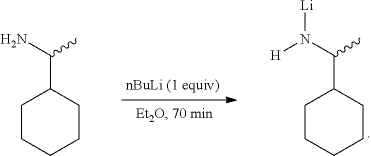

The squiggly bond indicates that the same preparation applies for both R and S isomers. Lithium (1-cyclohexylethyl)amide Both commercially obtained isomers (R,S) of 1-cyclohexylethan-1-amine were lithiated in two separate reactions by adding nBuLi (1.2 equiv.) to a pentane solution of amine (1.0 g) at −35° C. While the lithiation proceeded smoothly, the product appeared to be soluble in pentane. Solvent was removed in vacuo and ca 20 mL of ether was added, and the mixture was stirred overnight. After 18 hours, white solid was collected and washed with minimal pentane. ¹H NMR indicates pure product—in both cases ca 0.8 g was isolated (76% yield). Given the enantiomeric relationship between two compounds, their ¹H NMR traces are identical. ¹H NMR (THF-d₈) δ 2.78 (m, 1H), 1.91 (s, 2H), 1.69 (m, 2H), 1.19 (m, 4H), 0.95 (m, 6H), −1.47 (s, 1H).

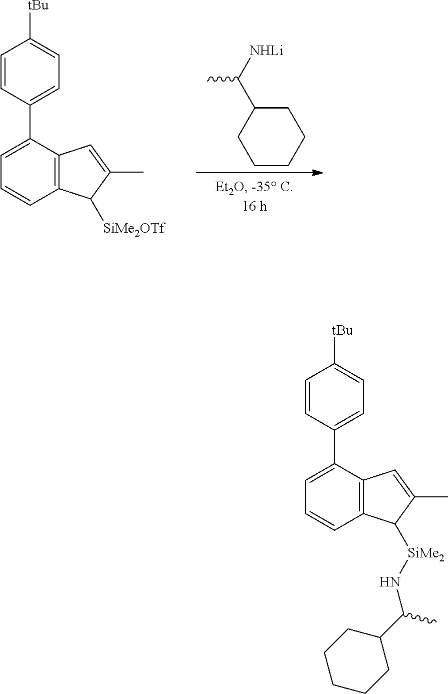

1-(4-(4-(tert-butyl)phenyl)-2-methyl-1H-inden-1-yl)-N-(1-cyclohexylethyl)-1,1-dimethylsilanamine. Same procedure was used to prepare both enantiopure (R and S forms) of the ligand. To a stirred slurry of lithium amide (0.3 g) in diethylether was slowly added a heptane/ether solution of indenyl triflate (1.05 g). The mixture was allowed to warm up to room temperature and was stirred for two days. After two days, both mixtures are pale yellow and clear. Solvent was removed in vacuo, and the residue was extracted with pentane (2×20 mL) and filtered. Solvent removal afforded pure compounds that appear to be mixtures of syn/anti diastereomers in 99% yield. ¹H NMR (C₆D₆) δ 7.66 (m, 2H), 7.45 (m, 4H), 7.25 (m, 1H), 6.95 (s, 1H), 3.29 (s, 1H), 2.46 (m, 1H), 2.11 (two s, 3H total), 1.73 (m, 5H), 1.65 (m, 1H), 1.30 (s, 9H, tBu) 1.12 (m, 5H), 0.92-0.84 (two d, 3H each CH—CH₃), 0.16-0.00 (four s, 6H total).

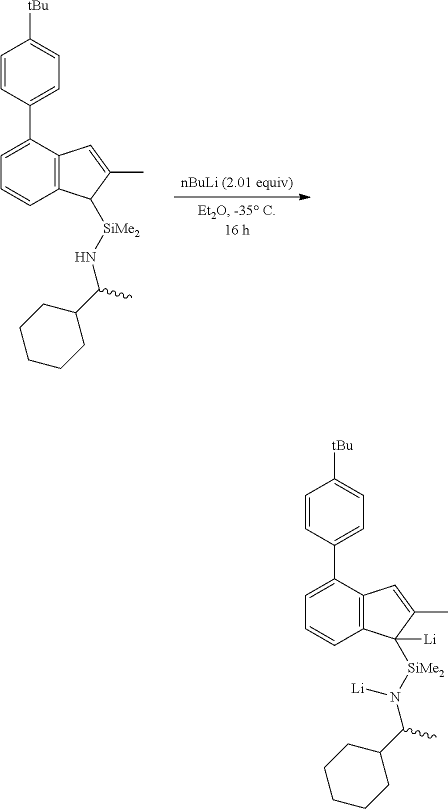

Dilithium-1-(4-(4-(tert-butyl)phenyl)-2-methyl-1H-inden-1-yl)-N-(1-cyclohexylethyl)-1,1-dimethylsilanamide. nBuLi (1.8 mL of 2.5M solution) was added to a stirred mixture of ligand (1.0 g) in diethylether at −35° C. The mixture almost instantly turned deep red. It was allowed to warm up to room temperature and was stirred overnight. After 16 hours, solvent was removed in vacuo, and the residue was washed with pentane (2×15 mL) and dried in vacuo to give a final product as a diethyl ether adduct (0.85 equiv.) in 92% yield regardless of the isomer used (R or S). The complex was used in the next step without further purification. ¹H NMR (THF-d8) δ 7.70 (m, 2H), 7.38 (m, 3H), 6.71 (m, 1H), 6.58 (s, 1H), 6.30 (m, 1H), 2.98 (s, 1H), 2.56 (s, 3H), 2.26 (m, 1H) 1.76 (m, 2H), 1.41 (s, 9H) 1.40 (m, 3H), 1.04 (m, 3H), 0.92 (m, 5H) 0.25 (bm, 6H).

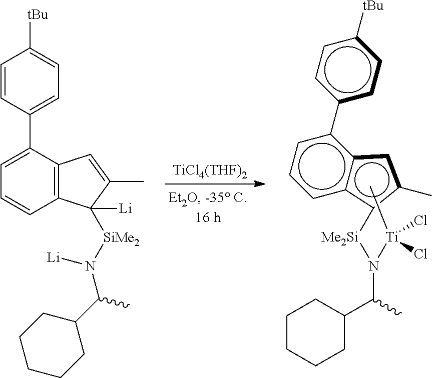

Same procedure and amounts were used for both R/S isomers. The catalysts D and E were prepared according to identical procedure.

1-(4-(4-(tert-butyl)phenyl)-2-methyl-1H-inden-1-yl)-N-(1-cyclohexylethyl)-1,1-dimethylsilanamide titanium dichloride. TiCl₄(THF)₂ (0.693 g) was slurried in ether and cooled to −35° C. While stirring, an ether solution of dilithiated ligand (1.08 g) was slowly added to titanium slurry. After the addition, the solution became dark brown. It was allowed to warm up to room temperature and was stirred overnight. After 16 hours, the mixture was concentrated in vacuo, and the resulting brown residue was extracted with methylene chloride and filtered over celite. Solvent was removed again, and the residue was triturated with pentane and allowed to stir for 30 minutes. After 30 minutes, the mixture showed signs of brown/grey precipitate, which was filtered over celite again. The pentane solution was then concentrated to ca 8 mL and placed in a freezer over the weekend. After 3 days, both vials (R,S versions) contained red crystalline solid. The mixtures were decanted, and solids were dried in vacuo. In both cases, very pure titanium dichlorides were obtained as 1:1 syn/anti diastereomeric mixtures. Yield (R-isomer, catalyst D) 24%; Yield (S-isomer, catalyst E) 21%. Since catalysts E and catalyst D are enantiomers, their NMR traces are identical. ¹H NMR (400 MHz, C₆D₆) δ 7.70 (m, 3H), 7.36 (m, 2H), 7.18 (m, 1H), 7.10 (m, 2H), 4.99 (m, 1H), 2.15-2.08 (two s, 3H total, 2-Me indene), 1.56 (bm, 6H), 1.26 (s, 9H, tBu), 1.23 (overlapping m, 5H), 1.07-1.01 (two d, 3H total), 0.68-0.40 (four s, 6H total).

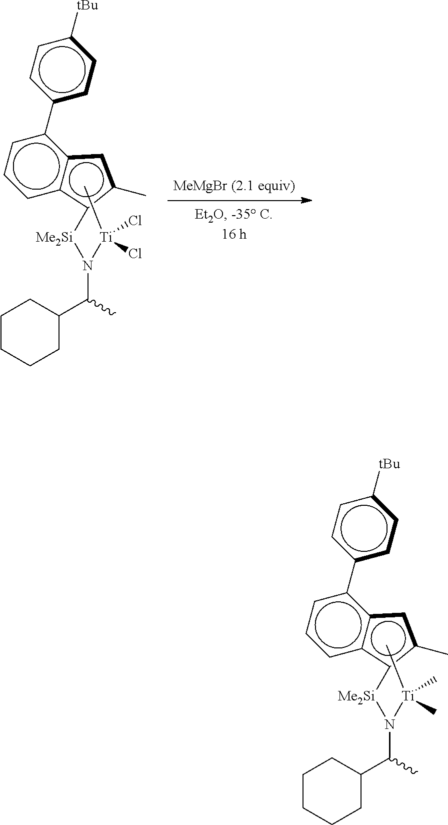

Catalyst D (S-isomer) and Catalyst E (R-isomer): 1-(4-(4-(tert-butyl)phenyl)-2-methyl-1H-inden-1-yl)-N-(1-cyclohexylethyl)-1,1-dimethylsilanamine titanium dimethyl. MeMgBr (0.171 mL of 3M solution, 2.1 equiv.) was added to a cold solution of titanium dichloride (0.141 g) in diethylether. The mixture was allowed to warm up to room temperature, and was further stirred for 18 hours. After 18 hours, solvent was removed in vacuo, and the residue was extracted with pentane (2×8 mL) and filtered. Solvent removal afforded pure titanium dimethyl complex as a mixture of syn/anti isomers of Catalyst D (92% yield). Same procedure was utilized for the S-isomer (catalyst E, 90% yield). ¹H NMR (Anti isomer, C₆D₆) δ 7.76 (m, 2H), 7.56 (d, 1H), 7.43 (m, 2H), 7.25 (m, 2H), 7.01 (m, 1H), 4.74 (m, 1H), 1.98 (s, 3H, 2-Me indenyl), 1.73 (bm, 11H), 1.15 (d, 3H), 0.83 (s, 3H, Ti-Me), 0.66 (s, 3H, SiMe₂), 0.45 (s, 3H, SiMe₂), 0.07 (s, 3H, Ti-Me). ¹H NMR (Syn isomer, C₆D₆) δ 7.73 (m, 2H), 7.54 (d, 1H), 7.45 (m, 2H), 7.28 (m, 2H), 6.96 (m, 1H), 4.74 (m, 1H), 2.01 (s, 3H, 2-Me indenyl), 1.73 (bm, 11H), 1/29 (s, 9H tBu) 1.22 (d, 3H), 0.88 (s, 3H, Ti-Me), 0.59 (s, 3H, SiMe₂), 0.52 (s, 3H, SiMe₂), 0.02 (s, 3H, Ti-Me).

### Preparation of Catalyst F

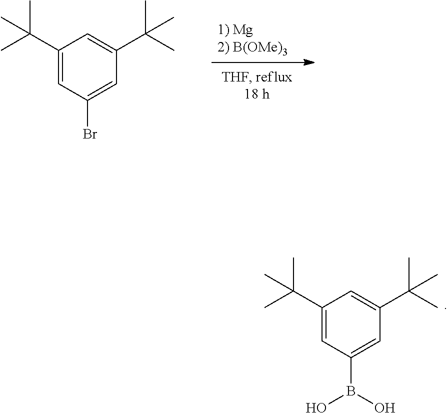 [SMILES: CC(C)(C)c1cc(Br)cc(C(C)(C)C)c1 ; CC(C)(C)c1cc(B(O)O)cc(C(C)(C)C)c1]

3,5-Di-tert-butylphenylboronic acid. The following procedure was adapted from Chemistry—A European Journal, (2020) v. 18(14), pp. 4174-4178. To a stirring suspension of magnesium turnings (0.497 g, 20.4 mmol, 1.4 equiv.) in tetrahydrofuran (15 mL), a solution of 1-bromo-3,5-di-tert-butylbenzene (3.930 g, 14.6 mmol) in tetrahydrofuran (10 mL). The reaction was stirred and heated to reflux for 3 hours and then allowed to warm to room temperature. Separately, a solution of trimethylborate (2.5 mL, 22.4 mmol, 1.5 equiv.) in diethyl ether (50 mL) was cooled to −60° C. To this cooled, stirring trimethylborate solution, the Grignard solution was added dropwise via addition funnel. Once addition was complete, the reaction, a white-grey suspension, was allowed to stir at room temperature overnight. The reaction was quenched by adding water (30 mL) and then concentrated aqueous hydrochloric acid (3 mL, 12M). The resulting mixture was added to a separatory funnel, and then organic phase was extracted. The aqueous phase was further extracted with diethyl ether (3×50 mL). The combined organic extracts were washed with brine. The organic extract was dried over anhydrous sodium sulfate and filtered. The filtrate was concentrated in vacuo to afford the product as a solid mixture of monomer and oligomers. ¹H NMR (400 MHz, CDCl₃): major product δ 8.13 (d, 2H), 7.69 (t, 1H,), 1.42 (s, 18H).

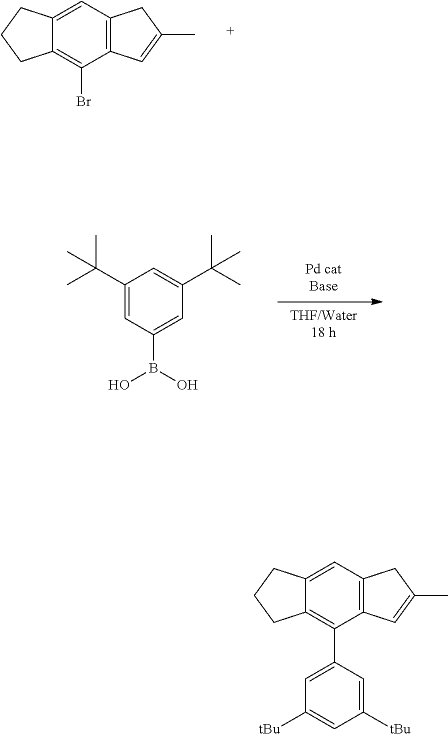

6-Methyl-8-(3,5-di-tert-butylphenyl)-1,2,3,5-tetrahydro-s-indacene. To a sealed flask with a stir bar, 3,5-di-tert-butylphenylboronic acid (3.136 g, 13.39 mmol, 1 equiv.), 8-bromo-6-methyl-1,2,3,5-tetrahydro-s-indacene (3.337 g, 13.39 mmol), potassium carbonate (4.132 g, 29.47 mmol, 2.2 equiv.), bis(dibenzylideneacetone)palladium (0.077 g, 0.13 mmol, 0.01 equiv.), and 1,3,5,7-tetramethyl-6-phenyl-2,4,8-trioxa-6-phosphaadamantane (0.117 g, 0.40 mmol, 0.03 equiv.) were added with tetrahydrofuran (25 mL). Then, nitrogen-purged water (5 mL) was added to the flask, and the flask was purged with nitrogen for 20 minutes. The flask was sealed and heated to 75° C. for 17.5 hours. The reaction, an orange suspension, was allowed to cool to room temperature. The reaction was poured into a separate flask and concentrated in vacuo. The residue was partitioned between water and hexane. The hexane phase was extracted. The aqueous phase was further extracted with hexane. The combined hexane extracts were washed with saturated aqueous potassium carbonate and then brine. The organic phase was dried over anhydrous magnesium sulfate. The mixture was filtered over a pad of silica (approximately 4-5 cm thick), washing product through with additional hexane (300 mL). The hexane filtrate was concentrated in vacuo to afford the product as a white solid (4.543 g). ¹H NMR (400 MHz, C₆D₆): δ 7.56 (t, 1H), 7.41 (d, 2H), 7.20 (s, 1H), 6.50 (q, 1H), 3.17 (s, 2H), 2.93 (q, 4H), 1.91 (p, 2H,), 1.86 (s, 3H), 1.35 (s, 18H).

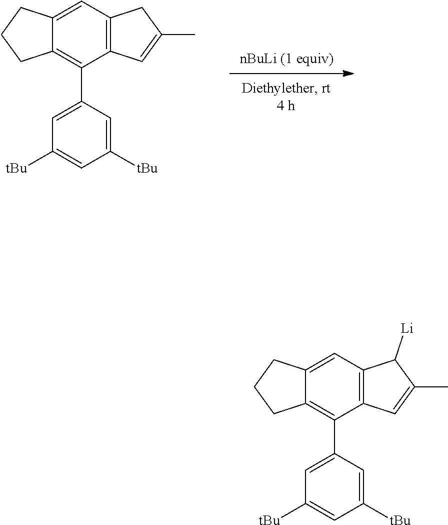

Lithium 4-(3,5-di-tert-butylphenyl)-2-methyl-1,5,6,7-tetrahydro-s-indacenide. To a precooled, stirring solution of 6-methyl-8-(3,5-di-tert-butylphenyl)-1,2,3,5-tetrahydro-s-indacene (4.543 g, 12.67 mmol) in diethyl ether (100 mL), n-butyllithium (5.2 mL, 2.48M in hexane, 12.9 mmol, 1.02 equiv.) was added. The reaction was stirred at room temperature for 3.5 hours. The reaction was filtered over a plastic, fritted funnel. The filtrate was concentrated under a stream of nitrogen and then under high vacuum. The residue was stirred in hexane (20 mL). The resulting suspension was filtered over a plastic, fritted funnel. The filtered solid was collected and concentrated under high vacuum to afford the product as an orange solid (4.076 g), containing diethyl ether (0.25 equiv.) and hexane (0.14 equiv.). ¹H NMR (THF-d8): δ 7.53 (d, 2H, J=1.9 Hz), 7.26 (t, 1H, J=1.9 Hz), 7.06 (s, 1H), 5.78-5.75 (m, 1H), 5.72-5.69 (m, 1H), 2.91-2.84 (m, 4H), 2.31 (s, 3H), 1.90 (p, 2H), 1.37 (s, 18H).

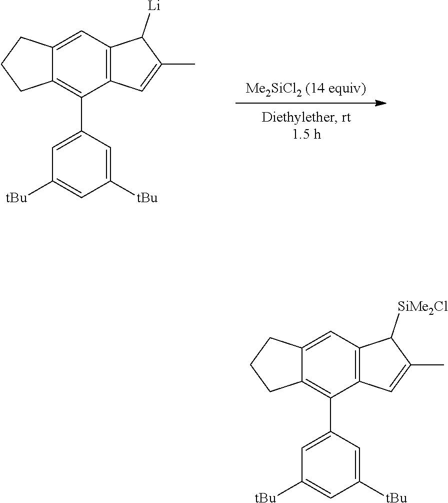

Chloro(4-(3,5-di-tert-butylphenyl)-2-methyl-1,5,6,7-tetrahydro-s-indacenyl)dimethylsilane. To a stirring solution of dichlorodimethylsilane (4.5 mL, 37.3 mmol, 14.6 equiv.) in diethyl ether (100 mL), a solution of lithium 4-(3,5-di-tert-butylphenyl)-2-methyl-1,5,6,7-tetrahydro-s-indacenide (1.011 g, 2.56 mmol) in diethyl ether (20 mL) was added. The reaction was stirred at room temperature for 1.5 hours. The reaction was concentrated under a stream of nitrogen and then under high vacuum. The residue was extracted with pentane (2×30 mL) and filtered over Celite. The combined pentane extracts were concentrated under a stream of nitrogen and then under high vacuum to afford the product as a white solid (1.082 g). ¹H NMR (400 MHz, C₆D₆): δ 7.60 (t, 1H), 7.52 (d, 2H), 7.41 (s, 1H), 6.79 (s, 1H), 3.42 (s, 1H), 3.01-2.88 (m, 4H), 2.06 (s, 3H), 1.88 (p, 2H), 1.36 (s, 18H), 0.29 (s, 3H), 0.05 (s, 3H).

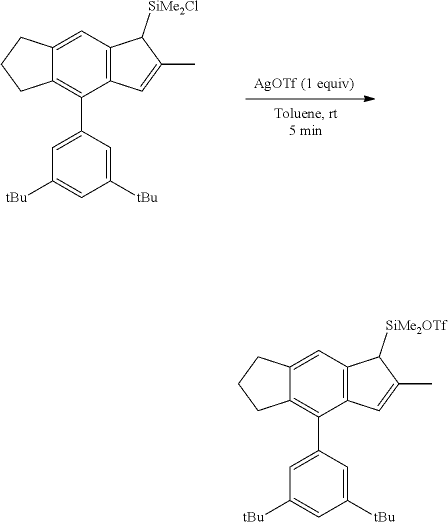

(4-(3,5-Di-tert-butylphenyl)-2-methyl-1,5,6,7-tetrahydro-s-indacenyl)dimethylsilyl trifluoromethanesulfonate. To a stirring solution of chloro(4-(3,5-di-tert-butylphenyl)-2-methyl-1,5,6,7-tetrahydro-s-indacenyl)dimethylsilane (0.529 g, 1.17 mmol) in toluene (10 mL), silver(I) trifluoromethanesulfonate (0.301 g, 1.17 mmol, 1 equiv.) was added with toluene (2 mL). The reaction was stirred at room temperature for 5 minutes. The reaction was filtered over Celite, extracting further from the reaction flask with pentane (10 mL). The combined toluene and pentane extracts were concentrated under a stream of nitrogen and then under high vacuum to afford the product as a pale yellow oil (0.582 g), containing toluene (0.22 equiv.). ¹H NMR (400 MHz, C₆D₆): □7.60 (t, 1H), 7.47 (d, 2H), 7.21 (s, 1H), 6.72 (s, 1H), 3.28 (s, 1H), 3.00-2.85 (m, 4H), 1.91 (s, 3H), 1.86 (p, 2H), 1.36 (s, 18H), 0.25 (s, 3H), −0.08 (s, 3H).

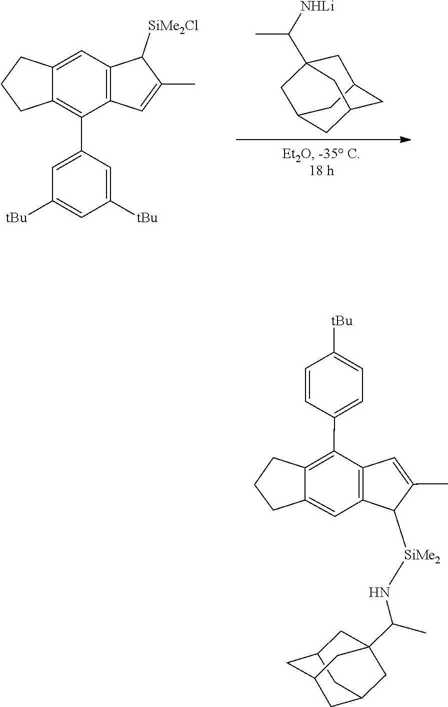

N-(1-(1-adamantypethyl)-1-(4-(3,5-di-tert-butylphenyl)-2-methyl-1,5,6,7-tetrahydro-s-indacenyl)-1,1-dimethylsilanamine. To a precooled, stirring solution of (4-(3,5 -di-tert-butyl phenyl)-2-methyl-1,5,6,7-tetrahydro-s-indacen-1-yl)dimethylsilyl trifluoromethanesulfonate (0.582 g, 0.995 mmol) in diethyl ether (30 mL), a suspension of lithium (1-(1-adamantanyl)ethyl)amide (0.194 g, 95% purity by mass, 0.999 mmol, 1 equiv.) in diethyl ether (20 mL) was added. The reaction, a white suspension, was stirred at room temperature for 18 hours. The reaction was concentrated under a stream of nitrogen and then under high vacuum. Then, tetrahydrofuran (20 mL) was added to the residue, and the resulting solution was stirred for 2 hours. The solution was then concentrated under a stream of nitrogen and then under high vacuum. The residue was extracted with pentane (50 mL, and then an additional 10 mL) and filtered over Celite. The combined pentane extracts were concentrated under a stream of nitrogen and then under high vacuum to afford the product as a white foam (0.429 g, mixture of two diastereomers). ¹H NMR (C₆D₆): δ 7.63-7.57 (m, 6H), 7.50 (s, 1H), 7.46 (s, 1H), 6.85 (s, 1H), 6.85 (s, 1H), 3.35 (s, 1H), 3.31 (s, 1H), 3.11-2.87 (m, 8H), 2.29-1.22 (m, 39H), 0.93 (d, 3H, J=6.6 Hz), 0.88 (d, 3H), 0.26 (s, 3H), 0.19 (s, 3H), 0.154 (s, 3H), 0.146 (s, 3H).

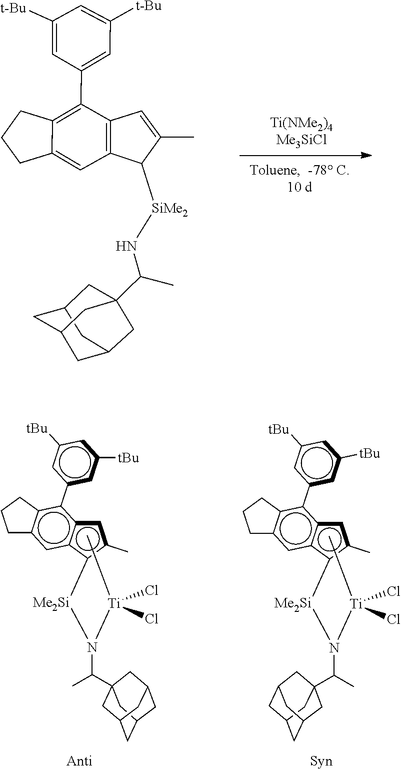

Dimethylsilyl (1-(1-adamantyl)-ethylamido) (2-methyl-4-(3,5-di-tert-butylphenyl)-1,5,6,7-tetrahydro-s-indacenyl) titanium dichloride. To a stirring solution of tetrakis(dimethylamido)titanium(IV) (0.166 g, 0.740 mmol, 1.03 equiv.) in toluene (20 mL) cooled to −78° C., a solution of N-(1-(1-adamantypethyl)-1-(4-(3,5-di-tert-butylphenyl)-2-methyl-1,5,6,7-tetrahydro-s-indacen-1-yl)-1,1-dimethylsilanamine (0.429 g, 0.722 mmol) in toluene (20 mL), also cooled to −78° C., was added. The reaction was stirred at −78° C. for 5 minutes before being allowed to slowly warm to ambient temperature. The reaction flask was then fitted with a reflux condenser and refluxed for 6 days. Then, additional tetrakis(dimethylamido)titanium(IV) (0.180 g, 0.803 mmol, 1.11 equiv.), and the reaction was refluxed for an additional 4 days. Then additional tetrakis(dimethylamido)titanium(IV) (0.130 g, 0.580 mmol, 0.803 equiv.) was added. The reaction was refluxed for an additional 4 hours. The reaction was then concentrated under a stream of nitrogen at 50° C. and then under high vacuum at 50° C. The resulting black solid was stirred in dichloromethane (10 mL). To this mixture, chlorotrimethylsilane (0.55 mL, 4.3 mmol, 6.0 equiv.) was added, and the reaction was stirred 17 hours. Then, additional chlorotrimethylsilane (0.60 mL, 4.7 mmol, 6.5 equiv.) was added, and the reaction was stirred an additional 6 hours. The reaction was then concentrated under a stream of nitrogen and then under high vacuum at 70° C. The resulting residue was extracted with dichloromethane and filtered over Celite. The dichloromethane extract was concentrated under a stream of nitrogen and then under high vacuum. The residue, a black solid, was dissolved in minimal pentane (10×1mL) and filtered through Celite and glass wool. The combined pentane extracts cooled to −35° C. The resulting precipitate was collected and concentrated under high vacuum to afford a fraction of the product as a dark red solid (0.138 g, 27% yield; 1:1 isomer ratio). The original pentane-washed black solid crude was extracted further with pentane (5 mL) and filtered over Celite and glass wool. The pentane extract was concentrated to about half volume and cooled to −35° C. The resulting precipitate was collected and concentrated under high vacuum to afford a second fraction of the product as a dark red solid (0.031 g, 6% yield, one isomer). ¹H NMR (400 MHz, CD₂Cl₂): δ 7.56 (s, 1H), 7.47-7.45 (m, 2H), 7.44 (s, 1H), 7.41-7.30 (br s, 4H), 6.85 (s, 1H), 6.84 (s, 1H), 4.88 (q, 1H,), 4.83 (q, 1H), 3.06-2.74 (m, 8H), 2.32 (s, 3H), 2.25 (s, 3H), 2.11-2.01 (m, 2H), 2.00-1.91 (m, 8H), 1.73-1.44 (m, 24H), 1.38 (s, 36H), 1.13 (s, 3H), 1.01 (d, 3H), 0.97 (s, 3H), 0.94 (d, 3H), 0.86 (s, 3H), 0.72 (s, 3H).

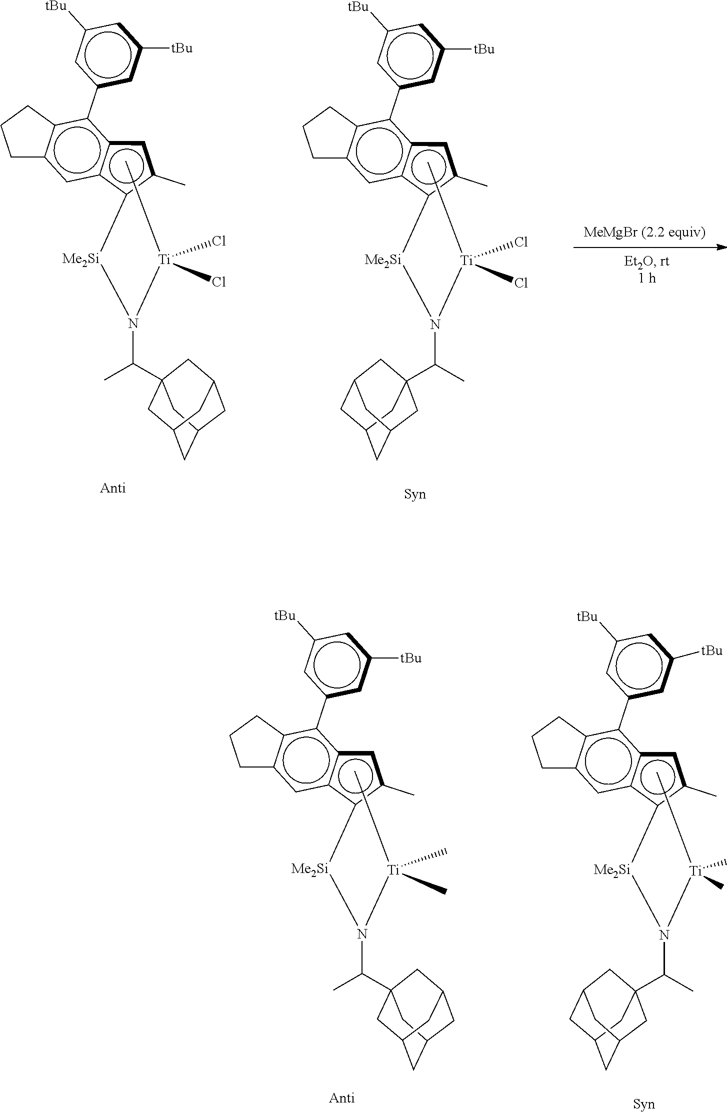

Catalyst F: Dimethylsilyl (1-(1-adamantyl)-ethylamido) (2-methyl-4-(3,5-di-tert-butylphenyl)-1,5,6,7-tetrahydro-s-indacenyl) titanium dimethyl. To a stirring solution of dimethylsilyl (1-(1 -adamantyl)-ethylamido) (2-methyl-4-(3,5-di-tert-butylphenyl)-1,5,6,7-tetrahydro-s-indacenyl) titanium dichloride (0.097 g, 0.14 mmol) in diethyl ether (10 mL), methylmagnesium bromide (0.10 mL, 3.0M in diethyl ether, 0.30 mmol, 2.2 equiv.) was added, changing the reaction color from a dark red to a light brown-yellow color. The reaction was stirred at room temperature for 1 hour. The reaction was concentrated under a stream of nitrogen and then under high vacuum. The residue was extracted with pentane (3×5 mL) and filtered over Celite. The combined pentane extracts were concentrated under a stream of nitrogen and then under high vacuum to afford the product as a light brown solid (0.104 g, 96% yield, 1.4:1 isomer ratio), containing diethyl ether (1.67 equiv.). ¹H NMR (C₆D₆), Isomer 1: δ 7.73 (br s, 2H), 7.66 (t, 1H,), 7.58 (s, 1H), 7.20 (s, 1H), 5.09 (q, 1H), 3.01-2.91 (m, 1H), 2.86-2.73 (m, 2H), 2.69-2.59 (m, 1H), 2.00 (s, 3H), 1.99-1.92 (m, 3H), 1.75-1.65 (m, 14H), 1.42 (s, 18H), 1.17 (d, 3H,), 0.96 (s, 3H), 0.93 (s, 3H), 0.52 (s, 3H), 0.17 (s, 3H); Isomer 2: δ 7.76-7.68 (br s, 2H), 7.66 (t, 1H,), 7.51 (s, 1H), 5.19 (q, 1H), 3.03-2.90 (m, 1H), 2.88-2.58 (m, 3H), 2.02 (s, 3H), 2.01-1.94 (m, 3H), 1.83-1.63 (m, 14H), 1.42 (s, 18H), 1.15 (d, 3H), 0.98 (s, 3H), 0.71 (s, 3H), 0.69 (s, 3H), 0.08 (s, 3H). This batch was used directly in polymerization studies.

Procedures to obtain anti enriched sample of catalyst F: To a precooled, stirring solution of N-(1-(1-adamantanyl)ethyl)-1-(4-(3,5-di-tert-butylphenyl)-2-methyl-1,5,6,7-tetrahydro-s-indacenyl)-1,1-dimethylsilanamine (1.140 g, 1.919 mmol) in diethyl ether (50 mL), n-butyllithium (1.6 mL, 2.48M in hexane, 4.0 mmol, 2.1 equiv.) was added. The reaction was stirred at room temperature for 4 hours. The reaction was concentrated under a stream of nitrogen and then under high vacuum. The residue was stirred in hexane and filtered over a plastic, fritted funnel. The filtrate was concentrated under a stream of nitrogen and then under high vacuum (0.799 g). A portion of this crude material (0.343 g, approximately 0.57 mmol) was dissolved in diethyl ether, and titanium(IV) chloride (1,2-dimethoxyethane adduct) was added. The reaction was stirred at room temperature overnight. The reaction was concentrated under a stream of nitrogen and then under high vacuum. The residue was extracted with dichloromethane. The dichloromethane extract was layered with pentane and cooled to −35° C. for 6 days. The cold supernatant was transferred to a separate vial. The supernatant was concentrated under a stream of nitrogen and then under high vacuum. The residue was dissolved in dichloromethane (1 mL) and pentane (1 mL) was added. The mixture was filtered over Celite and glass wool. The filtrate was concentrated under a stream of nitrogen and then under high vacuum. The residue was mixed with pentane (2 mL) and filtered over Celite and glass wool. The filtrate was cooled to −35° C. overnight. The supernatant was decanted away, and the resulting crystals were dried under high vacuum to afford the product as a dark red solid (0.014 g, 3% yield; approximately 8:2 ratio anti:syn isomers).

Procedures to obtain syn enriched sample of catalyst F: To a stirring solution of N-(1 -(1-adamantypethyl)-1-(443,5 -di-tert-butylphenyl)-2-methyl-1,5,6,7-tetrahydro-s-indacen-1-yl)-1,1-dimethylsilanamine (0.777 g, 1.31 mmol) in tetrahydrofuran (20 mL), 27 ethylmagnesium bromide (1.75 mL, 3.0M in diethyl ether, 5.25 mmol, 4.01 equiv.) was added. The reaction was stirred at room temperature overnight. Then, the reaction was heated to 50° C. and stirred for 4 hours. The reaction was then allowed to cool to room temperature and stirred for 3 days. The reaction, a light amber solution, was then cool to −35° C. To the cooled, stirring reaction, titanium (IV) chloride, 1,2-dimethoxyethane adduct (0.366 g, 1.31 mmol, 1 equiv.) was added, at which point the reaction darkened considerably. The reaction was stirred at room temperature for 4 hours. Then, additional methylmagnesium bromide (0.90 mL, 3.0M in diethyl ether, 2.7 mmol, 2.06 equiv.) was added, and the reaction was stirred for 20 hours. The reaction was then concentrated under a stream of nitrogen and then under high vacuum. The residue was extracted with pentane (2×20 mL) and filtered over Celite. The combined pentane extracts, an orange solution, were concentrated under a stream of nitrogen and then under high vacuum. The residue was dissolved in pentane (2 mL) and cooled to −35° C. The cold pentane supernatant was decanted into a separate vial and cooled again to −35° C. The resulting precipitate was isolated and washed quickly with additional pentane (2×2 mL). The remaining solids were concentrated under high vacuum to afford the product as a tan solid (0.060 g, 7% yield, 2:7 ratio of syn:anti isomers).

Catalyst Comp. CGC 1 (Me₂Si(η⁵-2,6,6-trimethyl-1,5,6,7-tetrahydro-indacene-1yl) (n¹-NtBu) titanium dimethyl represents current state of the art and was prepared in a similar fashion as described in WO2017/192226.

Catalyst Comp. CGC 2 is prepared to illustrate the importance of asymmetric substitution pertinent to the disclosed invention versus the asymmetric catalyst bearing adamantyl substituents C and F.

### Preparation of Comp. CGC 2 Catalyst

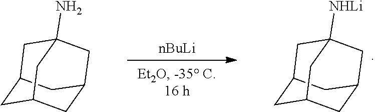

lithium ((3s,5s,7s)-adamantan-1-yl)amide. To a stirred slurry of adamantyl amine (1.5 g) in diethylether was slowly added nBuLi (8.5 mL of 2.5M solution). Almost instantly the reaction mixture became thick white with precipitate. It was allowed to stir for 30 minutes at room temperature. The mixture was then filtered and the solid was washed with 30 mL of hexane to give the final product in 80% yield. ¹H NMR (THF-d8): δ 1.95 (m, 3H) 1.57-1.48 (m, 12H) −1.58 (s, 1H).

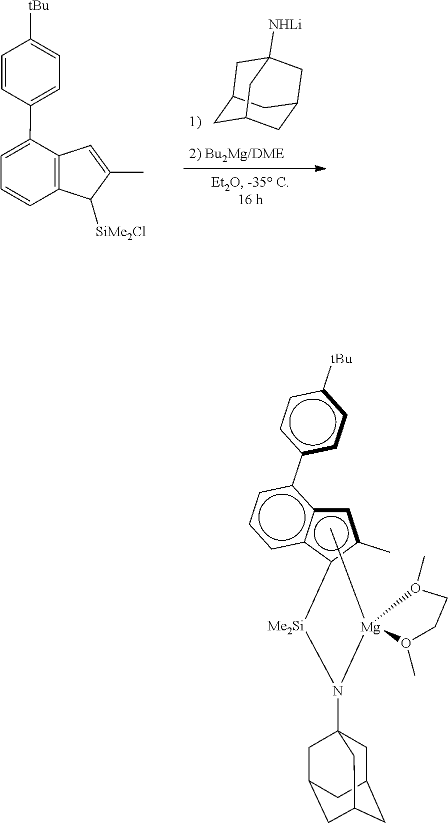

N-((3s,5s,7s)-adamantan-1-yl)-1-(4-(4-(tert-butyl)phenyl)-2-methyl-1H-inden-1-yl)-1,1-dimethylsilanamide magnesium (II). A THF slurry of 1-adamantyl amide (0.538 g in 10 mL of diethylether) was slowly added to an ether solution of silane (1.05 g) at −35° C. The reaction mixture was stirred for 16 hours overnight. After 16 hours, the mixture was concentrated and the solids were extracted with hexane (2×20 mL) and filtered over celite into another pre-weighed flask equipped with a stir bar. While stirring, dibutyl magnesium (3.13 mL of 1M solution) was added to the initially cloudy white solution. No color change is observed, and the reaction mixture was then taken to reflux temperature (70° C.). After ca 1 hour of heating the solution became bright yellow and was homogenous. The mixture was allowed to stir at 70° C. overnight. After 18 hours, the mixture was cooled back to room temperature and 2 equivalents (0.649 mL) of dimethoxyethane were added. This almost instantly precipitated the yellow solid. After brief stirring at room temperature the solid deposited on the bottom of the flask as a yellow semi solid. The hexane solution was then filtered and the yellow solid was dried in vacuo. This gave desired magnesocene in excellent yield in purity as a DME adduct (1 equivalent). ¹H NMR (THF-d8): δ 7.77 (m, 1H), 7.66 (m, 2H,), 7.42 (m, 2H), 6.73 (m, 2H), 6.44 (s, 1H) 2.56 (s, 3H) 2.10 (bs, 2H), 1.75-1.66 (m, 12H), 1.40 (s, 9H), 0.48 (s, 3H), 0.46 (s, 3H).

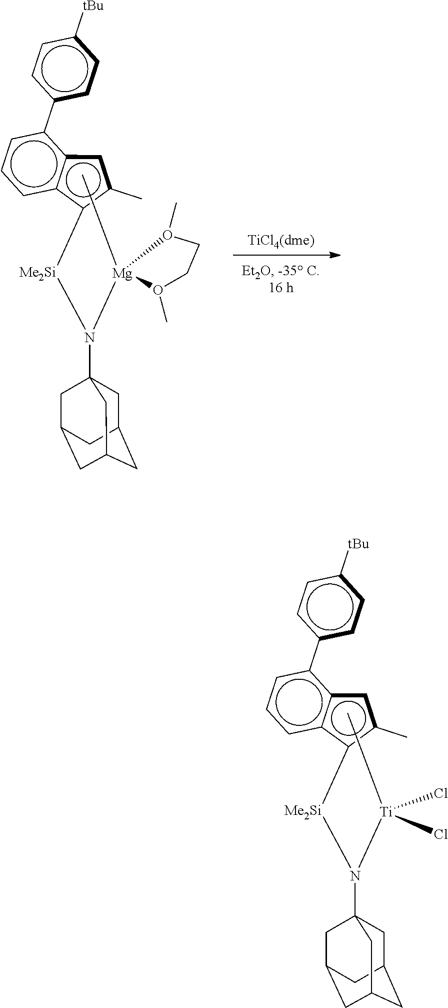

N-((3s,5s,7s)-adamantan-1-yl)-1-(4-(4-(tert-butyl)phenyl)-2-methyl-1H-inden-l-yl)-1,1-dimethylsilanamide titanium dichloride. A cold ether slurry of magnesocene (0.766 g in ca 20 mL) was dropwise added to a slurry of TiCl₄(dme) in diethylether (0.368 g). The reaction mixture gradually darkened. Upon warming up to room temperature, the reaction mixture became dark red with white precipitate. It was allowed to stir overnight at room temperature. After 18 hours, solvent was removed in vacuo to give a maroon residue. The residue was extracted with methylene chloride (2×20 mL), filtered over celite and concentrated. Hexane (ca 20 mL) was then added to give a cloudy red solution. The solid was filtered and briefly washed with minimal hexane. This yielded a first crop of material. The residual hexane layer was concentrated to ca 10 mL and placed in a freezer over the long weekend. Large red crystals formed. The solution was decanted and the solid was dried in vacuo to give a second crop of material in 36% yield. ¹H NMR (400 MHz, CD₂Cl₂) δ 7.78 (m, 1H), 7.57 (s, 4H), 7.43-7.26 (m, 2H), 7.27 (m, 1H), 2.41 (s, 3H), 2.12 (s, 4H), 2.05-1.90 (m, 6H), 1.68 (m, 6H), 1.42 (s, 9H), 1.01 (s, 3H), 0.86 (s, 3H).

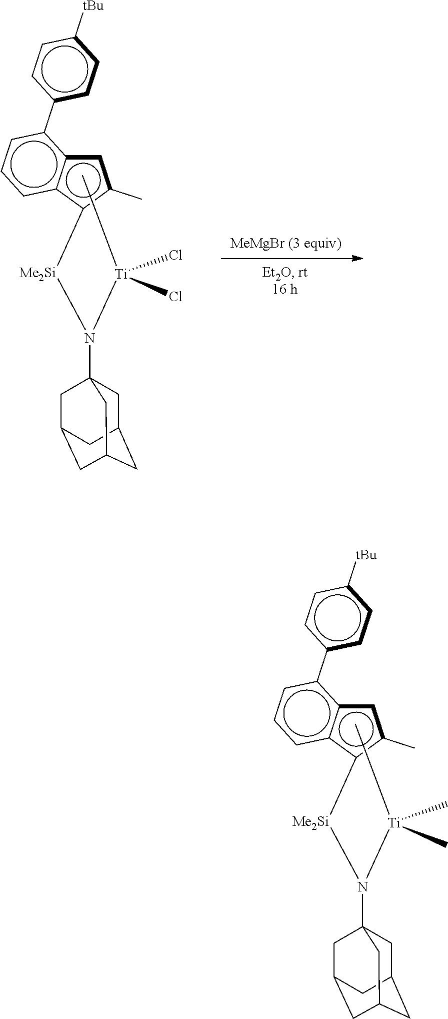

Catalyst Comp. CGC 2: N-((3s,5s,7s)-adamantan-1-yl)-1-(4-(4-(tert-butyl)phenyl)-2-methyl-1H-inden-1-yl)-1,1-dimethylsilanamide titanium dimethyl. MeMgBr (0.353 mL of 3M solution) was added to an ether solution of titanium dichloride (0.207 g) at room temperature. The mixture was stirred overnight. After 18 hours, solvent was removed in vacuo, and the residue was extracted with hexane (2×5 mL) and filtered to give a dark brown solution. The solution was concentrated to give a desired product as yellow foam in 87% yield. ¹H NMR (C₆D₆) δ 7.85-7.71 (m, 2H), 7.68-7.54 (m, 1H), 7.51-7.38 (m, 2H), 7.38-7.25 (m, 2H), 7.04 (m, 1H), 2.14 (m, 6H), 2.02 (bs, 6H), 1.74-1.48 (m, 6H), 1.28 (s, 9H), 0.95 (s, 3H), 0.67 (s, 3H), 0.54 (s, 3H), 0.12 (s, 3H).

Catalyst Comp. CGC 3 is prepared to illustrate the importance of unsaturated ring when R¹ and R² are fused. This catalyst is a direct comparative to catalyst B. The indenyl triflate precursor can be prepared in a similar fashion as it is prepared for the tetrahydroindacene analog described for catalyst F.

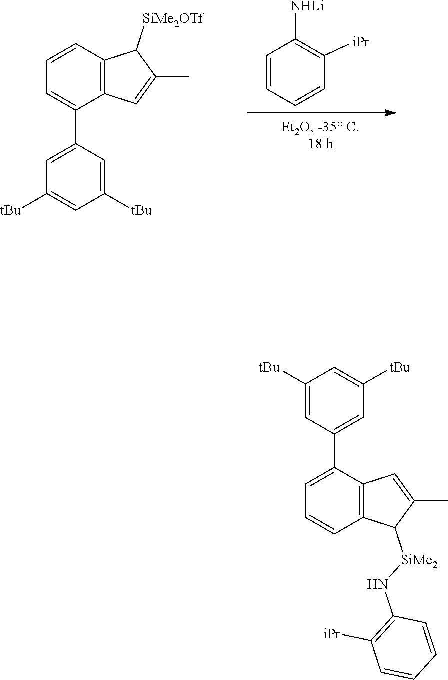

1-(4-(3,5-di-tert-butylphenyl)-2-methyl-1H-inden-1-yl)-N-(2-isopropylphenyl)-1,1-dimethylsilanamine. 2-isopropylaniline (0.279 g) was dissolved in diethyl ether in a small vial equipped with a stir bar and cooled to −35° C. nBuLi (1.03 equiv.) was then slowly added to this mixture, which resulted in vigorous bubbling. The reaction was stirred at room temperature for 1 hour. In a separate vial, indenyl triflate was dissolved in 8 mL of diethyl ether and cooled in the freezer. While cold, the solution of indenyl triflate was transferred to the stirring solution of lithiated aniline. The initially pale orange solution became dark brown over the course of 18 hours. After 18 hours, solvent removal afforded foamy solids. The solids were extracted with pentane, filtered through celite and concentrated in vacuo to afford an off-white foam in 85% yield. ¹H NMR (400 MHz, CDCl₃) δ 7.73 (d, 2H), 7.67 (t, 1H), 7.60-7.55 (m, 1H), 7.46 (m, 1H), 7.27 (m, 1H), 7.19 (m, 2H), 7.09 (m, 1H), 7.00-6.91 (m, 2H), 3.61 (s, 1H), 3.40 (s, 1H), 2.72-2.56 (m, 1H), 2.10 (s, 3H), 1.44 (s, 18H), 1.17 (d, 3H), 1.11 (d, 3H), 0.30 (s, 3H) 0.26 (s, 3H).

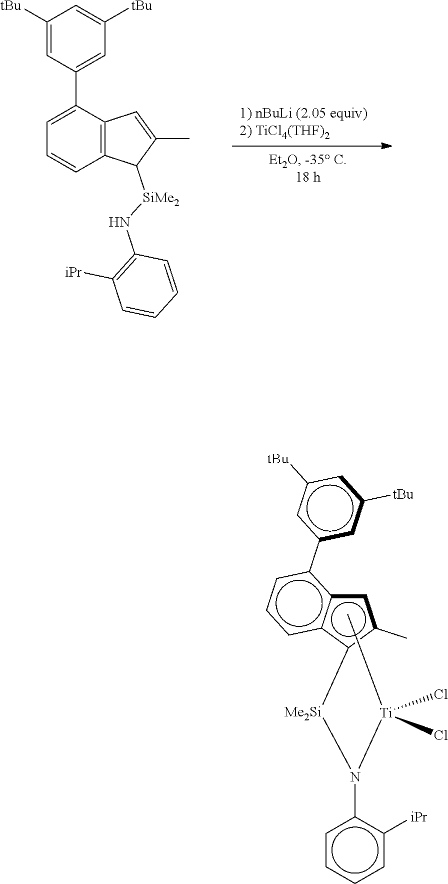

1-(4-(3,5-di-tert-butylphenyl)-2-methyl-1H-inden-1-yl)-N-(2-isopropylphenyl)-1,1-dimethylsilanamide titanium dichloride. An ether solution of crude ligand (0.873 g) prepared in the previous step was cooled to −35° C. in the glove box freezer. While stirring, a solution of nBuLi (2.05 equiv.) was added slowly. The reaction mixture was stirred for 2 hours. Solvent was removed in vacuo to give an orange solid. The solid was washed with minimal pentane and dried in vacuo. The orange solid was then suspended in diethyl ether and cooled to −35° C. for 1 hour. To this stirring mixture, TiCl₄(THF)₂ (0.572 g) was added as a solid in portions. The mixture almost instantly became dark red. Upon warming to room temperature, the reaction mixture remained dark red/brown with white precipitate. The mixture was stirred overnight. After 18 hours, solvent was removed in vacuo to give brown solids. The solids were extracted with methylene chloride (20 mL) and filtered over celite. The resulting bright maroon/brown mixture was then concentrated in vacuo to brown solids. The solids were suspended in pentane and stored in the freezer. After 3 days, the formed red solids were filtered and washed with pentane (2×3 mL). The isolated maroon solid was isolated in 14.9% yield. ¹H NMR (400 MHz, CD₂Cl₂) δ 7.93 (d, 1H), 7.54-7.47 (m, 5H), 7.24 (m, 2H), 7.12 (m, 2H), 6.69 (m, 1H) 2.91 (m, 1H), 2.64 (s, 3H), 1.41 (s, 18H), 1.26 (d, 3H), 1.13 (d, 3H), 0.90 (s, 3H) 0.79 (s, 3H).

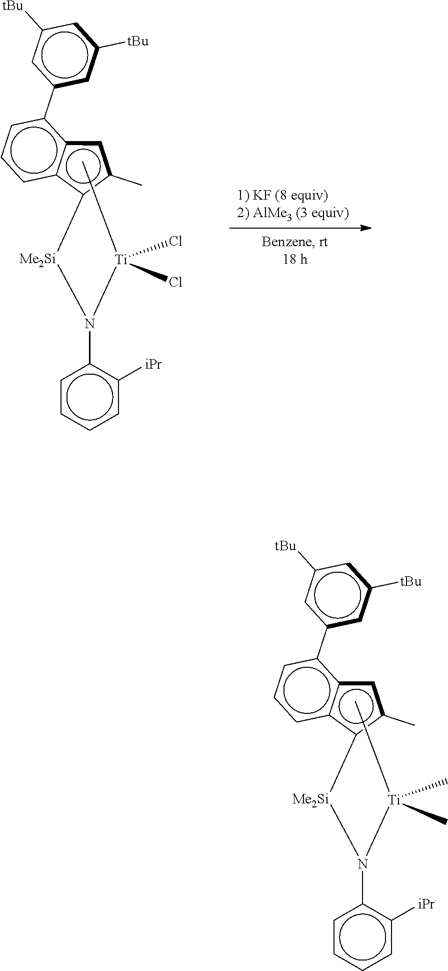

Catalyst Comp CGC 3: 1-(4-(3,5-di-tert-butylphenyl)-2-methyl-1H-inden-1-yl)-N-(2-isopropylphenyl)-1,1-dimethylsilanamide titanium dimethyl Neat AlMe₃ (0.124 mL) was added to a stirred mixture of KF (0.200 g) and titanium complex (0.270 g). The initially maroon solution quickly became dark brown. It was allowed to stir for 18 hours at room temperature. After 18 hours, solvent was removed in vacuo, and the residue was extracted with pentane (2×5 mL), filtered over celite and concentrated to give a brown foamy solid. The compound is very pure by ¹H NMR. ¹H NMR (400 MHz, C₆D₆) δ 7.73 (2, 2H), 7.68-7.63 (m, 2H), 7.29 (m, 3H), 7.07 (m, 3H), 6.84 (m, 1H) 3.41 (m, 1H), 2.13 (s, 3H), 1.37 (s, 18H), 1.31 (d, 3H), 1.21 (d, 3H), 1.07 (s, 3H) 0.55 (s, 3H) 0.42 (s, 3H) 0.25 (s. 3H).

By using a combination of synthetic routes described above, 6 novel diastereomeric catalyst pairs can be prepared. In all cases, the crude mixtures exclusively contain 1:1 mixtures of syn and anti diastereomers. The values could be enriched toward either diastereomer by fractional crystallization from cold pentane or hexane.

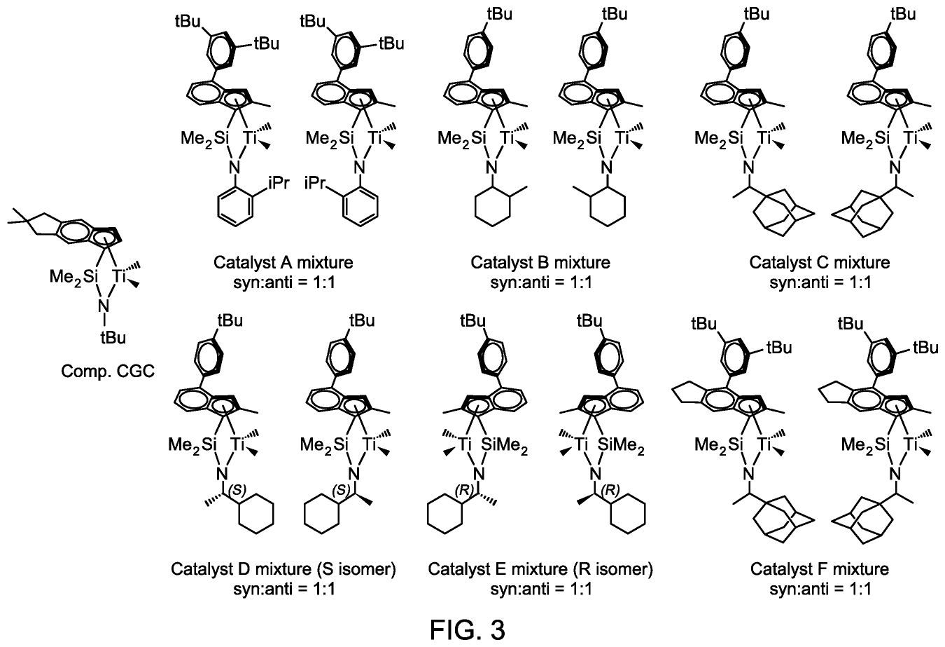

FIG. 3 illustrates diastereomeric catalyst pairs alongside comparative catalyst (Comp. CGC 1 and Comp. CGC 2) used in the polymerization analysis described herein.

Catalyst B: 1 -(4-(4-(tert-butyl)phenyl)-2-methyl-1H-inden-1-yl)-1,1-dimethyl-N-(2-methylcyclohexyl)silanamide titanium dimethyl. R¹ fused with R² to form asymmetric cyclohexyl ring with Me group in the 2-position; R¹³, R¹⁴, R³=Me, R⁴,R⁵,R⁶,R⁷,R⁸, R⁹, R¹¹, R¹²=H; R¹⁰=tBu; M=Ti; Alkyl=Me; Z=CH (racemic).

Catalyst C: N-(1-((3r,5r,7r)-adamantan-1-yl)ethyl)-1-(4-(4-(tert-butyl)phenyl)-2-methyl-1H-inden-1-yl)-1,1-dimethylsilanamde titanium dimethyl. R¹=Me; R²=1-Adamantyl; R¹³, R¹⁴, R³=Me; R⁴,R⁵,R⁶,R⁷,R⁸, R⁹, R¹¹, R¹²=H; R¹⁰=tBu; M=Ti; alkyl=Me; Z=CH (racemic).

Catalyst D: 1-(4-(4-(tert-butyl)phenyl)-2-methyl-1H-inden-1-yl)-N-(1-cyclohexylethyl)-1,1-dimethylsilanamide titanium dimethyl. R¹=Me; R²=Cyclohexyl; R¹³, R¹⁴, R³=Me; R⁴,R⁵,R⁶,R⁷,R⁸, R⁹, R¹¹, R¹²=H; R¹⁰ =tBu; M=Ti; alkyl=Me; Z=CH (with S stereochemical configuration).

Catalyst E: 1-(4-(4-(tert-butyl)phenyl)-2-methyl-1H-inden-1-yl)-N-(1-cyclohexylethyl)-1,1-dimethylsilanamine titanium dimethyl R¹=1-adamantyl; R²=Me; R¹³, R¹⁴, R³=Me; R⁴,R⁵,R⁶,R⁷,R⁸, R⁹, R¹¹, R¹²=H; R¹⁰, =tBu; M=Ti; alkyl=Me; Z=CH (with R stereochemical configuration).

Catalyst F: Dimethylsilyl (1-(1 -adamantyl)-ethylamido) (2-methyl-4-(3,5-di-tert-butylphenyl)-1,5,6,7-tetrahydro-s-indacenyl) titanium dimethyl R¹=1-adamantyl; R²=Me; R¹³, R¹⁴, R³=Me; R⁵,R⁶=fused to make cyclopentyl ring; R⁴,R⁷,R⁸, R¹², R¹⁰=H; R¹¹, R⁹=tBu; M=Ti; alkyl=Me. Z=CH (racemic).

Comp CGC 1: (Me₂Si(η⁵-2,6,6-trimethyl-1,5,6,7-tetrahydro-indacene-1yl) (n¹-NtBu) titanium dimethyl.

Comp CGC 2: N-((3s,5s,7s)-adamantan-1-yl)-1-(4-(4-(tert-butyl)phenyl)-2-methyl-1H-inden-1-yl)-1,1-dimethylsilanamide titanium dimethyl.

Comp CGC 3: 1-(4-(3,5-di-tert-butylphenyl)-2-methyl-1H-inden-1-yl)-N-(2-isopropylphenyl)-1,1-dimethylsilanamide titanium dimethyl.

The comparative CGC 1 is example referenced in FIG. 3 and in the experimental section below is (Me₂Si(η⁵-2,6,6-trimethyl-1,5,6,7-tetrahydro-indacene-1yl) (n¹-NtBu) titanium dimethyl catalyst, since it has excellent activity and molecular weight capability for both PP and EP. Comp GCC 2 catalyst referenced in examples below demonstrates the importance of inventive ligand substitution pattern on catalyst activity, especially at higher polymerization temperatures. Comp CGC 3 catalyst is a direct comparison to catalyst B referenced in examples below and demonstrates the importance of unsaturated, non-aromatic cyclic structure when R¹ and R² form a fused rung.

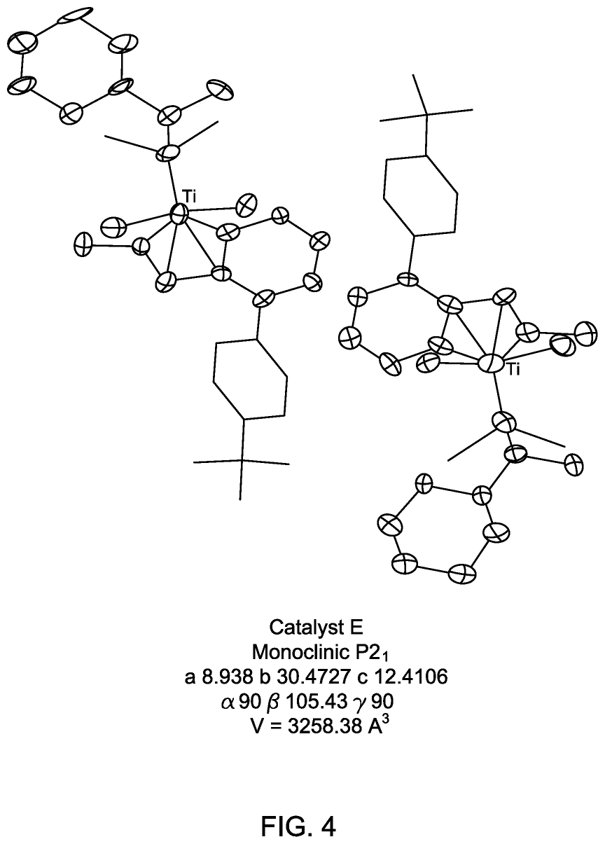

FIG. 4 is an X-ray crystal structure of diastereomeric pair of Catalyst E (dichloride). The absolute configuration at the unsymmetrical carbon atom is R in both syn and anti-conformers. Ellipsoids are at 50% probability level. The aryl group is shown in wireframe for clarity, with the hydrogens omitted for clarity. The X-ray structure of catalyst E confirmed the absolute stereochemistry at the carbon atom (Z) consistent with the starting material that was used in catalyst preparation. Interestingly enough, this catalyst co-crystallizes with its sibling diastereomer in 1:1 ratio per asymmetric unit. The origin is likely due to the weak stabilizing interactions via apparent π-stacking from indenyl rings.

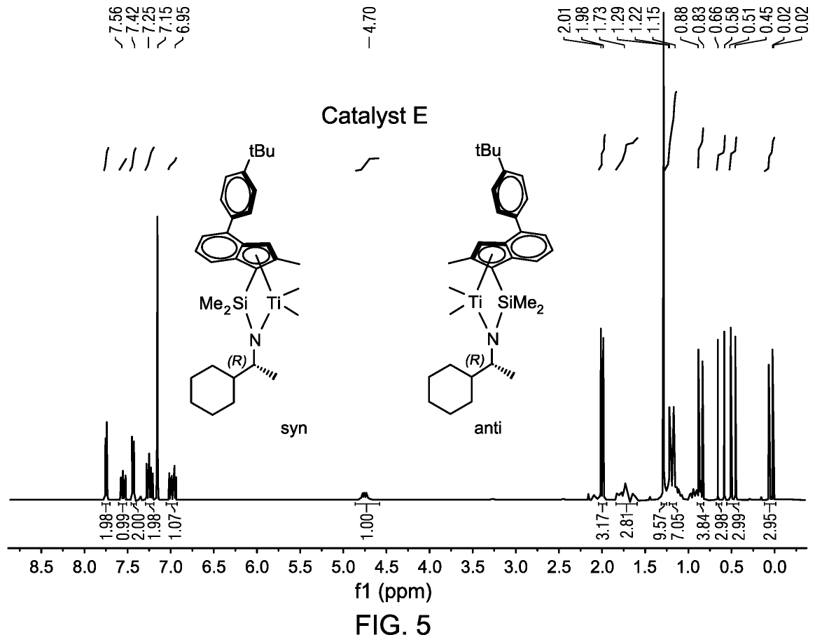

FIG. 5 is an ¹H NMR spectrum (C₆D₆) demonstrating two diastereomers of Catalyst E. ¹H NMR spectrum of catalyst E confirms the presence of two diastereomers in 1:1 ratio. Diagnostic 2-Me indenyl peak at around 2.0 ppm appears split due to the presence of two diastereomeric species.

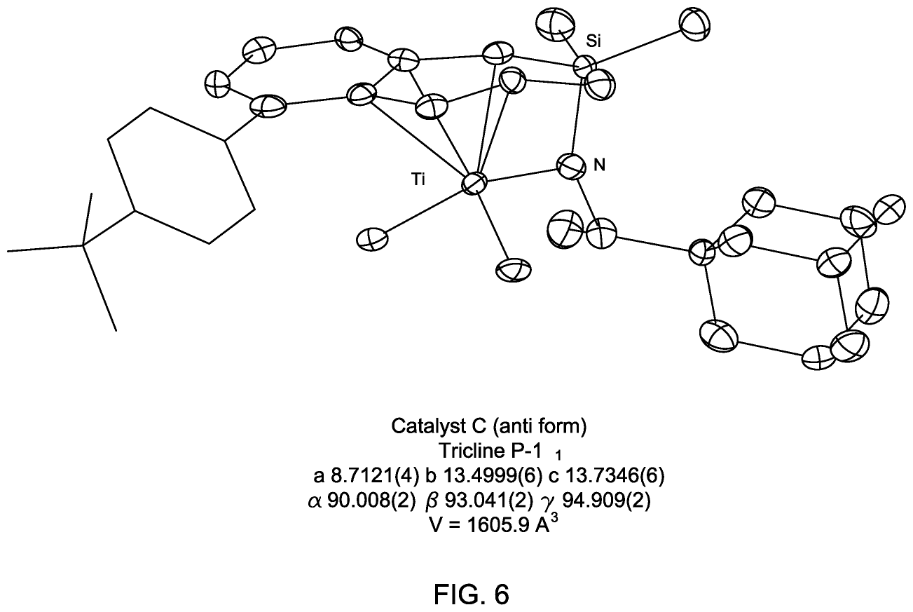

FIG. 6 is an X-ray crystal structure of diastereomeric pure Catalyst C (anti form). Ellipsoids are at 50% probability level. The aryl group is shown in wireframe for clarity, with the hydrogens omitted for clarity. Similar to catalyst E, the X-ray quality crystals of catalyst C can be obtained by slow evaporation of pentane solution of catalyst C at −35° C. In this case however, diastereomerically enriched species (anti configuration) was obtained. For catalyst E, it appears that the anti form crystallizes faster than syn form. This is all the function of ligand substituents. For catalyst E, the solution spectrum of the mixture prior to crystallization indeed shows both syn and anti forms in 1:1 ratio.

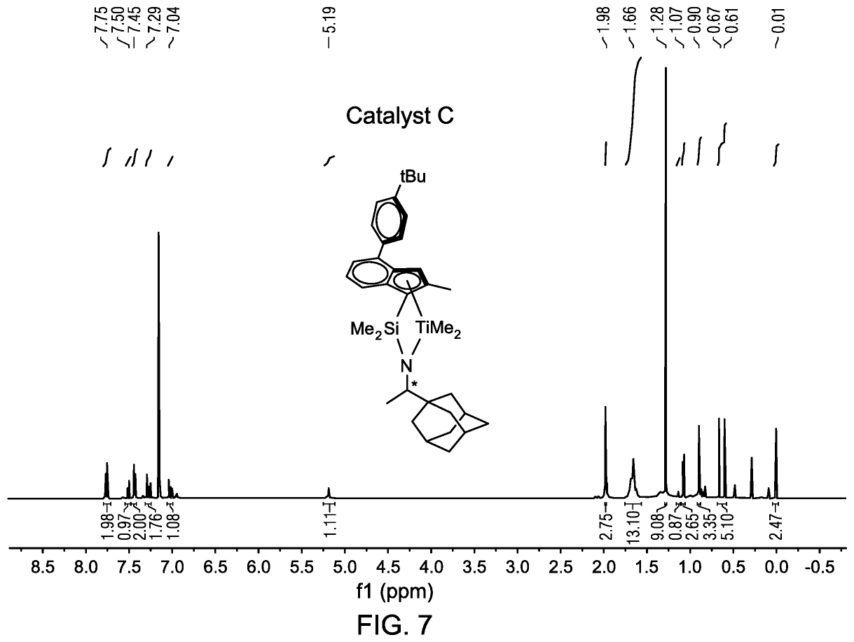

FIG. 7 is an ¹H NMR spectrum (C₆D₆) demonstrating two diastereomers of Catalyst C. In addition to X-ray structure, the presence of single species diastereomer is confirmed by ¹H NMR spectroscopy. Diagnostic 2-Me indenyl resonance at around 2.0 ppm shows predominantly single peak with circa 15-20% of other diastereomer contributing to the overall sample.

### Activators

The catalyst systems described herein may comprise a catalyst compounds as described above and an activator such as alumoxane or a non-coordinating anion and may be formed by combining the catalyst components described herein with activators in any suitable manner, including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, σ-bound, metal ligand making the metal compound cationic and providing a charge-balancing non-coordinating or weakly coordinating anion, e.g., a non-coordinating anion. Those of the ordinary skill in the art could use conventional activators with the catalyst compounds embodying the present technological advancement. The list of preferred activators includes: N,N-dimethylanilinium tetrakis(pentafluorophenyl)borate, dioctadecylmethylammonium tetrakis(pentafluorophenyl)borate, dioctadecylmethylammonium tetrakis(perfluoronaphthyl)borate, triphenylcarbenium tetrakis(pentafluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(t-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium) tetrakis(perfluoronaphthyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium) tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(t-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium) tetrakis(perfluorobiphenyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium) tetrakis(perfluorobiphenyl)borate, [4-t-butyl-PhNMe₂H][(C₆F₃(C₆F₅)₂)₄B], trimethylammonium tetraphenylborate, triethylammonium tetraphenylborate, tripropylammonium tetraphenylborate, tri(n-butyl)ammonium tetraphenylborate, tri(t-butyl)ammonium tetraphenylborate, N,N-dimethylanilinium tetraphenylborate, N,N-diethylanilinium tetraphenylborate, N,N-dimethyl-(2,4,6-trimethylanilinium) tetraphenylborate, tropillium tetraphenylborate, triphenylcarbenium tetraphenylborate, triphenylphosphonium tetraphenylborate, triethylsilylium tetraphenylborate, benzene(diazonium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium) tetrakis(pentafluorophenyl)borate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium) tetrakis(pentafluorophenyl)borate, trimethylammonium tetrakis-(2,3,4,6-tetrafluorophenyl) borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluoro-phenyl)borate, dimethyl(t-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium) tetrakis-(2,3,4,6-tetrafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium) tetrakis-(2,3,4,6-tetrafluorophenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(t-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5 -bis(trifluoromethyl)phenyl)borate, N,N-dimethyl-(2,4,6-trimethylanilinium)tetrakis(3,5-bis(trifluoromethyl)phenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, benzene(diazonium) tetrakis(3,5-bis(trifluoromethyl)phenyl)borate, di-(i-propyl)ammonium tetrakis(pentafluorophenyl)borate, dicyclohexylammonium tetrakis(pentafluorophenyl)borate, tri(o-tolyl)phosphonium tetrakis(pentafluorophenyl)borate, tri(2,6-dimethylphenyl)phosphonium tetrakis(pentafluorophenyl)borate, triphenylcarbenium tetrakis(perfluorophenyl)borate, 1-(4-(tris(pentafluorophenyl)borate)-2,3,5,6-tetrafluorophenyl)pyrrolidinium, tetrakis(pentafluorophenyl)borate, 4-(tris(pentafluorophenyl)borate)-2,3,5,6-tetrafluoropyridine, N-methyl-4-nonadecyl-N-octadecylbenzenaminium tetrakis(pentafluorophenyl)borate, N-methyl-4-nonadecyl-N-octadecylbenzenaminium tetrakis(perfluoronaphthalenyl)borate, triphenylcarbenium tetrakis(3,5-bis(trifluoromethyl)phenyl)borate), or a combination thereof.

### Optional Support Materials

In embodiments herein, the catalyst system may include an inert support material. The supported material can be a porous support material, for example, talc, and inorganic oxides. Other support materials include zeolites, clays, organoclays, or another organic or inorganic support material, or mixtures thereof.

The support material can be an inorganic oxide in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂, Al₂O₃, SiO₂/TiO₂, silica clay, silicon oxide/clay, or mixtures thereof. Those of the ordinary skill in the art could use conventional support materials with the catalyst compounds embodying the present technological advancement.

### Polymerization Processes

In some embodiments herein, the present disclosure relates to polymerization processes where a monomer (such as propylene), and, optionally, a comonomer (such as ethylene or 1-octene), are introduced to (or contacted with) a catalyst system including an activator and at least one catalyst compound. The catalyst compound and activator may be combined prior to contacting with the monomer. Alternatively the catalyst compound and activator may be introduced into the polymerization reactor separately, wherein they subsequently react to form the active catalyst. Those of the ordinary skill in the art could use conventional polymerization techniques with the catalyst compounds embodying the present technological advancement.

### EXAMPLES

Unless specified otherwise, all reagents were obtained from Aldrich Chemical Company. All catalyst and activator manipulations were carried out under N₂ atmosphere. Solvents and monomers were dried and degassed prior to use.

Regarding the experimental complexes discussed below, the prepared complexes were tested for propylene polymerization and ethylene-propylene copolymerization at 70 and 100° C. The following activators were used: [B(C₆F₅)₄][DMAH], [B(C₉F₇)₄][DMAH]—and [B(C₆F₅)₄][CPh₃].

TABLE 1
Propylene Polymerization with Different Activators at 70° C.
Propylene polymerization at 70° C.

| | | | | | | | Activity |
|---|---|---|---|---|---|---|---|
| | | syn:anti | | Tₚ | Quench | Yield | (kg/ |
| Run # | Catalyst | ratio | Activator | (deg C.) | time (s) | (mg) | mmol · h) |
| 1 | Comp. CGC 1 | — | [B(C₉F₇)₄][DMAH] | 70 | 72 | 145.9 | 208.4 |
| 2 | Comp. CGC 1 | — | [B(C₉F₇)₄][DMAH] | 70 | 65 | 141.0 | 223.1 |
| 3 | Comp. CGC 1 | — | [B(C₆F₅)₄][DMAH] | 70 | 63 | 120.3 | 196.4 |
| 4 | Comp. CGC 1 | — | [B(C₆F₅)₄][DMAH] | 70 | 54 | 118.8 | 226.3 |
| 5 | Comp. CGC 1 | — | [B(C₆F₅)₄][CPh₃] | 70 | 1801 | 66.8 | 3.8 |
| 6 | Comp. CGC 1 | — | [B(C₆F₅)₄][CPh₃] | 70 | 1740 | 64.5 | 3.8 |
| 7 | Comp CGC 3 | — | [B(C₉F₇)₄][DMAH] | 70 | 1800 | 6.3 | 0.4 |
| 8 | Comp CGC 3 | — | [B(C₉F₇)₄][DMAH] | 70 | 1800 | 6.1 | 0.4 |
| 9 | Comp CGC 3 | — | [B(C₉F₇)₄][DMAH] | 70 | 1800 | 5.1 | 0.3 |
| 10 | Catalyst B | 1:1 | [B(C₉F₇)₄][DMAH] | 70 | 259 | 165.5 | 65.7 |
| 11 | Catalyst B | 1:1 | [B(C₉F₇)₄][DMAH] | 70 | 210 | 155.5 | 76.2 |
| 12 | Catalyst B | 1:1 | [B(C₆F₅)₄][DMAH] | 70 | 162 | 148.2 | 94.1 |
| 13 | Catalyst B | 1:1 | [B(C₆F₅)₄][DMAH] | 70 | 124 | 109.7 | 91.0 |
| 14 | Catalyst B | 1:1 | [B(C₆F₅)₄][CPh₃] | 70 | 848 | 83.5 | 10.1 |
| 15 | Catalyst B | 1:1 | [B(C₆F₅)₄][CPh₃] | 70 | 703 | 71.8 | 10.5 |
| 16 | Catalyst C | 7:3 | [B(C₉F₇)₄][DMAH] | 70 | 65 | 198.5 | 314.1 |
| 17 | Catalyst C | 7:3 | [B(C₉F₇)₄][DMAH] | 70 | 123 | 231.4 | 193.5 |
| 18 | Catalyst C | 7:3 | [B(C₆F₅)₄][DMAH] | 70 | 81 | 269.0 | 341.6 |
| 19 | Catalyst C | 7:3 | [B(C₆F₅)₄][DMAH] | 70 | 90 | 294.3 | 336.3 |
| 20 | Catalyst C | 7:3 | [B(C₆F₅)₄][CPh₃] | 70 | 176 | 175.8 | 102.7 |
| 21 | Catalyst C | 7:3 | [B(C₆F₅)₄][CPh₃] | 70 | 188 | 176.6 | 96.6 |
| 22 | Catalyst C | 4:6 | [B(C₉F₇)₄][DMAH] | 70 | 240 | 88.3 | 37.8 |
| 23 | Catalyst C | 4:6 | [B(C₉F₇)₄][DMAH] | 70 | 320 | 124.2 | 39.9 |
| 24 | Catalyst C | 4:6 | [B(C₆F₅)₄][DMAH] | 70 | 236 | 92.0 | 40.1 |
| 25 | Catalyst C | 4:6 | [B(C₆F₅)₄][DMAH] | 70 | 186 | 132.4 | 73.2 |
| 26 | Catalyst C | 4:6 | [B(C₆F₅)₄][CPh₃] | 70 | 265 | 130.5 | 50.7 |
| 27 | Catalyst C | 4:6 | [B(C₆F₅)₄][CPh₃] | 70 | 300 | 131.0 | 44.9 |
| 28 | Catalyst D | 1:1 | [B(C₉F₇)₄][DMAH] | 70 | 98 | 183.8 | 192.9 |
| 29 | Catalyst D | 1:1 | [B(C₉F₇)₄][DMAH] | 70 | 82 | 155.2 | 194.7 |
| 30 | Catalyst D | 1:1 | [B(C₆F₅)₄][DMAH] | 70 | 102 | 192.2 | 193.8 |
| 31 | Catalyst D | 1:1 | [B(C₆F₅)₄][DMAH] | 70 | 117 | 214.8 | 188.8 |
| 32 | Catalyst D | 1:1 | [B(C₆F₅)₄][CPh₃] | 70 | 275 | 119.8 | 44.8 |
| 33 | Catalyst D | 1:1 | [B(C₆F₅)₄][CPh₃] | 70 | 256 | 94.7 | 38.0 |
| 34 | Catalyst E | 1:1 | [B(C₉F₇)₄][DMAH] | 70 | 72 | 154.8 | 221.1 |
| 35 | Catalyst E | 1:1 | [B(C₉F₇)₄][DMAH] | 70 | 113 | 184.7 | 168.1 |
| 36 | Catalyst E | 1:1 | [B(C₆F₅)₄][DMAH] | 70 | 99 | 190.9 | 198.3 |
| 37 | Catalyst E | 1:1 | [B(C₆F₅)₄][DMAH] | 70 | 95 | 213.9 | 231.6 |
| 38 | Catalyst E | 1:1 | [B(C₆F₅)₄][CPh₃] | 70 | 272 | 133.5 | 50.5 |
| 39 | Catalyst E | 1:1 | [B(C₆F₅)₄][CPh₃] | 70 | 268 | 123.8 | 47.5 |
| 40 | Catalyst F | 8:2 | [B(C₉F₇)₄][DMAH] | 70 | 92 | 252.2 | 282.0 |
| 41 | Catalyst F | 8:2 | [B(C₉F₇)₄][DMAH] | 70 | 120 | 257.5 | 220.7 |
| 42 | Catalyst F | 8:2 | [B(C₆F₅)₄][DMAH] | 70 | 74 | 251.0 | 348.9 |
| 43 | Catalyst F | 8:2 | [B(C₆F₅)₄][DMAH] | 70 | 71 | 263.4 | 381.6 |
| 44 | Catalyst F | 8:2 | [B(C₆F₅)₄][CPh₃] | 70 | 201 | 215.7 | 110.4 |
| 45 | Catalyst F | 8:2 | [B(C₆F₅)₄][CPh₃] | 70 | 160 | 161.9 | 104.1 |
| 46 | Catalyst F | 2:7 | [B(C₉F₇)₄][DMAH] | 70 | 114 | 90.8 | 81.9 |
| 47 | Catalyst F | 2:7 | [B(C₉F₇)₄][DMAH] | 70 | 261 | 184.1 | 72.6 |
| 48 | Catalyst F | 2:7 | [B(C₆F₅)₄][DMAH] | 70 | 121 | 126.5 | 107.5 |
| 49 | Catalyst F | 2:7 | [B(C₆F₅)₄][DMAH] | 70 | 136 | 181.7 | 137.4 |
| 50 | Catalyst F | 2:7 | [B(C₆F₅)₄][CPh₃] | 70 | 245 | 136.6 | 57.3 |
| 51 | Catalyst F | 2:7 | [B(C₆F₅)₄][CPh₃] | 70 | 260 | 110.3 | 43.6 |

TABLE 2
Propylene Polymerization at 100° C.
Propylene polymerization at 100° C.

| | | | | | Quench | | Activity |
|---|---|---|---|---|---|---|---|
| | | syn:anti | | Tₚ | time | Yield | (kg/ |
| Run # | Catalyst | ratio | Activator | (deg C.) | (s) | (mg) | mmol · h) |
| 52 | Comp. CGC | — | [B(C₆F₅)₄][DMAH] | 100 | 109 | 80.3 | 75.8 |
| 53 | Comp. CGC | — | [B(C₆F₅)₄][DMAH] | 100 | 108 | 82 | 78.1 |
| 54 | Catalyst B | 1:1 | [B(C₆F₅)₄][DMAH] | 100 | 136 | 108 | 81.7 |
| 55 | Catalyst B | 1:1 | [B(C₆F₅)₄][DMAH] | 100 | 139 | 110.9 | 82.1 |
| 56 | Catalyst D | 1:1 | [B(C₆F₅)₄][DMAH] | 100 | 102 | 113.7 | 114.7 |
| 57 | Catalyst D | 1:1 | [B(C₆F₅)₄][DMAH] | 100 | 90 | 96.8 | 110.6 |
| 58 | Catalyst F | 1:1 | [B(C₆F₅)₄][DMAH] | 100 | 43 | 123 | 294.2 |
| 59 | Catalyst F | 1:1 | [B(C₆F₅)₄][DMAH] | 100 | 51 | 141.9 | 286.2 |

TABLE 3
GPC Data for Propylene Homopolymers Prepared at 70° C.
Propylene polymerization at 70° C.

| | | syn:anti | | Tₚ | Mₙ | M_{w} | |
|---|---|---|---|---|---|---|---|
| Run # | Catalyst | ratio | Activator | (deg C.) | (g/mol) | (g/mol) | PDI |
| 1 | Comp. CGC 1 | — | [B(C₉F₇)₄][DMAH] | 70 | 335,171 | 565,744 | 1.7 |
| 2 | Comp. CGC 1 | — | [B(C₉F₇)₄][DMAH] | 70 | 256,317 | 465,852 | 1.8 |
| 3 | Comp. CGC 1 | — | [B(C₆F₅)₄][DMAH] | 70 | 111,150 | 194,539 | 1.8 |
| 4 | Comp. CGC 1 | — | [B(C₆F₅)₄][DMAH] | 70 | 106,534 | 182,385 | 1.7 |
| 5 | Comp. CGC 1 | — | [B(C₆F₅)₄][CPh₃] | 70 | 154,570 | 263,147 | 1.7 |
| 6 | Comp. CGC 1 | — | [B(C₆F₅)₄][CPh₃] | 70 | 182,952 | 308,418 | 1.7 |
| 7 | Comp. CGC 3 | — | [B(C₉F₇)₄][DMAH] | 70 | — | — | — |
| 8 | Comp. CGC 3 | — | [B(C₉F₇)₄][DMAH] | 70 | — | — | — |
| 9 | Comp. CGC 3 | — | [B(C₉F₇)₄][DMAH] | 70 | — | — | — |
| 10 | Catalyst B | 1:1 | [B(C₉F₇)₄][DMAH] | 70 | 741,751 | 1,369,766 | 1.8 |
| 11 | Catalyst B | 1:1 | [B(C₉F₇)₄][DMAH] | 70 | 788,139 | 1,474,000 | 1.9 |
| 12 | Catalyst B | 1:1 | [B(C₆F₅)₄][DMAH] | 70 | 553,417 | 1,098,691 | 2.0 |
| 13 | Catalyst B | 1:1 | [B(C₆F₅)₄][DMAH] | 70 | 547,843 | 1,017,657 | 1.9 |
| 14 | Catalyst B | 1:1 | [B(C₆F₅)₄][CPh₃] | 70 | 19,058 | 53,312 | 2.8 |
| 15 | Catalyst B | 1:1 | [B(C₆F₅)₄][CPh₃] | 70 | 65,220 | 191,801 | 2.9 |
| 16 | Catalyst C | 7:3 | [B(C₉F₇)₄][DMAH] | 70 | 21,567 | 96,325 | 4.5 |
| 17 | Catalyst C | 7:3 | [B(C₉F₇)₄][DMAH] | 70 | 297,374 | 721,738 | 2.4 |
| 18 | Catalyst C | 7:3 | [B(C₆F₅)₄][DMAH] | 70 | 217,876 | 581,318 | 2.7 |
| 19 | Catalyst C | 7:3 | [B(C₆F₅)₄][DMAH] | 70 | 182,842 | 480,903 | 2.6 |
| 20 | Catalyst C | 7:3 | [B(C₆F₅)₄][CPh₃] | 70 | 119,721 | 226,373 | 1.9 |
| 21 | Catalyst C | 7:3 | [B(C₆F₅)₄][CPh₃] | 70 | 450,955 | 831,723 | 1.8 |
| 22 | Catalyst C | 4:6 | [B(C₉F₇)₄][DMAH] | 70 | 335,572 | 563,673 | 1.7 |
| 23 | Catalyst C | 4:6 | [B(C₉F₇)₄][DMAH] | 70 | 660,505 | 1,181,413 | 1.8 |
| 24 | Catalyst C | 4:6 | [B(C₆F₅)₄][DMAH] | 70 | 17,698 | 68,316 | 3.9 |
| 25 | Catalyst C | 4:6 | [B(C₆F₅)₄][DMAH] | 70 | 458,544 | 843,755 | 1.8 |
| 26 | Catalyst C | 4:6 | [B(C₆F₅)₄][CPh₃] | 70 | 486,398 | 837,467 | 1.7 |
| 27 | Catalyst C | 4:6 | [B(C₆F₅)₄][CPh₃] | 70 | 537,553 | 972,020 | 1.8 |
| 28 | Catalyst D | 1:1 | [B(C₉F₇)₄][DMAH] | 70 | 491,094 | 941,144 | 1.9 |
| 29 | Catalyst D | 1:1 | [B(C₉F₇)₄][DMAH] | 70 | 530,806 | 1,003,537 | 1.9 |
| 30 | Catalyst D | 1:1 | [B(C₆F₅)₄][DMAH] | 70 | 305,905 | 629,656 | 2.1 |
| 31 | Catalyst D | 1:1 | [B(C₆F₅)₄][DMAH] | 70 | 286,670 | 655,716 | 2.3 |
| 32 | Catalyst D | 1:1 | [B(C₆F₅)₄][CPh₃] | 70 | 30,492 | 131,502 | 4.3 |
| 33 | Catalyst D | 1:1 | [B(C₆F₅)₄][CPh₃] | 70 | 590,431 | 1,045,232 | 1.8 |
| 34 | Catalyst E | 1:1 | [B(C₉F₇)₄][DMAH] | 70 | 488,651 | 891,646 | 1.8 |
| 35 | Catalyst E | 1:1 | [B(C₉F₇)₄][DMAH] | 70 | 253,032 | 482,214 | 1.9 |
| 36 | Catalyst E | 1:1 | [B(C₆F₅)₄][DMAH] | 70 | 142,778 | 402,027 | 2.8 |
| 37 | Catalyst E | 1:1 | [B(C₆F₅)₄][DMAH] | 70 | 289,129 | 612,102 | 2.1 |
| 38 | Catalyst E | 1:1 | [B(C₆F₅)₄][CPh₃] | 70 | 30,834 | 100,515 | 3.3 |
| 39 | Catalyst E | 1:1 | [B(C₆F₅)₄][CPh₃] | 70 | 569,378 | 1,019,955 | 1.8 |
| 40 | Catalyst F | 8:2 | [B(C₉F₇)₄][DMAH] | 70 | 400,279 | 1,135,038 | 2.8 |
| 41 | Catalyst F | 8:2 | [B(C₉F₇)₄][DMAH] | 70 | 407,176 | 935,458 | 2.3 |
| 42 | Catalyst F | 8:2 | [B(C₆F₅)₄][DMAH] | 70 | 271,278 | 657,501 | 2.4 |
| 43 | Catalyst F | 8:2 | [B(C₆F₅)₄][DMAH] | 70 | 234,775 | 623,747 | 2.7 |
| 44 | Catalyst F | 8:2 | [B(C₆F₅)₄][CPh₃] | 70 | 506,149 | 912,611 | 1.8 |
| 45 | Catalyst F | 8:2 | [B(C₆F₅)₄][CPh₃] | 70 | 586,730 | 1,216,178 | 2.1 |
| 46 | Catalyst F | 2:8 | [B(C₉F₇)₄][DMAH] | 70 | 888,801 | 1,487,670 | 1.7 |
| 47 | Catalyst F | 2:8 | [B(C₉F₇)₄][DMAH] | 70 | 740,068 | 1,401,509 | 1.9 |
| 48 | Catalyst F | 2:8 | [B(C₆F₅)₄][DMAH] | 70 | 60,184 | 271,959 | 4.5 |
| 49 | Catalyst F | 2:8 | [B(C₆F₅)₄][DMAH] | 70 | 486,698 | 887,904 | 1.8 |
| 50 | Catalyst F | 2:8 | [B(C₆F₅)₄][CPh₃] | 70 | 614,522 | 1,129,053 | 1.8 |
| 51 | Catalyst F | 2:8 | [B(C₆F₅)₄][CPh₃] | 70 | 275,019 | 485,565 | 1.8 |

TABLE 4
temperature study in propylene polymerization
Temperature study in propylene polymerization

| | | | | | Quench | | Activity |
|---|---|---|---|---|---|---|---|
| | | syn:anti | | Tₚ | time | Yield | (kg/ |
| Run # | Catalyst | ratio | Activator | (deg C.) | (s) | (mg) | mmol · h) |
| 52 | Comp. CGC 1 | — | [B(C₉F₇)₄][DMAH] | 50 | 84 | 277.3 | 339.6 |
| 53 | Comp. CGC 1 | — | [B(C₉F₇)₄][DMAH] | 50 | 84 | 289.6 | 354.6 |
| 54 | Comp. CGC 1 | — | [B(C₉F₇)₄][DMAH] | 50 | 104 | 314.9 | 311.4 |
| 55 | Comp. CGC 1 | — | [B(C₉F₇)₄][DMAH] | 50 | 96 | 280.8 | 300.9 |
| 56 | Comp. CGC 1 | — | [B(C₉F₇)₄][DMAH] | 70 | 77 | 193.2 | 258.1 |
| 57 | Comp. CGC 1 | — | [B(C₉F₇)₄][DMAH] | 70 | 78 | 230.8 | 304.4 |
| 58 | Comp. CGC 1 | — | [B(C₉F₇)₄][DMAH] | 70 | 75 | 185.6 | 254.5 |
| 59 | Comp. CGC 1 | — | [B(C₉F₇)₄][DMAH] | 70 | 47 | 128.9 | 282.1 |
| 60 | Comp. CGC 1 | — | [B(C₉F₇)₄][DMAH] | 100 | 169 | 105.3 | 64.1 |
| 61 | Comp. CGC 1 | — | [B(C₉F₇)₄][DMAH] | 100 | 112 | 79.6 | 73.1 |
| 62 | Comp. CGC 1 | — | [B(C₉F₇)₄][DMAH] | 100 | 162 | 104.7 | 66.5 |
| 63 | Comp. CGC 1 | — | [B(C₉F₇)₄][DMAH] | 100 | 152 | 105.6 | 71.5 |
| 64 | Comp. CGC 2 | — | [B(C₉F₇)₄][DMAH] | 50 | 83 | 255.6 | 316.8 |
| 65 | Comp. CGC 2 | — | [B(C₉F₇)₄][DMAH] | 50 | 52 | 223.2 | 441.5 |
| 66 | Comp. CGC 2 | — | [B(C₉F₇)₄][DMAH] | 50 | 90 | 235.3 | 268.9 |
| 67 | Comp. CGC 2 | — | [B(C₉F₇)₄][DMAH] | 50 | 65 | 236.9 | 374.9 |
| 68 | Comp. CGC 2 | — | [B(C₉F₇)₄][DMAH] | 70 | 81 | 177.4 | 225.3 |
| 69 | Comp. CGC 2 | — | [B(C₉F₇)₄][DMAH] | 70 | 55 | 120.6 | 225.5 |
| 70 | Comp. CGC 2 | — | [B(C₉F₇)₄][DMAH] | 70 | 90 | 160 | 182.9 |
| 71 | Comp. CGC 2 | — | [B(C₉F₇)₄][DMAH] | 70 | 85 | 191.5 | 231.7 |
| 72 | Comp. CGC 2 | — | [B(C₉F₇)₄][DMAH] | 100 | 517 | 85.3 | 17.0 |
| 73 | Comp. CGC 2 | — | [B(C₉F₇)₄][DMAH] | 100 | 412 | 75.9 | 18.9 |
| 74 | Comp. CGC 2 | — | [B(C₉F₇)₄][DMAH] | 100 | 430 | 90.3 | 21.6 |
| 75 | Comp. CGC 2 | — | [B(C₉F₇)₄][DMAH] | 100 | 431 | 82.9 | 19.8 |
| 76 | Catalyst C | 1:1 | [B(C₉F₇)₄][DMAH] | 50 | 64 | 286.3 | 460.1 |
| 77 | Catalyst C | 1:1 | [B(C₉F₇)₄][DMAH] | 50 | 58 | 291.5 | 516.9 |
| 78 | Catalyst C | 1:1 | [B(C₉F₇)₄][DMAH] | 50 | 56 | 280.7 | 515.6 |
| 79 | Catalyst C | 1:1 | [B(C₉F₇)₄][DMAH] | 50 | 55 | 291.9 | 545.9 |
| 80 | Catalyst C | 1:1 | [B(C₉F₇)₄][DMAH] | 70 | 77 | 229.8 | 307.0 |
| 81 | Catalyst C | 1:1 | [B(C₉F₇)₄][DMAH] | 70 | 73 | 230.1 | 324.2 |
| 82 | Catalyst C | 1:1 | [B(C₉F₇)₄][DMAH] | 70 | 69 | 231.4 | 344.9 |
| 83 | Catalyst C | 1:1 | [B(C₉F₇)₄][DMAH] | 70 | 86 | 242.8 | 290.4 |
| 84 | Catalyst C | 1:1 | [B(C₉F₇)₄][DMAH] | 100 | 69 | 127.5 | 190.1 |
| 85 | Catalyst C | 1:1 | [B(C₉F₇)₄][DMAH] | 100 | 72 | 118.8 | 169.7 |
| 86 | Catalyst C | 1:1 | [B(C₉F₇)₄][DMAH] | 100 | 74 | 101.2 | 140.7 |
| 87 | Catalyst C | 1:1 | [B(C₉F₇)₄][DMAH] | 100 | 72 | 101.2 | 144.6 |
| 88 | Catalyst F | 1.4:1 | [B(C₉F₇)₄][DMAH] | 50 | 47 | 245.5 | 537.3 |
| 89 | Catalyst F | 1.4:1 | [B(C₉F₇)₄][DMAH] | 50 | 54 | 275.6 | 525.0 |
| 90 | Catalyst F | 1.4:1 | [B(C₉F₇)₄][DMAH] | 50 | 49 | 285.5 | 599.3 |
| 91 | Catalyst F | 1.4:1 | [B(C₉F₇)₄][DMAH] | 50 | 51 | 269.4 | 543.3 |
| 92 | Catalyst F | 1.4:1 | [B(C₉F₇)₄][DMAH] | 70 | 72 | 247.3 | 353.3 |
| 93 | Catalyst F | 1.4:1 | [B(C₉F₇)₄][DMAH] | 70 | 78 | 271.7 | 358.3 |
| 94 | Catalyst F | 1.4:1 | [B(C₉F₇)₄][DMAH] | 70 | 94 | 241.9 | 264.7 |
| 95 | Catalyst F | 1.4:1 | [B(C₉F₇)₄][DMAH] | 70 | 62 | 224.4 | 372.3 |
| 96 | Catalyst F | 1.4:1 | [B(C₉F₇)₄][DMAH] | 100 | 85 | 91.4 | 110.6 |
| 97 | Catalyst F | 1.4:1 | [B(C₉F₇)₄][DMAH] | 100 | 100 | 104 | 107.0 |
| 98 | Catalyst F | 1.4:1 | [B(C₉F₇)₄][DMAH] | 100 | 85 | 119.9 | 145.1 |
| 99 | Catalyst F | 1.4:1 | [B(C₉F₇)₄][DMAH] | 100 | 84 | 107.3 | 131.4 |

TABLE 5
characterization of polymers prepared during temperature study in propylene
polymerization (this table has characterization of polymers from Table 4)
Propylene polymerization at 70° C.

| | | syn:anti | | Tₚ | Mₙ | M_{w} | |
|---|---|---|---|---|---|---|---|
| Run # | Catalyst | ratio | Activator | (deg C.) | (g/mol) | (g/mol) | PDI |
| 52 | Comp. CGC 1 | — | [B(C₉F₇)₄][DMAH] | 50 | 292,267 | 700,790 | 2.4 |
| 53 | Comp. CGC 1 | — | [B(C₉F₇)₄][DMAH] | 50 | 274,669 | 688,820 | 2.5 |
| 54 | Comp. CGC 1 | — | [B(C₉F₇)₄][DMAH] | 50 | 283,674 | 653,711 | 2.3 |
| 55 | Comp. CGC 1 | — | [B(C₉F₇)₄][DMAH] | 50 | 295,464 | 726,338 | 2.5 |
| 56 | Comp. CGC 1 | — | [B(C₉F₇)₄][DMAH] | 70 | 265,613 | 491,147 | 1.8 |
| 57 | Comp. CGC 1 | — | [B(C₉F₇)₄][DMAH] | 70 | 213,939 | 458,873 | 2.1 |
| 58 | Comp. CGC 1 | — | [B(C₉F₇)₄][DMAH] | 70 | 238,487 | 502,239 | 2.1 |
| 59 | Comp. CGC 1 | — | [B(C₉F₇)₄][DMAH] | 70 | 171,094 | 398,820 | 2.3 |
| 60 | Comp. CGC 1 | — | [B(C₉F₇)₄][DMAH] | 100 | 114,302 | 208,270 | 1.8 |
| 61 | Comp. CGC 1 | — | [B(C₉F₇)₄][DMAH] | 100 | 129,713 | 227,534 | 1.8 |
| 62 | Comp. CGC 1 | — | [B(C₉F₇)₄][DMAH] | 100 | 113,958 | 230,168 | 2.0 |
| 63 | Comp. CGC 1 | — | [B(C₉F₇)₄][DMAH] | 100 | 123,867 | 243,748 | 2.0 |
| 64 | Comp. CGC 2 | — | [B(C₉F₇)₄][DMAH] | 50 | 344,979 | 801,684 | 2.3 |
| 65 | Comp. CGC 2 | — | [B(C₉F₇)₄][DMAH] | 50 | 416,676 | 861,219 | 2.1 |
| 66 | Comp. CGC 2 | — | [B(C₉F₇)₄][DMAH] | 50 | 384,757 | 768,908 | 2.0 |
| 67 | Comp. CGC 2 | — | [B(C₉F₇)₄][DMAH] | 50 | 332,650 | 839,442 | 2.5 |
| 68 | Comp. CGC 2 | — | [B(C₉F₇)₄][DMAH] | 70 | 263,815 | 548,098 | 2.1 |
| 69 | Comp. CGC 2 | — | [B(C₉F₇)₄][DMAH] | 70 | 267,931 | 525,264 | 2.0 |
| 70 | Comp. CGC 2 | — | [B(C₉F₇)₄][DMAH] | 70 | 244,448 | 569,555 | 2.3 |
| 71 | Comp. CGC 2 | — | [B(C₉F₇)₄][DMAH] | 70 | 204,419 | 499,715 | 2.4 |
| 72 | Comp. CGC 2 | — | [B(C₉F₇)₄][DMAH] | 100 | 171,295 | 329,825 | 1.9 |
| 73 | Comp. CGC 2 | — | [B(C₉F₇)₄][DMAH] | 100 | 158,014 | 305,576 | 1.9 |
| 74 | Comp. CGC 2 | — | [B(C₉F₇)₄][DMAH] | 100 | 154,023 | 304,685 | 2.0 |
| 75 | Comp. CGC 2 | — | [B(C₉F₇)₄][DMAH] | 100 | 171,130 | 316,692 | 1.9 |
| 76 | Catalyst C | 1:1 | [B(C₉F₇)₄][DMAH] | 50 | 394,031 | 1,163,931 | 3.0 |
| 77 | Catalyst C | 1:1 | [B(C₉F₇)₄][DMAH] | 50 | 416,332 | 1,087,715 | 2.6 |
| 78 | Catalyst C | 1:1 | [B(C₉F₇)₄][DMAH] | 50 | 390,857 | 1,068,200 | 2.7 |
| 79 | Catalyst C | 1:1 | [B(C₉F₇)₄][DMAH] | 50 | 326,995 | 1,000,573 | 3.1 |
| 80 | Catalyst C | 1:1 | [B(C₉F₇)₄][DMAH] | 70 | 215,796 | 593,940 | 2.8 |
| 81 | Catalyst C | 1:1 | [B(C₉F₇)₄][DMAH] | 70 | 219,961 | 561,892 | 2.6 |
| 82 | Catalyst C | 1:1 | [B(C₉F₇)₄][DMAH] | 70 | 235,818 | 610,400 | 2.6 |
| 83 | Catalyst C | 1:1 | [B(C₉F₇)₄][DMAH] | 70 | 231,712 | 584,224 | 2.5 |
| 84 | Catalyst C | 1:1 | [B(C₉F₇)₄][DMAH] | 100 | 126,059 | 247,883 | 2.0 |
| 85 | Catalyst C | 1:1 | [B(C₉F₇)₄][DMAH] | 100 | 108,429 | 230,160 | 2.1 |
| 86 | Catalyst C | 1:1 | [B(C₉F₇)₄][DMAH] | 100 | 126,587 | 238,103 | 1.9 |
| 87 | Catalyst C | 1:1 | [B(C₉F₇)₄][DMAH] | 100 | 127,258 | 252,944 | 2.0 |
| 88 | Catalyst F | 1.4:1 | [B(C₉F₇)₄][DMAH] | 50 | 714,490 | 1,791,276 | 2.5 |
| 89 | Catalyst F | 1.4:1 | [B(C₉F₇)₄][DMAH] | 50 | 709,271 | 1,722,579 | 2.4 |
| 90 | Catalyst F | 1.4:1 | [B(C₉F₇)₄][DMAH] | 50 | 514,988 | 1,518,927 | 2.9 |
| 91 | Catalyst F | 1.4:1 | [B(C₉F₇)₄][DMAH] | 50 | 627,671 | 1,637,606 | 2.6 |
| 92 | Catalyst F | 1.4:1 | [B(C₉F₇)₄][DMAH] | 70 | 391,308 | 906,838 | 2.3 |
| 93 | Catalyst F | 1.4:1 | [B(C₉F₇)₄][DMAH] | 70 | 338,893 | 908,741 | 2.7 |
| 94 | Catalyst F | 1.4:1 | [B(C₉F₇)₄][DMAH] | 70 | 420,115 | 984,275 | 2.3 |
| 95 | Catalyst F | 1.4:1 | [B(C₉F₇)₄][DMAH] | 70 | 333,460 | 852,846 | 2.6 |
| 96 | Catalyst F | 1.4:1 | [B(C₉F₇)₄][DMAH] | 100 | 220,625 | 442,297 | 2.0 |
| 97 | Catalyst F | 1.4:1 | [B(C₉F₇)₄][DMAH] | 100 | 251,384 | 490,246 | 2.0 |
| 98 | Catalyst F | 1.4:1 | [B(C₉F₇)₄][DMAH] | 100 | 219,128 | 439,846 | 2.0 |
| 99 | Catalyst F | 1.4:1 | [B(C₉F₇)₄][DMAH] | 100 | 283,471 | 510,640 | 1.8 |

This catalyst demonstrates that the inventive substitution that gives diastereomers plays a significant role contributing to catalyst activity and temperature stability. For example, both comparative catalysts had lower activity at 100° C. polymerization temperature relative to inventive catalysts.

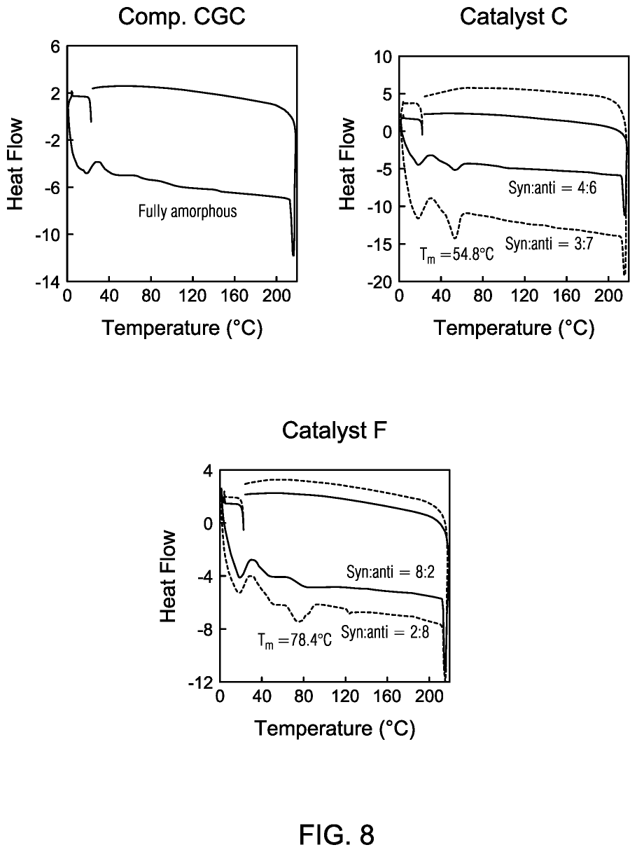

FIG. 8 illustrates differential scanning calorimetry (DSC) results (1^{st} melt) of polypropylenes prepared with comparative CGC and syn and anti enriched catalysts C and D. The polymers prepared with catalysts enriched in an anti-configuration afford polypropylene that demonstrated the onset of crystallinity as observed by DSC. For catalysts C and D, the plot shows Tm corresponding to a dip not present in the comparative CGC. The larger dip on the anti evidences the anti's role in the crystallization.

This is believed to be the first time that this phenomenon has been observed with constrained geometry catalysts. In general, the degree of crystallinity is low; the higher melting temperatures were observed with indacenyl catalyst F relative to indenyl variant C. This is consistent with traditionally higher melting iPP temperatures observed with indacenyl based C₁ and C₂ symmetric zirconocenes. At the same time, the cyclohexyl variants of catalyst D and E produced a fully amorphous polymer which also indicates that the size of the substituent at the amine group plays a significant role in tacticity control.

Both ethylene-propylene (EP) and ethylene-octene (EO) copolymers can be efficiently produced with catalyst compounds embodying the present technological advancement as demonstrated by Tables below.

TABLE 6
Ethylene-propylene (EP) copolymerization at 70° C.
Ethylene - Propylene copolymerization at 70° C.

| | | | | | Quench | | Activity |
|---|---|---|---|---|---|---|---|
| | | syn:anti | | Ethylene | time | Yield | (kg/ |
| Run # | Catalyst | ratio | Activator | (psi) | (s) | (mg) | mmol · h) |
| 100 | Comp. CGC 1 | — | [B(C₆F₅)₄][DMAH] | 20 | 12 | 265.7 | 2277.4 |
| 101 | Comp. CGC 1 | — | [B(C₆F₅)₄][DMAH] | 20 | 15 | 285.9 | 1960.5 |
| 102 | Comp. CGC 1 | — | [B(C₆F₅)₄][DMAH] | 50 | 10 | 257.9 | 2652.7 |
| 103 | Comp. CGC 1 | — | [B(C₆F₅)₄][DMAH] | 50 | 8 | 268.7 | 3454.7 |
| 104 | Catalyst B | 1:1 | [B(C₆F₅)₄][DMAH] | 20 | 37 | 198.6 | 552.1 |
| 105 | Catalyst B | 1:1 | [B(C₆F₅)₄][DMAH] | 20 | 40 | 229.5 | 590.1 |
| 106 | Catalyst B | 1:1 | [B(C₆F₅)₄][DMAH] | 50 | 29 | 255.6 | 906.6 |
| 107 | Catalyst B | 1:1 | [B(C₆F₅)₄][DMAH] | 50 | 28 | 265.7 | 976.0 |
| 108 | Catalyst D | 1:1 | [B(C₆F₅)₄][DMAH] | 20 | 28 | 254.7 | 935.6 |
| 109 | Catalyst D | 1:1 | [B(C₆F₅)₄][DMAH] | 20 | 25 | 254.4 | 1046.7 |
| 110 | Catalyst D | 1:1 | [B(C₆F₅)₄][DMAH] | 50 | 11 | 250.9 | 2346.1 |
| 111 | Catalyst D | 1:1 | [B(C₆F₅)₄][DMAH] | 50 | 16 | 246.8 | 1586.6 |
| 112 | Catalyst F | 1.4:1 | [B(C₆F₅)₄][DMAH] | 20 | 31 | 302.2 | 1002.7 |
| 113 | Catalyst F | 1.4:1 | [B(C₆F₅)₄][DMAH] | 20 | 32 | 296.5 | 953.0 |
| 114 | Catalyst F | 1.4:1 | [B(C₆F₅)₄][DMAH] | 50 | 6 | 235.1 | 4030.3 |
| 115 | Catalyst F | 1.4:1 | [B(C₆F₅)₄][DMAH] | 50 | 7 | 258.7 | 3801.3 |

TABLE 7
Characterization data for EP copolymers prepared at 70° C.
Ethylene - Propylene copolymerization at 70° C.

| | | | | | | | | Ethylene |
|---|---|---|---|---|---|---|---|---|
| | | syn:anti | | Ethylene | Mₙ | M_{w} | | content |
| Run # | Catalyst | ratio | Activator | (psi) | (g/mol) | (g/mol) | PDI | (wt %) |
| 100 | Comp. CGC 1 | — | [B(C₆F₅)₄][DMAH] | 20 | 47,073 | 144,859 | 3.1 | 4.6 |
| 101 | Comp. CGC 1 | — | [B(C₆F₅)₄][DMAH] | 20 | 49,383 | 150,016 | 3.0 | 5.2 |
| 102 | Comp. CGC 1 | — | [B(C₆F₅)₄][DMAH] | 50 | 42,867 | 193,134 | 4.5 | 12.8 |
| 103 | Comp. CGC 1 | — | [B(C₆F₅)₄][DMAH] | 50 | 36,471 | 168,258 | 4.6 | 12.7 |
| 104 | Catalyst B | 1:1 | [B(C₆F₅)₄][DMAH] | 20 | 215,420 | 400,840 | 1.9 | 3.3 |
| 105 | Catalyst B | 1:1 | [B(C₆F₅)₄][DMAH] | 20 | 263,963 | 538,370 | 2.0 | 4.7 |
| 106 | Catalyst B | 1:1 | [B(C₆F₅)₄][DMAH] | 50 | 244,493 | 486,378 | 2.0 | 12.0 |
| 107 | Catalyst B | 1:1 | [B(C₆F₅)₄][DMAH] | 50 | 213,887 | 458,205 | 2.1 | 10.9 |
| 108 | Catalyst D | 1:1 | [B(C₆F₅)₄][DMAH] | 20 | 142,200 | 400,100 | 2.8 | 4.4 |
| 109 | Catalyst D | 1:1 | [B(C₆F₅)₄][DMAH] | 20 | 166,898 | 371,403 | 2.2 | 2.0 |
| 110 | Catalyst D | 1:1 | [B(C₆F₅)₄][DMAH] | 50 | 127,730 | 360,016 | 2.8 | 10.4 |
| 111 | Catalyst D | 1:1 | [B(C₆F₅)₄][DMAH] | 50 | 127,401 | 378,418 | 3.0 | 10.6 |
| 112 | Catalyst F | 1.4:1 | [B(C₆F₅)₄][DMAH] | 20 | 110,362 | 443,560 | 4.0 | 3.2 |
| 113 | Catalyst F | 1.4:1 | [B(C₆F₅)₄][DMAH] | 20 | 115,627 | 485,021 | 4.2 | 3.7 |
| 114 | Catalyst F | 1.4:1 | [B(C₆F₅)₄][DMAH] | 50 | 165,039 | 562,599 | 3.4 | 15.6 |
| 115 | Catalyst F | 1.4:1 | [B(C₆F₅)₄][DMAH] | 50 | 145,340 | 544,058 | 3.7 | 14.4 |

TABLE 8
Ethylene-propylene (EP) copolymerization at 100° C.
Ethylene - Propylene copolymerization at 100° C.

| | | | | | Quench | | Activity |
|---|---|---|---|---|---|---|---|
| | | syn:anti | | Ethylene | time | Yield | (kg/ |
| Run # | Catalyst | ratio | Activator | (psi) | (s) | (mg) | mmol · h) |
| 116 | Comp. CGC 1 | — | [B(C₆F₅)₄][DMAH] | 20 | 14 | 166.1 | 1220.3 |
| 117 | Comp. CGC 1 | — | [B(C₆F₅)₄][DMAH] | 20 | 14 | 181.7 | 1334.9 |
| 118 | Comp. CGC 1 | — | [B(C₆F₅)₄][DMAH] | 50 | 5 | 137.6 | 2830.6 |
| 119 | Comp. CGC 1 | — | [B(C₆F₅)₄][DMAH] | 50 | 4 | 157.1 | 4039.7 |
| 120 | Catalyst B | 1:1 | [B(C₆F₅)₄][DMAH] | 20 | 34 | 140.6 | 425.3 |
| 121 | Catalyst B | 1:1 | [B(C₆F₅)₄][DMAH] | 20 | 34 | 139.4 | 421.7 |
| 122 | Catalyst B | 1:1 | [B(C₆F₅)₄][DMAH] | 50 | 20 | 155.7 | 800.7 |
| 123 | Catalyst B | 1:1 | [B(C₆F₅)₄][DMAH] | 50 | 20 | 152.2 | 782.7 |
| 124 | Catalyst E | 1:1 | [B(C₆F₅)₄][DMAH] | 20 | 18 | 120.3 | 687.4 |
| 125 | Catalyst E | 1:1 | [B(C₆F₅)₄][DMAH] | 20 | 18 | 148.8 | 850.3 |
| 126 | Catalyst E | 1:1 | [B(C₆F₅)₄][DMAH] | 50 | 24 | 167.7 | 718.7 |
| 127 | Catalyst E | 1:1 | [B(C₆F₅)₄][DMAH] | 50 | 12 | 165.5 | 1418.6 |
| 128 | Catalyst F | 1.4:1 | [B(C₆F₅)₄][DMAH] | 20 | 21 | 174.8 | 856.2 |
| 129 | Catalyst F | 1.4:1 | [B(C₆F₅)₄][DMAH] | 20 | 17 | 160 | 968.1 |
| 130 | Catalyst F | 1.4:1 | [B(C₆F₅)₄][DMAH] | 50 | 11 | 183 | 1711.2 |
| 131 | Catalyst F | 1.4:1 | [B(C₆F₅)₄][DMAH] | 50 | 8 | 169.6 | 2180.6 |

TABLE 9
Characterization of EP copolymers prepared at 100° C.
Ethylene - Propylene copolymerization at 100° C.

| | | | | | | | | Wt % |
|---|---|---|---|---|---|---|---|---|
| | | syn:anti | | Ethylene | | | | C₂ in |
| Run # | Catalyst | ratio | Activator | (psi) | Mₙ | M_{w} | PDI | polymer |
| 116 | Comp. CGC 1 | — | [B(C₆F₅)₄][DMAH] | 20 | 21,929 | 53,938 | 2.5 | 11.3 |
| 117 | Comp. CGC 1 | — | [B(C₆F₅)₄][DMAH] | 20 | 25,087 | 56,357 | 2.2 | 7.5 |
| 118 | Comp. CGC 1 | — | [B(C₆F₅)₄][DMAH] | 50 | 24,614 | 69,856 | 2.8 | 25.9 |
| 119 | Comp. CGC 1 | — | [B(C₆F₅)₄][DMAH] | 50 | 27,112 | 72,995 | 2.7 | 18.5 |
| 120 | Catalyst B | 1:1 | [B(C₆F₅)₄][DMAH] | 20 | 148,053 | 302,844 | 2 | 6.6 |
| 121 | Catalyst B | 1:1 | [B(C₆F₅)₄][DMAH] | 20 | 150,922 | 291,513 | 1.9 | 7.3 |
| 122 | Catalyst B | 1:1 | [B(C₆F₅)₄][DMAH] | 50 | 130,051 | 284,724 | 2.2 | 15.0 |
| 123 | Catalyst B | 1:1 | [B(C₆F₅)₄][DMAH] | 50 | 151,329 | 290,538 | 1.9 | 15.1 |
| 124 | Catalyst E | 1:1 | [B(C₆F₅)₄][DMAH] | 20 | 92,588 | 221,564 | 2.4 | 4.7 |
| 125 | Catalyst E | 1:1 | [B(C₆F₅)₄][DMAH] | 20 | 81,363 | 204,827 | 2.5 | 7.6 |
| 126 | Catalyst E | 1:1 | [B(C₆F₅)₄][DMAH] | 50 | 93,779 | 208,150 | 2.2 | 15.8 |
| 127 | Catalyst E | 1:1 | [B(C₆F₅)₄][DMAH] | 50 | 88,609 | 211,240 | 2.4 | 13.7 |
| 128 | Catalyst F | 1.4:1 | [B(C₆F₅)₄][DMAH] | 20 | 88,860 | 216,819 | 2.4 | 6.7 |
| 129 | Catalyst F | 1.4:1 | [B(C₆F₅)₄][DMAH] | 20 | 76,884 | 204,136 | 2.7 | 6.3 |
| 130 | Catalyst F | 1.4:1 | [B(C₆F₅)₄][DMAH] | 50 | 81,733 | 241,385 | 3 | 18.2 |
| 131 | Catalyst F | 1.4:1 | [B(C₆F₅)₄][DMAH] | 50 | 95,821 | 262,031 | 2.7 | 16.3 |

TABLE 10
Ethylene-Octene (EO) Copolymers Prepared at 100° C.
Ethylene - octene (EO) copolymerization at 100° C.

| | | | | | Quench | | Activity |
|---|---|---|---|---|---|---|---|
| | | syn:anti | | 1-octene | time | Yield | (kg/ |
| Run # | Catalyst | ratio | Activator | (μL) | (s) | (mg) | mmol · h) |
| 132 | Comp. CGC 1 | — | [B(C₆F₅)₄][DMAH] | 0 | 640 | 61.9 | 17.4 |
| 133 | Comp. CGC 1 | — | [B(C₆F₅)₄][DMAH] | 0 | 152 | 58.6 | 69.4 |
| 134 | Comp. CGC 1 | — | [B(C₆F₅)₄][DMAH] | 50 | 89 | 67.1 | 135.7 |
| 135 | Comp. CGC 1 | — | [B(C₆F₅)₄][DMAH] | 50 | 86 | 75.8 | 158.7 |
| 136 | Comp. CGC 1 | — | [B(C₆F₅)₄][DMAH] | 100 | 47 | 88.4 | 338.6 |
| 137 | Comp. CGC 1 | — | [B(C₆F₅)₄][DMAH] | 100 | 40 | 87.4 | 393.3 |
| 138 | Comp. CGC 1 | — | [B(C₆F₅)₄][DMAH] | 150 | 1800 | 23.6 | 2.4 |
| 139 | Comp. CGC 1 | — | [B(C₆F₅)₄][DMAH] | 150 | 1800 | 47.6 | 4.8 |
| 140 | Comp. CGC 1 | — | [B(C₆F₅)₄][DMAH] | 200 | 1801 | 49 | 4.9 |
| 141 | Comp. CGC 1 | — | [B(C₆F₅)₄][DMAH] | 200 | 46 | 88.6 | 346.7 |
| 142 | Comp. CGC 1 | — | [B(C₆F₅)₄][DMAH] | 300 | 92 | 87.4 | 171.0 |
| 143 | Comp. CGC 1 | — | [B(C₆F₅)₄][DMAH] | 300 | 43 | 119.8 | 501.5 |
| 144 | Catalyst B | 1:1 | [B(C₆F₅)₄][DMAH] | 0 | 326 | 41.2 | 22.7 |
| 145 | Catalyst B | 1:1 | [B(C₆F₅)₄][DMAH] | 0 | 422 | 38.9 | 16.6 |
| 146 | Catalyst B | 1:1 | [B(C₆F₅)₄][DMAH] | 50 | 693 | 50.8 | 13.2 |
| 147 | Catalyst B | 1:1 | [B(C₆F₅)₄][DMAH] | 50 | 173 | 56.3 | 58.6 |
| 148 | Catalyst B | 1:1 | [B(C₆F₅)₄][DMAH] | 100 | 1800 | 61.7 | 6.2 |
| 149 | Catalyst B | 1:1 | [B(C₆F₅)₄][DMAH] | 100 | 174 | 61.7 | 63.8 |
| 150 | Catalyst B | 1:1 | [B(C₆F₅)₄][DMAH] | 150 | 1800 | 38.4 | 3.8 |
| 151 | Catalyst B | 1:1 | [B(C₆F₅)₄][DMAH] | 150 | 888 | 51.8 | 10.5 |
| 152 | Catalyst B | 1:1 | [B(C₆F₅)₄][DMAH] | 200 | 1801 | 59.8 | 6.0 |
| 153 | Catalyst B | 1:1 | [B(C₆F₅)₄][DMAH] | 200 | 1802 | 61.1 | 6.1 |
| 154 | Catalyst B | 1:1 | [B(C₆F₅)₄][DMAH] | 300 | 1800 | 71 | 7.1 |
| 155 | Catalyst B | 1:1 | [B(C₆F₅)₄][DMAH] | 300 | 1800 | 84.7 | 8.5 |
| 156 | Catalyst E | 1:1 | [B(C₆F₅)₄][DMAH] | 0 | 145 | 38.5 | 47.8 |
| 157 | Catalyst E | 1:1 | [B(C₆F₅)₄][DMAH] | 0 | 146 | 40.8 | 50.3 |
| 158 | Catalyst E | 1:1 | [B(C₆F₅)₄][DMAH] | 50 | 102 | 62.5 | 110.3 |
| 159 | Catalyst E | 1:1 | [B(C₆F₅)₄][DMAH] | 50 | 109 | 63.1 | 104.2 |
| 160 | Catalyst E | 1:1 | [B(C₆F₅)₄][DMAH] | 100 | 118 | 72.9 | 111.2 |
| 161 | Catalyst E | 1:1 | [B(C₆F₅)₄][DMAH] | 100 | 77 | 73.3 | 171.4 |
| 162 | Catalyst E | 1:1 | [B(C₆F₅)₄][DMAH] | 150 | 131 | 69.3 | 95.2 |
| 163 | Catalyst E | 1:1 | [B(C₆F₅)₄][DMAH] | 150 | 111 | 70.8 | 114.8 |
| 164 | Catalyst E | 1:1 | [B(C₆F₅)₄][DMAH] | 200 | 111 | 80.1 | 129.9 |
| 165 | Catalyst E | 1:1 | [B(C₆F₅)₄][DMAH] | 200 | 125 | 81.4 | 117.2 |
| 166 | Catalyst E | 1:1 | [B(C₆F₅)₄][DMAH] | 300 | 131 | 102.8 | 141.3 |
| 167 | Catalyst E | 1:1 | [B(C₆F₅)₄][DMAH] | 300 | 144 | 100.8 | 126.0 |
| 168 | Catalyst F | 1.4:1 | [B(C₆F₅)₄][DMAH] | 0 | 46 | 68.1 | 266.5 |
| 169 | Catalyst F | 1.4:1 | [B(C₆F₅)₄][DMAH] | 0 | 35 | 71.4 | 367.2 |
| 170 | Catalyst F | 1.4:1 | [B(C₆F₅)₄][DMAH] | 50 | 70 | 82.8 | 212.9 |
| 171 | Catalyst F | 1.4:1 | [B(C₆F₅)₄][DMAH] | 50 | 60 | 79.5 | 238.5 |
| 172 | Catalyst F | 1.4:1 | [B(C₆F₅)₄][DMAH] | 100 | 136 | 87.8 | 116.2 |
| 173 | Catalyst F | 1.4:1 | [B(C₆F₅)₄][DMAH] | 100 | 88 | 92.3 | 188.8 |
| 174 | Catalyst F | 1.4:1 | [B(C₆F₅)₄][DMAH] | 150 | 127 | 93.2 | 132.1 |
| 175 | Catalyst F | 1.4:1 | [B(C₆F₅)₄][DMAH] | 150 | 54 | 94.5 | 315.0 |
| 176 | Catalyst F | 1.4:1 | [B(C₆F₅)₄][DMAH] | 200 | 101 | 108.4 | 193.2 |
| 177 | Catalyst F | 1.4:1 | [B(C₆F₅)₄][DMAH] | 200 | 68 | 100.2 | 265.2 |
| 178 | Catalyst F | 1.4:1 | [B(C₆F₅)₄][DMAH] | 300 | 84 | 114.9 | 246.2 |

TABLE 11
Characterization of EO copolymers prepared at 100° C.
Ethylene - octene (EO) copolymerization at 100° C.

| | | | | | | | | 1-octene | |
|---|---|---|---|---|---|---|---|---|---|
| | | syn:anti | | 1-octene | Mₙ | M_{w} | | content | Tₘ |
| Run # | Catalyst | ratio | Activator | (μL) | (g/mol) | (g/mol) | PDI | (wt %) | (deg C.) |
| 132 | Comp. CGC 1 | — | [B(C₆F₅)₄][DMAH] | 0 | 699,001 | 1,405,849 | 2.0 | — | 135.5 |
| 133 | Comp. CGC 1 | — | [B(C₆F₅)₄][DMAH] | 0 | 729,438 | 1,319,263 | 1.8 | — | 136.1 |
| 134 | Comp. CGC 1 | — | [B(C₆F₅)₄][DMAH] | 50 | 316,484 | 687,574 | 2.2 | 14.2 | 99.3 |
| 135 | Comp. CGC 1 | — | [B(C₆F₅)₄][DMAH] | 50 | 253,402 | 653,314 | 2.6 | 13.7 | 99.0 |
| 136 | Comp. CGC 1 | — | [B(C₆F₅)₄][DMAH] | 100 | 199,656 | 434,901 | 2.2 | 24.2 | 79.3 |
| 137 | Comp. CGC 1 | — | [B(C₆F₅)₄][DMAH] | 100 | 207,649 | 452,515 | 2.2 | 22.2 | 79.9 |
| 138 | Comp. CGC 1 | — | [B(C₆F₅)₄][DMAH] | 150 | 291,809 | 504,584 | 1.7 | 28.9 | 71.5 |
| 139 | Comp. CGC 1 | — | [B(C₆F₅)₄][DMAH] | 150 | 251,447 | 486,228 | 1.9 | 24.0 | 71.7 |
| 140 | Comp. CGC 1 | — | [B(C₆F₅)₄][DMAH] | 200 | 244,835 | 432,545 | 1.8 | 34.3 | 48.9 |
| 141 | Comp. CGC 1 | — | [B(C₆F₅)₄][DMAH] | 200 | 173,779 | 319,162 | 1.8 | 34.7 | — |
| 142 | Comp. CGC 1 | — | [B(C₆F₅)₄][DMAH] | 300 | 165,142 | 305,679 | 1.9 | 46.9 | — |
| 143 | Comp. CGC 1 | — | [B(C₆F₅)₄][DMAH] | 300 | 134,009 | 259,833 | 1.9 | 49.7 | — |
| 144 | Catalyst B | 1:1 | [B(C₆F₅)₄][DMAH] | 0 | 1,054,628 | 2,136,794 | 2.0 | — | 134.5 |
| 145 | Catalyst B | 1:1 | [B(C₆F₅)₄][DMAH] | 0 | 1,102,563 | 2,022,988 | 1.8 | — | 135.2 |
| 146 | Catalyst B | 1:1 | [B(C₆F₅)₄][DMAH] | 50 | 609,166 | 1,245,250 | 2.0 | 18.1 | 77.7 |
| 147 | Catalyst B | 1:1 | [B(C₆F₅)₄][DMAH] | 50 | 734,962 | 1,352,030 | 1.8 | 18.6 | 79.0 |
| 148 | Catalyst B | 1:1 | [B(C₆F₅)₄][DMAH] | 100 | 516,690 | 1,031,369 | 2.0 | 31.1 | 43.5 |
| 149 | Catalyst B | 1:1 | [B(C₆F₅)₄][DMAH] | 100 | 513,452 | 952,427 | 1.9 | 42.2 | — |
| 150 | Catalyst B | 1:1 | [B(C₆F₅)₄][DMAH] | 150 | 353,954 | 757,544 | 2.1 | 48.3 | — |
| 151 | Catalyst B | 1:1 | [B(C₆F₅)₄][DMAH] | 150 | 449,721 | 820,872 | 1.8 | 50.7 | — |
| 152 | Catalyst B | 1:1 | [B(C₆F₅)₄][DMAH] | 200 | 396,373 | 734,890 | 1.9 | 59.0 | — |
| 153 | Catalyst B | 1:1 | [B(C₆F₅)₄][DMAH] | 200 | 384,538 | 733,289 | 1.9 | 55.3 | — |
| 154 | Catalyst B | 1:1 | [B(C₆F₅)₄][DMAH] | 300 | 358,108 | 694,186 | 1.9 | 70.9 | — |
| 155 | Catalyst B | 1:1 | [B(C₆F₅)₄][DMAH] | 300 | 339,564 | 688,155 | 2.0 | 65.1 | — |
| 156 | Catalyst D | 1:1 | [B(C₆F₅)₄][DMAH] | 0 | 671,481 | 1,388,243 | 2.1 | — | 135.2 |
| 157 | Catalyst D | 1:1 | [B(C₆F₅)₄][DMAH] | 0 | 888,919 | 1,737,945 | 2.0 | — | 135.2 |
| 158 | Catalyst D | 1:1 | [B(C₆F₅)₄][DMAH] | 50 | 559,233 | 1,141,222 | 2.0 | 18.5 | 82.0 |
| 159 | Catalyst D | 1:1 | [B(C₆F₅)₄][DMAH] | 50 | 525,390 | 1,030,325 | 2.0 | 23.4 | 79.0 |
| 160 | Catalyst D | 1:1 | [B(C₆F₅)₄][DMAH] | 100 | 430,629 | 826,361 | 1.9 | 33.9 | — |
| 161 | Catalyst D | 1:1 | [B(C₆F₅)₄][DMAH] | 100 | 457,159 | 846,222 | 1.9 | 38.1 | 43.8 |
| 162 | Catalyst D | 1:1 | [B(C₆F₅)₄][DMAH] | 150 | 372,343 | 667,656 | 1.8 | 53.9 | — |
| 163 | Catalyst D | 1:1 | [B(C₆F₅)₄][DMAH] | 150 | 376,819 | 716,405 | 1.9 | 40.3 | — |
| 164 | Catalyst D | 1:1 | [B(C₆F₅)₄][DMAH] | 200 | 311,157 | 592,519 | 1.9 | 49.2 | — |
| 165 | Catalyst D | 1:1 | [B(C₆F₅)₄][DMAH] | 200 | 322,675 | 620,776 | 1.9 | 49.9 | — |
| 166 | Catalyst D | 1:1 | [B(C₆F₅)₄][DMAH] | 300 | 220,512 | 520,191 | 2.4 | 62.7 | — |
| 167 | Catalyst D | 1:1 | [B(C₆F₅)₄][DMAH] | 300 | 278,870 | 578,696 | 2.1 | 59.2 | — |
| 168 | Catalyst F | 1.4:1 | [B(C₆F₅)₄][DMAH] | 0 | 1,222,985 | 2,777,511 | 2.3 | — | 134.9 |
| 169 | Catalyst F | 1.4:1 | [B(C₆F₅)₄][DMAH] | 0 | 1,036,833 | 2,568,743 | 2.5 | — | 135.5 |
| 170 | Catalyst F | 1.4:1 | [B(C₆F₅)₄][DMAH] | 50 | 820,755 | 2,199,890 | 2.7 | 16.0 | 95.8 |
| 171 | Catalyst F | 1.4:1 | [B(C₆F₅)₄][DMAH] | 50 | 972,150 | 2,333,014 | 2.4 | 16.3 | 98.2 |
| 172 | Catalyst F | 1.4:1 | [B(C₆F₅)₄][DMAH] | 100 | 663,662 | 1,841,638 | 2.8 | 30.8 | 74.2 |
| 173 | Catalyst F | 1.4:1 | [B(C₆F₅)₄][DMAH] | 100 | 761,404 | 2,073,540 | 2.7 | 25.3 | 83.2 |
| 174 | Catalyst F | 1.4:1 | [B(C₆F₅)₄][DMAH] | 150 | 671,719 | 1,635,065 | 2.4 | 36.8 | — |
| 175 | Catalyst F | 1.4:1 | [B(C₆F₅)₄][DMAH] | 150 | 699,051 | 1,658,685 | 2.4 | 31.4 | — |
| 176 | Catalyst F | 1.4:1 | [B(C₆F₅)₄][DMAH] | 200 | 696,812 | 1,775,995 | 2.5 | 39.0 | — |
| 177 | Catalyst F | 1.4:1 | [B(C₆F₅)₄][DMAH] | 200 | 604,871 | 1,605,176 | 2.7 | 36.1 | — |
| 178 | Catalyst F | 1.4:1 | [B(C₆F₅)₄][DMAH] | 300 | 505,093 | 1,473,887 | 2.9 | 57.7 | — |

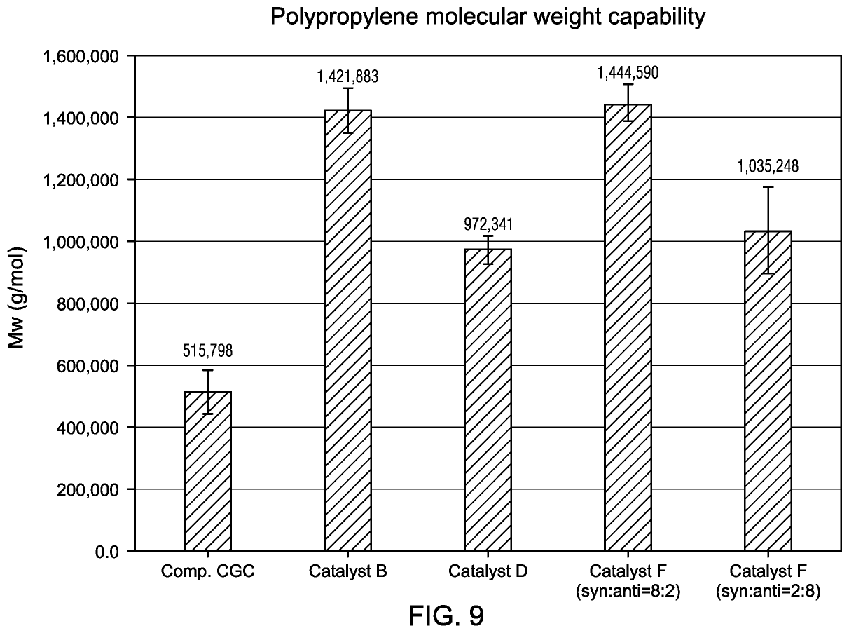

FIG. 9 is a bar graph illustrating polypropylene molecular weight capability. As shown, the catalyst compounds embodying the present technological advancement obtain superior molecular weights relative to comp. CGC. The molecular weights achievable with the catalyst compounds embodying the present technological advancement range from 950,000 (g/mol) to 1,500,000 (g/mol), and preferably from 970,000 to 1,445,000, preferably 1,000,000 (g/mol) to 1,444,590 (g/mol).

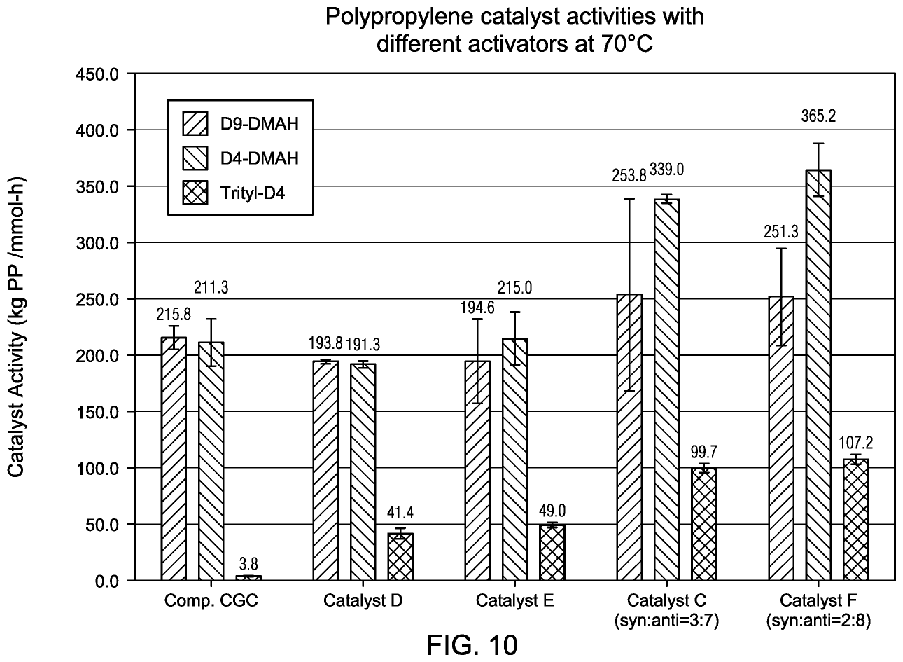

FIG. 10 is a bar graph illustrating polypropylene catalyst activities with different activators at 70° C. The catalyst compounds embodying the present technological advancement have superior or comparable catalyst activity relative to the comp. CGC.

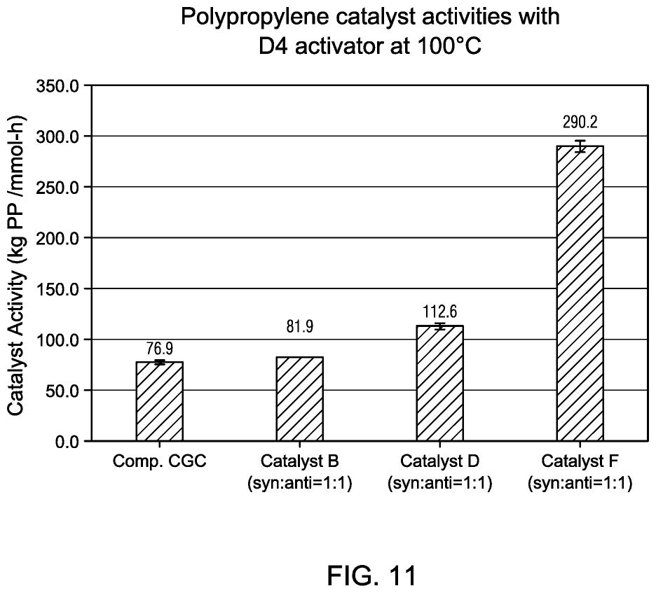

FIG. 11 is a bar graph illustrating polypropylene catalyst activities with the [B(C₆F₅)₄][DMAH] activator at 100° C. The catalyst compounds embodying the present technological advancement have superior catalyst activity relative to the comp. CGC.

### Polymerization Procedure

Propylene (PP) polymerizations were carried out under high-throughput conditions according to the following general procedure. A pre-weighed glass vial insert and disposable stirring paddle were fitted to each reaction vessel of the reactor, which contains 48 individual reaction vessels. The reactor was then closed and liquid propylene (typically 1-4 mL) was introduced at a desired pressure. Then solvent (typically the isohexane) was added to bring the total reaction volume, including the subsequent additions, to 5 mL and the reactor vessels were heated to their set temperature (usually from about 50° C. to about 110° C.). The contents of the vessel were stirred at 800 rpm. An activator solution (typically 1.1 molar equivalents relative to catalyst in toluene) was then injected into the reaction vessel along with 500 microliters of isohexane. Catalyst (typically 0.50 mM in toluene, such as 20-40 nmol of catalyst) and another aliquot of isohexane (500 microliters) were then added to initiate the reaction. Equivalence is determined based on the mol equivalents relative to the moles of the transition metal in the catalyst complex. The reaction was then allowed to proceed until a pre-determined amount of pressure had been taken up by the reaction. Alternatively, the reaction may be allowed to proceed for a set amount of time. At this point, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC₃₀₀₀D vacuum evaporator operating at elevated temperature and reduced pressure. The vial was then weighed to determine the yield of the polymer product. The resultant polymer was analyzed by Rapid GPC (see below) to determine the molecular weight and by DSC (see below) to determine melting point.

Ethylen-Propylene (EP) copolymerizations were carried out under high-throughput conditions according to the following general procedure. A pre-weighed glass vial insert and disposable stirring paddle were fitted to each reaction vessel of the reactor, which contains 48 individual reaction vessels. The reactor was then closed and liquid propylene (typically 1-4 mL) was introduced at a desired pressure. Then solvent (typically the isohexane) was added to bring the total reaction volume, including the subsequent additions, to 5 mL and the reactor vessels were heated to their set temperature (usually from about 50° C. to about 110° C.). The reactors were then pressurized with desired amount of ethylene (typically 20-100 psi). The contents of the vessel were stirred at 800 rpm. An activator solution (typically 1.1 molar equivalents relative to catalyst in toluene) was then injected into the reaction vessel along with 500 microliters of isohexane. Catalyst (typically 0.50 mM in toluene, such as 20-40 nmol of catalyst) and another aliquot of isohexane (500 microliters) were then added to initiate the reaction. Equivalence is determined based on the mol equivalents relative to the moles of the transition metal in the catalyst complex. The reaction was then allowed to proceed until a pre-determined amount of pressure had been taken up by the reaction. Alternatively, the reaction may be allowed to proceed for a set amount of time. At this point, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC₃₀₀₀D vacuum evaporator operating at elevated temperature and reduced pressure. The vial was then weighed to determine the yield of the polymer product. The resultant polymer was analyzed by Rapid GPC (see below) to determine the molecular weight and by DSC (see below) to determine melting point.

In an exemplary embodiment, a method can include introducing propylene and a catalyst system of claim 4 into a reactor at a reactor pressure of from 1 bar to 70 bar and a reactor temperature of from 20° C. to 150° C.; and obtaining a polymer. The introducing can include introducing propylene and an alpha-olefin, and the polymer is a co-polymer of propylene and the alpha-olefin. The alpha-olefin can be a C₂ or C₄ to C₄₀ olefin monomer, preferably ethylene, and the co-polymer can have a Mw of 50,000-600,000 g/mol and preferably an ethylene content from 0.5-50 wt %. The polymer can be polypropylene that has a M_{w} of 50,000-1,500,000 g/mol or polyethylene that has a Mw of 50,000-3,000,000 g/mol. In this method, the catalyst compound can be enriched to either syn or anti form in at least 6:4, more preferably 7:3, more preferably 8:2, more preferably 9:1 and higher. For example, the catalyst compound can be enriched in anti form and the polymer can be a propylene elastomer with a melt temperature ranging between 50-80° C.

Ethylene-octene (EO) copolymerizations were carried out under high-throughput conditions according to the following general procedure. A pre-weighed glass vial insert and disposable stirring paddle were fitted to each reaction vessel of the reactor, which contains 48 individual reaction vessels. The reactor was then closed and ethylene gas was introduced at a desired pressure. Then solvent (typically the isohexane) was added to bring the total reaction volume, including the subsequent additions, to 5 mL and the reactor vessels were heated to their set temperature (usually from about 50° C. to about 110° C.). The contents of the vessel were stirred at 800 rpm. An activator solution (typically 1.1 molar equivalents relative to catalyst in toluene) was then injected into the reaction vessel along with 500 microliters of isohexane, followed by addition of 1-octene (typically 50-300 μL). Catalyst (typically 0.50 mM in toluene, such as 20-40 nmol of catalyst) and another aliquot of isohexane (500 microliters) were then added to initiate the reaction. Equivalence is determined based on the mol equivalents relative to the moles of the transition metal in the catalyst complex. The reaction was then allowed to proceed until a pre-determined amount of pressure had been taken up by the reaction. Alternatively, the reaction may be allowed to proceed for a set amount of time. At this point, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC₃₀₀₀D vacuum evaporator operating at elevated temperature and reduced pressure. The vial was then weighed to determine the yield of the polymer product. The resultant polymer was analyzed by Rapid GPC (see below) to determine the molecular weight and by DSC (see below) to determine melting point.

In an exemplary embodiment, a method can include introducing 1-octene and a catalyst system of claim 4 into a reactor at a reactor pressure of from 1 bar to 70 bar and a reactor temperature of from 20° C. to 150° C.; and obtaining a polymer. The introducing can include introducing propylene and an alpha-olefin, and the polymer is a co-polymer of propylene and the alpha-olefin. The polymer can be an ethylene-octene (EO) copolymer that has a Mw of 50,000-1,500,000 g/mol, an 1-octene content from 0.5 to 60 wt % and Tₘ less than 125° C.

### Rapid GPC Procedure

To determine various molecular weight related values by GPC, high temperature size 5 exclusion chromatography was performed using an automated “Rapid GPC” system as generally described in U.S. Pat. Nos. 6,491,816; 6,491,823; 6,475,391; 6,461,515; 6,436,292; 6,406,632; 6,175,409; 6,454,947; 6,260,407; and 6,294,388, each of which is fully incorporated herein by reference for US purposes. This apparatus has a series of three 30 cm×7.5 mm linear columns, each containing PLgel 10 μm, Mix B. The GPC system was calibrated using polystyrene standards ranging from 580-3,390,000 g/mol. The system was operated at an eluent flow rate of 2.0 mL/minutes and an oven temperature of 165° C. 1,2,4-trichlorobenzene was used as the eluent. The polymer samples were dissolved in 1,2,4-trichlorobenzene at a concentration of 0.1-0.9 mg/mL. 250 uL of a polymer solution was injected into the system. The concentration of the polymer in the eluent was monitored using an evaporative light scattering detector (as shown by the examples in Table 3) or Polymer Char IR⁴ detector. The molecular weights presented are relative to linear polystyrene standards and are uncorrected.

### DSC Procedure

For the high throughput samples, the melting temperature (Tm) was measured using Differential Scanning Calorimetry (DSC) using commercially available equipment such as a TA Instruments TA-Q200 DSC. Typically, 5 to 10 mg of molded polymer or plasticized polymer is sealed in an aluminum pan and loaded into the instrument at about room temperature. Samples were pre-annealed at about 220° C. for about 15 minutes and then allowed to cool to about room temperature overnight. The samples were then heated to about 220° C. at a heating rate of about 100° C./min, held at this temperature for at least about 5 minutes, and then cooled at a rate of about 50° C./min to a temperature typically at least about 50° C. below the crystallization temperature. Melting points were collected during the heating period.

### ¹H NMR Procedure

¹H NMR data of catalysts and ligands can be collected at 23° C. using a 5 mm tube on a 400 MHz Bruker spectrometer with deuterated methylene chloride (CD₂Cl₂), benzene (C₆D₆) or THF (thf-d8). Data was recorder with a 30° pulse with either 8 or 16 transients.

¹H NMR data of the polymer can be collected at 120° C. using a 10 mm cryoprobe on a 600 MHz Bruker spectrometer with deuterated tetrachloroethane (tce-d2). Samples were prepped with a concentration of 30 mg/mL at 140° C. Data was recorded with a 30° pulse, 5 second delay, 512 transients. Signals were integrated and the numbers of unsaturation types per 1,000 carbons were reported. The shift regions for unsaturations were in the following table.

| | | Number of |
|---|---|---|
| | Region | hydrogens |
| Unsaturation Type | (ppm) | per structure |
| Vinyl | 4.95-5.10 | 2 |
| Vinylidene | 4.70-4.84 | 2 |
| Vinylene | 5.31-5.55 | 2 |
| Trisubstituted | 5.11-5.30 | 1 |

The transient extensional viscosity was measured at 190° C. using a SER²-P testing Platform available from Xpansion Instruments LLC, Tallmadge, Ohio, USA. The sample was prepared placing the pellets in a mold measuring approximately 50 mm×50 mm with a thickness of ˜0.5 mm. The mold was pressed in a carver laboratory press with a 3 pressure stage procedure at 190° C. The material was preheated with 0 pounds of pressure for 2 minutes, pressed at 5 k lbs of pressure for 2 minutes, then the pressure was maintained at 0 while still in the mold for 15 minutes. Samples were cut into test strips measuring between 13 and 13.4 mm in width, ˜18 mm in length, and between 0.5 mm and 0.6 mm in average thickness. Note that there is variation in dimensions due to sample type. Samples were tested on an MCR501 rheometer with an SER testing fixture. Samples were temperature equilibrated for 10-15 minutes before the test. The SER Testing Platform was used on a MCR501 rheometer available from Anton Paar. The SER Testing Platform is described in U.S. Pat. Nos. 6,578,413 and 6,691,569, which are incorporated herein for reference. A general description of transient uniaxial extensional viscosity measurements is provided, for example, in “Measuring the transient extensional rheology of polyethylene melts using the SER universal testing platform”, The Society of Rheology, Inc., J. Rheol., v. 49(3), pp. 585-606 (2005). Strain hardening occurs when a polymer is subjected to elongational flow and the transient extensional viscosity increases with respect to the linear viscoelasticity envelop (LVE). Strain hardening is observed as abrupt upswing of the extensional viscosity in the transient extensional viscosity vs. time plot. A strain hardening ratio (SHR) is used to characterize the upswing in extensional viscosity and is defined as the ratio of the maximum transient extensional viscosity at certain strain rate over the respective value of the LVE. Strain hardening is present in the material when the ratio is greater than 1.

Peak melting point, Tₘ, described for reactor batches (also referred to as melting point) and peak crystallization temperature, T_{c}, (also referred to as crystallization temperature) are determined using the following DSC procedure according to ASTM D3418-03. Differential scanning calorimetric (DSC-2) data can be obtained using a TA Instruments model DSC2500 machine. Samples weighing approximately 5 to 10 mg are sealed in an aluminum hermetic sample pan and loaded into the instrument at about room temperature. The DSC data are recorded by first gradually heating the sample to about 200° C. at a rate of about 10° C./minute. The sample is kept at about 200° C. for 5 minutes, then cooled to about −50° C. at a rate of about 10° C./minute, followed by an isothermal for about 5 minutes and heating to about 200° C. at about 10° C./minute, holding at about 200° C. for about 5 minutes and then cooling down to about 25° C. at a rate of about 10° C./minute. Both the first and second cycle thermal events were recorded. The melting and crystallization temperatures reported here were obtained during the second heating/cooling cycle unless otherwise noted. In the event of conflict between the DSC Procedure-1 and DSC procedure-2, DSC procedure-2 is used.

Unless otherwise indicated, the distribution and the moments of molecular weight (Mw, Mn, Mz, Mw/Mn, etc.), the comonomer content, and the branching index (g′) are determined by using a high temperature Gel Permeation Chromatography (Polymer Char GPC-IR) equipped with a multiple-channel band-filter based Infrared detector IRS with a multiple-channel band filter based infrared detector ensemble IRS with band region covering from about 2700 cm⁻¹ to about 3000 cm⁻¹ (representing saturated C-H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant BHT can be used as the mobile phase at a nominal flow rate of ˜1.0 mL/min and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IRS broadband signal, I, using the equation: c=αI, where a is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{P S} / K )}{α + 1} + \frac{{α}_{P S} + 1}{α + 1} log {M}_{P S}$$

where the variables with subscript “PS” stand for polystyrene while those without a subscript are for the test samples. In this method, α_{PS}=0.67 and K_{PS}=0.000175, a and K for other materials are as calculated and published in literature (Sun, T. et al. Macromolecules 2001, v. 34, 6812), except that for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, and α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted.

### Definitions

The term “alpha-olefin” refers to an olefin having a terminal carbon-to-carbon double bond in the structure thereof ((R¹R²)—C═CH₂, where R¹ and R² can be independently hydrogen or any hydrocarbyl group; preferably R¹ is hydrogen and R² is an alkyl group). A “linear alpha-olefin” is an alpha-olefin defined in this paragraph wherein R¹ is hydrogen, and R² is hydrogen or a linear alkyl group. Ethylene is an alpha-olefin.

For the purposes of this present disclosure and the claims thereto, and unless otherwise specified, a “catalyst system” is a combination of at least one catalyst compound, at least one activator, an optional co-activator, and an optional support material. When “catalyst system” is used to describe such a pair before activation, it refers to the unactivated catalyst complex (precatalyst) together with an activator and, optionally, a co-activator. When it is used to describe such a pair after activation, it refers to the activated complex and the activator or other charge-balancing moiety. The transition metal compound may be neutral as in a precatalyst, or a charged species with a counter ion as in an activated catalyst system. For the purposes of this present disclosure and the claims thereto, and unless otherwise specified, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein embrace both neutral and ionic forms of the catalyst compounds and activators.

For the purposes of this present disclosure and the claims thereto, the new numbering scheme for the Periodic Table Groups is used as described in Chemical and Engineering News, 63(5), pg. 27 (1985). Therefore, a “group 4 metal” is an element from group 4 of the Periodic Table, e.g. Hf, Ti, or Zr.

For the purposes of this present disclosure and the claims thereto, and unless otherwise specified, the terms “hydrocarbyl radical,” “hydrocarbyl group,” or “hydrocarbyl” may be used interchangeably and are defined to mean a group consisting of hydrogen and carbon atoms only. Suitable hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, aryl groups, such as phenyl, benzyl, naphthyl.

For the purposes of this present disclosure and the claims thereto, and unless otherwise specified, the terms “alkyl radical,” and “alkyl” are used interchangeably throughout this disclosure. For purposes of this disclosure, “alkyl radical” is defined to be C₁-C₁₀₀ alkyls, that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like including their substituted analogues.

For the purposes of this present disclosure and the claims thereto, and unless otherwise specified (such as for “substituted hydrocarbyl”, etc.), the term “substituted” refers to that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*2, —SiR*₃, —GeR*₃, —SnR*₃, —PbR*₃, —(CH₂)_{q}—SiR*₃, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

For the purposes of this present disclosure and the claims thereto, and unless otherwise specified, the term “ring atom” refers to an atom that is part of a cyclic ring structure. By this definition, a benzyl group has six ring atoms and tetrahydrofuran has 5 ring atoms.

For the purposes of this present disclosure and the claims thereto, and unless otherwise specified, the term “aryl” or “aryl group” refers to an aromatic ring such as phenyl, naphthyl, xylyl, etc. Likewise, heteroaryl refers to an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

The term “substituted aryl,” means an aryl group having one or more hydrogen groups replaced by a hydrocarbyl, substituted hydrocarbyl, heteroatom or heteroatom containing group.

The term “substituted heteroaryl,” means a heteroaryl group having one or more hydrogen groups replaced by a hydrocarbyl, substituted hydrocarbyl, heteroatom or heteroatom containing group.

A “halocarbyl” is a halogen substituted hydrocarbyl group that may be bound to another substituent via a carbon atom or a halogen atom.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

The following abbreviations may be used herein: Me is methyl, Et is ethyl, Pr is propyl, cPR is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, MAO is methylalumoxane, dme is 1,2-dimethoxyethane, p-tBu is para-tertiary butyl, TMS is trimethylsilyl, TIBAL is triisobutylaluminum, TNOAL is tri(n-octyl)aluminum, p-Me is para-methyl, Bz and Bn are benzyl (i.e., CH₂Ph), THF (also referred to as thf) is tetrahydrofuran, RT is room temperature (and is 23° C. unless otherwise indicated), tol is toluene, EtOAc is ethyl acetate, Cbz is Carbazole, and Cy is cyclohexyl.

In the description herein, the catalyst may be described as a catalyst, a catalyst precursor, a pre-catalyst compound, catalyst compound or a transition metal compound, and these terms are used interchangeably.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

A “metallocene” catalyst compound is a transition metal catalyst compound having one, two or three, typically one or two, substituted or unsubstituted cyclopentadienyl ligands bound to the transition metal, typically a metallocene catalyst is an organometallic compound containing at least one n-bound cyclopentadienyl moiety (or substituted cyclopentadienyl moiety). Substituted or unsubstituted cyclopentadienyl ligands include substituted or unsubstituted indenyl, fluroenyl, indacenyl, benzindenyl, and the like.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

1-15. (canceled)

16. A composition, comprising:
a catalyst compound having Formula (I), 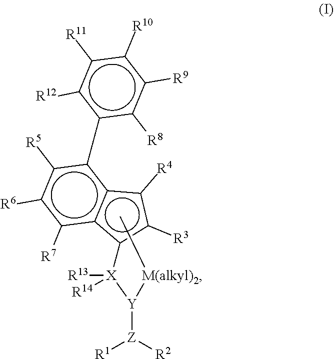
wherein,
M is a group IV transition metal,
X is a bridging atom,
Y is nitrogen,
Z is carbon that is optionally stereogenic,
each R¹ and R² are independently hydrogen, substituted or unsubstituted hydrocarbyl, aryl, or heteroaryl, wherein R¹ and R² can be joined to form a saturated or unsaturated C₃-C₆₀ cyclic or polycyclic ring or combination of thereof,
R³ is a substituted or unsubstituted C₁-C₂₀ hydrocarbyl,
R⁴ is hydrogen, an alkyl group, or aryl group,
each of R⁵ and R⁶ is independently hydrogen, an unsubstituted C₁-C₄₀ hydrocarbyl, a substituted C₁-C₄₀ hydrocarbyl, a heteroatom, a heteroatom-containing group, or R⁵ and R⁶ form a cyclic or polycyclic ring structure, or a combination thereof,
R⁷ is hydrogen, a substituted C₁-C₂₀ hydrocarbyl, or an unsubstituted C₁-C₂₀ hydrocarbyl,
each of R⁸, R⁹, R¹⁰, R¹¹, and R¹² is independently hydrogen, an unsubstituted C₁-C₄₀ hydrocarbyl, a substituted C₁-C₄₀ hydrocarbyl, a heteroatom, a heteroatom-containing group, or two or more of R⁸, R⁹, R¹⁰, R¹¹, and R¹² are joined together to form a C₄-C₆₂ cyclic or polycyclic ring structure, or a combination thereof; and
each R¹³ and R¹⁴ is independently substituted or unsubstituted hydrocarbyl, aryl, or heteroaryl, or cycloalkyl, wherein R¹³ and R¹⁴ can be joined to form a saturated or unsaturated C₃-C₆₀ cyclic or polycyclic ring, or combination of thereof.

17. The composition of claim 16, wherein each R¹ and R² are independently, methyl, ethyl, propyl, isopropyl, butyl, isobutyl, tertbutyl, pentyl, isopentyl, hexyl, cyclopentyl, cyclohexyl, 1-adamantyl, 2-adamantyl, or norbornyl, or combination of thereof.

18. The composition of claim 16, wherein the catalyst compound has a syn or anti configuration, and R¹ and R² are different from each other.

19. The composition of claim 16, wherein diastereomeric chirality is imposed on the catalyst compound by the Z being stereogenic, R¹ and R² are different from each other, and the R³-R¹² is a substituted 4-aryl polycyclic ring.

20. The composition of claim 16, wherein R¹ and R² are joined to form a saturated or unsaturated asymmetric C₃-C₆₀ cyclic or polycyclic ring or combination of thereof.

21. The composition of claim 16, wherein X is silicon.

22. The composition of claim 19, wherein the catalyst compound has syn and anti configurations, M is titanium, X is silicon, and R¹ is fused with R² to form an asymmetric cyclohexyl ring with Me group in 2-position, R¹³, R¹⁴, R³ are each independently Me, each of R⁴, R⁵, R⁶, R⁷, R⁸, R⁹, R¹¹, and R¹² are independently H, R¹⁰ is tBu, and Z is CH and racemic.

23. The composition of claim 16, wherein the catalyst compound has syn and anti configurations, M is titanium, X is silicon wherein each of R¹, R³, R¹³, and R¹⁴ is independently Me, R² is 1-adamantyl, each of R⁴-R⁹, and R¹² is independently hydrogen, and R¹⁰ is tertButyl.

24. The composition of claim 16, wherein the catalyst compound has syn and anti configurations, M is titanium, X is silicon wherein each of R¹, R³, R¹³, and R¹⁴ is independently Me, R² is cyclohexyl, each of R⁴-R⁹, R¹¹, and R¹² is independently hydrogen, and R¹⁰ is tertButyl such that stereochemistry at the Z atom is R.

25. The composition of claim 16, wherein the catalyst compound has syn and anti configurations, the M is titanium, X is silicon wherein each of R¹, R³, R¹³, and R¹⁴ is independently Me, R² is cyclohexyl, each of R⁴-R⁹, R¹¹, and R¹² is independently hydrogen, and R¹⁰ is tertButyl such that stereochemistry at the Z atom is S.

26. The composition of claim 16, wherein the catalyst compound has syn and anti configurations, the M is titanium, X is silicon wherein each of R¹, R³, R¹³, and R¹⁴ is independently Me, R² is 1-adamantyl, each of R⁴, R⁷, R⁸, R¹⁰, and R¹² are independently hydrogen, R⁵ and R⁶ are fused to make a cyclopentyl ring, and R¹¹ and R⁹ are each independently tBu.

27. The composition of claim 19, wherein the catalyst compound is included in a catalyst system with an activator and a support material.

28. A method, comprising:
introducing one or more monomers and a catalyst system of claim 12 into a reactor at a reactor pressure of from 1 bar to 70 bar and a reactor temperature of from 20° C. to 150° C.; and
obtaining a polymer.

29. The method of claim 28, wherein the introducing includes introducing propylene and an alpha-olefin, and the polymer is a co-polymer of propylene and the alpha-olefin.

30. The method of claim 29, wherein the alpha-olefin is a C₂ or C₄ to C₄₀ olefin monomer, and the co-polymer has a Mw of 50,000-600,000 g/mol.

31. The method of claim 28, wherein the polymer is polypropylene that has a M_{w} of 50,000-1,500,000 g/mol or polyethylene that has a Mw of 50,000-3,000,000 g/mol.

32. The method of claim 28, wherein the catalyst compound is enriched to either syn or anti form in at least 6:4.

33. The method of claim 32, wherein the catalyst compound is enriched in anti form and the polymer is a propylene elastomer with a melt temperature ranging between 50-80° C.

34. The method of claim 29, wherein the polymer is an ethylene-octene (EO) copolymer that has a Mw of 50,000-1,500,000 g/mol, an 1-octene content from 0.5 to 60 wt % and Tₘ less than 125° C.
